(19) United States
(12) Patent Application Publication
(10) Pub. No.: US 2026/0032695 A1
(43) Pub. Date: Jan. 29, 2026

(54) METHOD AND APPARATUS FOR PUSCH OR PDSCH SCHEDULING ON A PLURALITY OF CELLS

(71) Applicant: Harfang IP Investment Corporation, Round Rock, TX (US)

(72) Inventor: Sushil KUMAR, Haryana (IN)

(73) Assignee: Harfang IP Investment Corporation, Round Rock, TX (US)

(21) Appl. No.: 19/143,835

(22) PCT Filed: Dec. 29, 2023
(86) PCT No.: PCT/US2023/086370

§ 371 Date: Jun. 26, 2025

(30) Foreign Application Priority Data
Dec. 30, 2022 (IN) 202211077316

(51) Int. Cl. H04W 72/231; H04L 5/00; H04W 72/0446; H04W 76/20

(52) U.S. Cl. CPC H04W 72/231; H04L 5/0044; H04W 72/0446; H04W 76/20

(57) ABSTRACT

A user terminal and a base station perform PUSCH or PDSCH scheduling on a plurality of cells. A method performed by a user equipment comprises receiving radio resource control (RRC) signaling configuring a first downlink control information (DCI) scheduling respective physical uplink shared channels (PUSCHs) on a first plurality of cells and configuring a second DCI scheduling respective physical downlink shared channels (PDSCHs) on a second plurality of cells, receiving the first DCI scheduling the respective PUSCHs on the first plurality of cells, receiving the second DCI scheduling the respective PDSCHs on the second plurality of cells, transmitting the respective PUSCHs on the first plurality of cells based on the received first DCI; and receiving the respective PDSCHs on the second plurality of cells based on the received second DCI.

### CROSS REFERENCE TO RELATED APPLICATIONS

This application is the U.S. National Stage, under 35 U.S.C. § 371, of International Application No. PCT/US2023/086370, filed Dec. 29, 2023, which claims the benefit of India application Ser. No. 202211077316, filed Dec. 30, 2022, the contents of which are incorporated by reference as if fully set forth. Further, this application incorporate by reference India application No. 202211034986, filed Jun. 18, 2022, and PCT/US2023/025666, filed Jun. 19, 2023.

### BACKGROUND

One of the finalized work items for 3GPP release 18 is “Multi-carrier enhancements for NR”. The description of the problem statement, and the objective of “Multi-carrier enhancements for NR” is described in RP-220834, 3GPP TSG RAN Meeting #95e, Electronic Meeting, Mar. 17-23, 2022, in section 3 and 4 as reproduced below.

### Justification

NR supports a wide range of spectrum in different frequency ranges. It is expected that there will be increasing availability of spectrum in the market for 5G Advanced, possibly due to re-farming from the bands originally used for previous cellular generation networks. Especially for low frequency FR1 bands, the available spectrum blocks tend to be more fragmented and scattered with narrower bandwidth. For FR2 bands and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

One motivation is to increase flexibility and spectral/power efficiency on scheduling data over multiple cells including intra-band cells and inter-band cells. The current scheduling mechanism only allows scheduling of single cell PUSCH/PDSCH per scheduling DCI. With more available scattered spectrum bands or wider bandwidth spectrum, the need of simultaneous scheduling of multiple cells is expected to be increasing. To reduce the control overhead, it is beneficial to extend from single-cell scheduling to multi-cell PUSCH/PDSCH scheduling with a single scheduling DCI. Meanwhile, the trade-off between overhead saving and scheduling restriction has to be taken into account.

For multi-carrier UL operation, there are some limitations of current specification, e.g., 2TX UE can be configured with at most 2 UL bands, which only can be changed by RRC reconfiguration, and UL Tx switching can be only performed between 2 UL bands for 2Tx UE. Dynamically selecting carriers with UL Tx switching e.g., based on the data traffic, TDD DL/UL configuration, bandwidths, and channel conditions of each band, instead of RRC-based cell(s) reconfiguration, may potentially lead to higher UL data rate, spectrum utilization and UL capacity.

### Objective

### 4.1 Objective of SI or Core Part WI or Testing Part WI

1. Specify a Solution for Multi-Cell PUSCH/PDSCH Scheduling (One PDSCH/PUSCH Per Cell) with a Single DCI [RAN1]
Identify the maximum number of cells that can be scheduled simultaneously.
   Consider both intra-band and inter-band CA operation.
   Consider both FR1 and FR2.
   The single DCI shall be optimized for 3 or more cells for the multi-cell PUSCH/PDSCH scheduling.

### 2. Study and if Necessary Specify Following Enhancements for Multi-Carrier UL Operation [RAN1, RAN2, RAN4]

UL Tx switching schemes across up to 3 or 4 bands with restriction of up to 2 Tx simultaneous transmission for FR1 UEs, including mechanisms to enable more configured UL bands than its simultaneous transmission capability and to support dynamic Tx carrier switching across the configured bands for both single TAG and multiple TAGs configurations (RAN1, RAN4)·
   UE capability and RRC configuration related signalling (RAN2)
   Note: strive for RAN1/2 design agnostic with the number of bands, i.e., common design between 3 and 4 bands.
   Note: no additional TAG is introduced for UL transmission on a carrier without corresponding DL carrier
   Note: this objective does not target to extend the SUL framework to support more than 1 SUL for 1 NUL
Switching time and other RF aspects, and RRM requirements for above UL Tx switching schemes across up to 3 or 4 bands (RAN4).
   Note: Prioritize UL Tx switching across up to 3 bands is to be addressed first and then that for up to 4 bands can also be addressed

### SUMMARY

In an embodiment, a method of wireless communication, performed by a UE, comprising receiving a first RRC signaling indicating activation of a first DCI scheduling respective PUSCHs on a first plurality of cells in a first PUCCH group and receiving a second RRC signaling indicating activation of a second DCI scheduling respective PDSCHs on a second plurality of cells in a second PUCCH group, wherein the first RRC signaling and the second RRC signaling are separate signalings. Based on the received first and second RRC signalings the UE configures itself for monitoring PDCCH search spaces for the first DCI and the second DCI formats. The UE receives the first DCI scheduling respective PUSCHs on the first plurality of cells in the first PUCCH group based on the first RRC signaling and receives the second DCI scheduling respective PDSCHs on the second plurality of cells in the second PUCCH group based on the second RRC signaling. The UE transmits the respective PUSCHs on the first plurality of cells in the first PUCCH group based on the first DCI and receives the respective PDSCHs on the second plurality of cells in the second PUCCH group based on the second DCI. The first and the second DCI may refer to any one of the DCI formats disclosed in the description in conjunction with FIG. 12-19 or 22-26. The first DCI and the second DCI may be received by the UE in different time/frequency slots. Similarly, the UE transmits the respective PUSCH for the first plurality of cells and receives the respective PDSCH for the second plurality of cells in different times time/frequency slots. The first PUCCH group and the second PUCCH group may have at least one cell which is not common. In an alternative embodiment, the first PUCCH group and the second PUCCH group may have identical cells.

In an embodiment, the first RRC signaling may further include information of a scheduling cell on which the first DCI scheduling the respective PUSCHs on the first plurality of cells is received. The scheduling cell on which the first DCI scheduling the respective PUSCHs on the first plurality of cells is received by the UE is part of the first PUCCH group but may or may not be a part of the first plurality of cells.

In an embodiment, the first RRC signaling may further include information of the first plurality of cells on which the respective PUSCHs are to be transmitted and the information of the first plurality of cells may include the respective cell indices.

In an embodiment, the first RRC signaling may further includes CSCI information and its association information with one or more combinations of the subsets of the first plurality of cells and/or at least one association may indicate all the cells in the first plurality of cells, and the CSCI information may be indicated in the first DCI scheduling the respective PUSCHs on the first plurality of cells or the subset of the first plurality of cells.

In an embodiment, the first RRC signaling may further include information of number of cells in the first plurality of cells and the information of the number of cells in the first plurality of cells may be selected from 2, 3, 4, or 8.

In an embodiment, the first RRC signaling may further includes information of a cell group ID of the first plurality of cells or a PUCCH group ID of the first PUCCH group.

In an embodiment, the first RRC signaling may further includes information of a reference cell within the first PUCCH group for the purpose of determining transmission timing of the respective PUSCHs by the UE on the first plurality of cells or for determining timing of receiving feedback (may be on PDCCH) of the transmitted PUSCHs by the UE on at least one cell of the first plurality of cells.

In an embodiment, the first RRC signaling may further includes information of one or more first DCI fields in the first DCI configured for indicating separate information for a set of scheduled cells and the set of scheduled cells corresponds to the first plurality of cells or a subset of cells from the first plurality of cells. The information of the one or more first DCI fields includes two or more of first DCI field names or first DCI field identifiers, number of bits to be used for the first DCI fields, or joint indication bits and corresponding values for each scheduled cell of the set of scheduled cells wherein the joint indication bits are included in the first DCI when the one or more first DCI fields are used for scheduling the respective PUSCHs on the first plurality of cells in the first PUCCH group. The one or more first DCI fields in the first DCI may refer to a time domain resource assignment (TDRA) field or an SRS request field.

In an embodiment, the first RRC signaling may further includes information of one or more second DCI fields in the first DCI which are dynamically configured based on a network configuration as common fields for indicating common information for a set of scheduled cells or as separate fields for indicating separate information for each scheduled cell of a set of scheduled cells and the set of scheduled cells corresponds to the first plurality of cells or a subset of cells from the first plurality of cells. The information of the one or more second DCI fields in the first DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The one or more second DCI fields in the first DCI may refer to an Antenna port(s) field, an SRS resource indicator field or a Precoding information and number of layers field.

In an embodiment, the second RRC signaling may further include information of a scheduling cell on which the second DCI scheduling the respective PDSCHs on the second plurality of cells is received. The scheduling cell on which the second DCI scheduling the respective PDSCHs on the second plurality of cells is received is part of the second PUCCH group but may or may not be a part of the second plurality of cells.

In an embodiment, the second RRC signaling may further include information of the second plurality of cells on which the respective PDSCHs are to be received and the information of the second plurality of cells may include the respective cell indices.

In an embodiment, the second RRC signaling may further includes CSCI information and its association information with one or more combinations of the subsets of the second plurality of cells and/or at least one association may indicate all the cells in the second plurality of cells and the CSCI information may be indicated in the second DCI scheduling the respective PDSCHs on the second plurality of cells or the subset of the second plurality of cells.

In an embodiment, the second RRC signaling may further include information of number of cells in the second plurality of cells and the information of the number of cells in the second plurality of cells may be selected from 2, 3, 4, or 8.

In an embodiment, the second RRC signaling may further include information of a cell group ID of the second plurality of cells or a PUCCH group ID of the second PUCCH group.

In an embodiment, the second RRC signaling may further include information of a reference cell within the second PUCCH group for the purpose of determining reception timing of the respective PDSCHs by the UE on the second plurality of cells or for determining timing of transmitting feedback (may be on PUCCH or PUSCH) of the received PDSCHs by the UE on at least one cell of the second plurality of cells.

In an embodiment, the second RRC signaling may further includes information of one or more first DCI fields in the second DCI configured for indicating separate information for a set of scheduled cells and the set of scheduled cells corresponds to the second plurality of cells or a subset of cells from the second plurality of cells. The information of the one or more first DCI fields includes two or more of DCI field names or DCI field identifiers, number of bits to be used for the first DCI fields, or joint indication bits and corresponding values for each scheduled cell of the set of scheduled cells wherein the joint indication bits are included in the second DCI when the first DCI field is used for scheduling the respective PDSCHs on the second plurality of cells in the second PUCCH group. The one or more first DCI fields in the second DCI may refer to a Time domain resource assignment (TDRA) field or an SRS request field.

In an embodiment, the second RRC signaling may further includes information of one or more second DCI fields in the second DCI which are dynamically configured based on a network configuration as common fields for indicating common information for a set of scheduled cells or as separate fields for indicating separate information for each scheduled cell of a set of scheduled cells and the set of scheduled cells corresponds to the second plurality of cells or a subset of cells from the second plurality of cells. The information of the one or more second DCI fields in the second DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The second DCI field in the second DCI may refer to an Antenna port(s) field.

In an embodiment, the method of wireless communication, performed by a base station, comprising receiving a first RRC signaling indicating activation of a first DCI scheduling respective PUSCHs on a first plurality of cells in a first PUCCH group and transmits a second RRC signaling indicating activation of a second DCI scheduling respective PDSCHs on a second plurality of cells in a second PUCCH group, wherein the first RRC signaling and the second RRC signaling are separate signalings. Based on the transmitted first and second RRC signalings the BS configures itself for transmitting PDCCH in the PDCCH search spaces with the first DCI and the second DCI formats. The BS transmits the first DCI scheduling respective PUSCHs on the first plurality of cells in the first PUCCH group based on the first RRC signaling and transmits the second DCI scheduling respective PDSCHs on the second plurality of cells in the second PUCCH group based on the second RRC signaling. The BS receives the respective PUSCHs on the first plurality of cells in the first PUCCH group based on the first DCI and transmits the respective PDSCHs on the second plurality of cells in the second PUCCH group based on the second DCI. The first and the second DCI may refer to any one of the DCI formats disclosed in the description in conjunction with FIG. 12-19 or 22-26. The first DCI and the second DCI may be transmitted by the BS in different time/frequency slots. Similarly, the BS receives the respective PUSCH for the first plurality of cells and transmits the respective PDSCH for the second plurality of cells in different times time/frequency slots. The first PUCCH group and the second PUCCH group may have at least one cell which is not common. In an alternative embodiment, the first PUCCH group and the second PUCCH group may have identical cells.

In an embodiment, the first RRC signaling may further include information of a scheduling cell on which the first DCI scheduling the respective PUSCHs on the first plurality of cells is transmitted by the BS. The scheduling cell on which the first DCI scheduling the respective PUSCHs on the first plurality of cells is transmitted by the BS is part of the first PUCCH group but may or may not be a part of the first plurality of cells.

In an embodiment, the first RRC signaling may further include information of the first plurality of cells on which the respective PUSCHs are to be transmitted by the UE and the information of the first plurality of cells may include the respective cell indices.

In an embodiment, the first RRC signaling may further include CSCI information and its association information with one or more combinations of the subsets of the first plurality of cells and/or at least one association may indicate all the cells in the first plurality of cells, and the CSCI information may be indicated in the first DCI scheduling the respective PUSCHs in the UE on the first plurality of cells or the subset of the first plurality of cells.

In an embodiment, the first RRC signaling may further include information of number of cells in the first plurality of cells and the information of the number of cells in the first plurality of cells may be selected from 2, 3, 4, or 8.

In an embodiment, the first RRC signaling may further includes information of a cell group ID of the first plurality of cells or a PUCCH group ID of the first PUCCH group.

In an embodiment, the first RRC signaling may further includes information of a reference cell to be used by the UE within the first PUCCH group for the purpose of determining transmission timing of the respective PUSCHs by the UE on the first plurality of cells or for determining timing of receiving feedback (may be on PDCCH) of the transmitted PUSCHs by the UE on at least one cell of the first plurality of cells.

In an embodiment, the first RRC signaling may further includes information of one or more first DCI fields to be transmitted in the first DCI configured for indicating separate information for a set of scheduled cells and the set of scheduled cells corresponds to the first plurality of cells or a subset of cells from the first plurality of cells. The information of the one or more first DCI field includes two or more of first DCI field names or first DCI field identifiers, number of bits to be used for the first DCI fields, or joint indication bits and corresponding values for each scheduled cell of the set of scheduled cells wherein the joint indication bits are included in the first DCI when the one or more first DCI fields are used for scheduling the respective PUSCHs by the UE on the first plurality of cells in the first PUCCH group. The one or more first DCI fields in the first DCI may refer to a Time domain resource assignment (TDRA) field or an SRS request field.

In an embodiment, the first RRC signaling may further includes information of one or more second DCI fields to be transmitted in the first DCI which are dynamically configured based on a network configuration as common fields for indicating common information for a set of scheduled cells or as separate fields for indicating separate information for each scheduled cell of a set of scheduled cells and the set of scheduled cells corresponds to the first plurality of cells or a subset of cells from the first plurality of cells. The information of the one or more second DCI field in the first DCI includes second DCI field names or second DCI field identifiers and an indicator of configuration as the common fields for indicating common information for the set of scheduled cells or an indicator of configuration as separate fields for indicating separate information for each scheduled cell of the set of the scheduled cells. The one or more second DCI fields in the first DCI may refer to an Antenna port(s) field, an SRS resource indicator field or a Precoding information and number of layers field.

In an embodiment, the second RRC signaling may further include information of a scheduling cell on which the second DCI scheduling the respective PDSCHs on the second plurality of cells is transmitted by the BS. The scheduling cell on which the second DCI scheduling the respective PDSCHs on the second plurality of cells is transmitted by the BS is part of the second PUCCH group but may or may not be a part of the second plurality of cells.

In an embodiment, the second RRC signaling may further include information of the second plurality of cells on which the respective PDSCHs are to be received by the UE and the information of the second plurality of cells may include the respective cell indices.

In an embodiment, the second RRC signaling may further includes CSCI information and its association information with one or more combinations of the subsets of the second plurality of cells and/or at least one association may indicate all the cells in the second plurality of cells and the CSCI information may be indicated in the second DCI by the BS for scheduling the respective PDSCHs on the second plurality of cells or the subset of the second plurality of cells.

In an embodiment, the second RRC signaling may further include information of number of cells in the second plurality of cells and the information of the number of cells in the second plurality of cells may be selected from 2, 3, 4, or 8.

In an embodiment, the second RRC signaling may further include information of a cell group ID of the second plurality of cells or a PUCCH group ID of the second PUCCH group.

In an embodiment, the second RRC signaling may further include information of a reference cell to be used by the UE within the second PUCCH group for the purpose of determining reception timing of the respective PDSCHs by the UE on the second plurality of cells or for determining timing of transmitting feedback (may be on PUCCH or PUSCH) of the received PDSCHs by the UE on at least one cell of the second plurality of cells.

In an embodiment, the second RRC signaling may further includes information of one or more first DCI fields in the second DCI to be transmitted by the BS configured for indicating separate information for a set of scheduled cells and the set of scheduled cells corresponds to the second plurality of cells or a subset of cells from the second plurality of cells. The information of the one or more first DCI fields includes two or more of DCI field names or DCI field identifiers, number of bits to be used for the first DCI fields, or joint indication bits and corresponding values for each scheduled cell of the set of scheduled cells wherein the joint indication bits are included in the second DCI when the first DCI field is used for scheduling the respective PDSCHs by the UE on the second plurality of cells in the second PUCCH group. The one or more first DCI fields in the second DCI may refer to a Time domain resource assignment (TDRA) field or an SRS request field.

In an embodiment, the second RRC signaling may further includes information of one or more second DCI fields in the second DCI to be transmitted by the BS which are dynamically configured based on a network configuration as common fields for indicating common information for a set of scheduled cells or as separate fields for indicating separate information for each scheduled cell of a set of scheduled cells and the set of scheduled cells corresponds to the second plurality of cells or a subset of cells from the second plurality of cells. The information of the one or more second DCI fields in the second includes second DCI field names or second DCI field identifiers and an indicator of configuration as the common fields for indicating common information for the set of scheduled cells or an indicator of configuration as separate fields for indicating separate information for each scheduled cell of the set of scheduled cells. The second DCI field in the second DCI may refer to an Antenna port(s) field.

In an embodiment, an apparatus comprising a processor or a plurality of processors, a transceiver or a plurality of transceivers configured to receive, from a base station, a first RRC signaling indicating activation of a first DCI scheduling respective PUSCHs on a first plurality of cells in a first PUCCH group and a second RRC signaling indicating activation of a second DCI scheduling respective PDSCHs on a second plurality of cells in a second PUCCH group. The first RRC signaling and the second RRC signaling are separate signalings. The transceiver or the plurality of transceivers are further configured to receive, from the base station, the first DCI scheduling the respective PUSCHs on the first plurality of cells in the first PUCCH group based on the first RRC signaling and the second DCI scheduling the respective PDSCHs on the second plurality of cells in the second PUCCH group based on the second RRC signaling. The transceiver or the plurality of transceivers further configured to transmit, to the base station, the respective PUSCHs on the first plurality of cells in the first PUCCH group based on the first DCI and the transceiver or the plurality of transceivers further configured to receive, from the base station, the respective PDSCHs on the second plurality of cells in the second PUCCH group based on the second DCI.

In an embodiment, an apparatus comprising a processor or a plurality of processors, a transceiver or a plurality of transceivers configured to transmit, to a UE, a first RRC signaling indicating activation of a first DCI scheduling respective PUSCHs on a first plurality of cells in a first PUCCH group and a second RRC signaling indicating activation of a second DCI scheduling respective PDSCHs on a second plurality of cells in a second PUCCH group. The first RRC signaling and the second RRC signaling are separate signalings. The transceiver or the plurality of transceivers are further configured to transmit, to the UE, the first DCI scheduling the respective PUSCHs on the first plurality of cells in the first PUCCH group based on the first RRC signaling and the second DCI scheduling the respective PDSCHs on the second plurality of cells in the second PUCCH group based on the second RRC signaling. The transceiver or the plurality of transceivers further configured to receive, from the UE, the respective PUSCHs on the first plurality of cells in the first PUCCH group based on the first DCI and the transceiver or the plurality of transceivers further configured to transmit, to the UE, the respective PDSCHs on the second plurality of cells in the second PUCCH group based on the second DCI.

In an embodiment, a non-transitory computer-readable medium comprising instructions operable to cause a processor or a plurality of processors to receive, from a base station, a first RRC signaling indicating activation of a first DCI scheduling respective PUSCHs on a first plurality of cells in a first PUCCH group and a second RRC signaling indicating activation of a second DCI scheduling respective PDSCHs on a second plurality of cells in a second PUCCH group. The first RRC signaling and the second RRC signaling are separate signalings. The instructions are further operable to cause a processor or a plurality of processors to receive, from the base station, the first DCI scheduling the respective PUSCHs on the first plurality of cells in the first PUCCH group based on the first RRC signaling and the second DCI scheduling the respective PDSCHs on the second plurality of cells in the second PUCCH group based on the second RRC signaling. The instructions are further operable to cause a processor or a plurality of processors to transmit, to the base station, the respective PUSCHs on the first plurality of cells in the first PUCCH group based on the first DCI and the instructions are further operable to cause a processor or a plurality of processors to receive, from the base station, the respective PDSCHs on the second plurality of cells in the second PUCCH group based on the second DCI.

In an embodiment, a non-transitory computer-readable medium comprising instructions operable to cause a processor or a plurality of processors to transmit, to a UE, a first RRC signaling indicating activation of a first DCI scheduling respective PUSCHs on a first plurality of cells in a first PUCCH group and a second RRC signaling indicating activation of a second DCI scheduling respective PDSCHs on a second plurality of cells in a second PUCCH group. The first RRC signaling and the second RRC signaling are separate signalings. The instructions are further operable to cause a processor or a plurality of processors to transmit, to the UE, the first DCI scheduling the respective PUSCHs on the first plurality of cells in the first PUCCH group based on the first RRC signaling and the second DCI scheduling the respective PDSCHs on the second plurality of cells in the second PUCCH group based on the second RRC signaling. The instructions are further operable to cause a processor or a plurality of processors to receive, from the UE, the respective PUSCHs on the first plurality of cells in the first PUCCH group based on the first DCI and the instructions are further operable to cause a processor or a plurality of processors to transmit, to the UE, the respective PDSCHs on the second plurality of cells in the second PUCCH group based on the second DCI.

### BRIEF DESCRIPTION OF THE DRAWINGS

FIG. 1 is an architecture of a wireless radio system according to an embodiment.

FIG. 2 is a diagram of a user plane protocol stack in a wireless radio system according to an embodiment.

FIG. 3 is a diagram of a control plane protocol stack in a wireless radio system according to an embodiment.

FIG. 4 is a block diagram of a user equipment according to an embodiment.

FIG. 5 is a block diagram of a base station according to an embodiment.

FIG. 6 is a flow diagram illustrating how a user equipment may be configured for a DCI scheduling a PUSCH or PDSCH per cell on each of a plurality of cells according to an embodiment.

FIG. 7 is a flow diagram illustrating how a base station may configure a user equipment for a DCI scheduling a PUSCH or PDSCH per cell on each of a plurality of cells according to an embodiment.

FIG. 8 is an illustration of a first embodiment related to scheduling configuration of the cells.

FIG. 9 is an illustration of a second embodiment related to scheduling configuration of the cells.

FIG. 10 is an illustration of a third embodiment related to scheduling configuration of the cells.

FIG. 11 is an illustration of a fourth embodiment related to scheduling configuration of the cells.

FIG. 12 is an illustration of a first embodiment related to configurations of DCI field format.

FIG. 13 is an illustration of a second embodiment related to configurations of DCI field format.

FIG. 14 is an illustration of a third embodiment related to configurations of DCI field format.

FIG. 15 is an illustration of a fourth embodiment related to configurations of DCI field format.

FIG. 16 is an illustration of a fifth embodiment related to configurations of DCI field format.

FIG. 17 is an illustration of a sixth embodiment related to configurations of DCI field format.

FIG. 18 is an illustration of a seventh embodiment related to configurations of DCI field format.

FIG. 19 is an illustration of an eighth embodiment related to configurations of DCI field format.

FIG. 20 is an illustration of an embodiment related to how a user equipment performs a method of receiving a DCI scheduling a PUSCH or PDSCH per cell on each of a plurality of cells.

FIG. 21 is an illustration of an embodiment related to how a base station performs a method of transmitting a DCI scheduling a PUSCH or PDSCH per cell on each of a plurality of cells.

FIG. 22 is an illustration of a ninth embodiment related to configurations of DCI field format.

FIG. 23 is an illustration of a tenth embodiment related to configurations of DCI field format.

FIG. 24 is an illustration of an eleventh embodiment related to configurations of DCI field format.

FIG. 25 is an illustration of a twelfth embodiment related to configurations of DCI field format.

FIG. 26 is an illustration of a thirteenth embodiment related to configurations of DCI field format.

FIG. 27 is an illustration of a first embodiment related to offset coding of Type 2 DCI fields.

FIG. 28 is an illustration of a second embodiment related to offset coding of Type 2

DCI fields.

FIG. 29 is an illustration of an embodiment related to configuration of a DCI scheduling a PDSCH per cell on each of a plurality of cells.

FIG. 30 is an illustration of an embodiment related to configuration of a DCI scheduling a PUSCH per cell on each of a plurality of cells.

FIG. 31 is an illustration of a first embodiment related to configuration of a DCI scheduling a PDSCH per cell on each of a plurality of cells in a dual connectivity mode.

FIG. 32 is an illustration of a second embodiment related to configuration of a DCI scheduling a PDSCH per cell on each of a plurality of cells in a dual connectivity mode.

FIG. 33 is an illustration of a first embodiment related to configuration of a DCI scheduling a PUSCH per cell on each of a plurality of cells in a dual connectivity mode.

FIG. 34 is an illustration of a second embodiment related to configuration of a DCI scheduling a PUSCH per cell on each of a plurality of cells in a dual connectivity mode.

FIG. 35 is an illustration of a first embodiment related to configuration of a DCI scheduling a PDSCH per cell on each of a plurality of cells and a DCI scheduling a PUSCH per cell on each of a plurality of cells in a dual connectivity mode.

FIG. 36 is an illustration of a second embodiment related to configuration of a DCI scheduling a PDSCH per cell on each of a plurality of cells and a DCI scheduling a PUSCH per cell on each of a plurality of cells in a dual connectivity mode.

FIG. 37 is an illustration of an embodiment related to configuration of a DCI scheduling a PDSCH per cell on each of a plurality of cells in a dual connectivity/CA mode.

FIG. 38 is an illustration of an embodiment related to configuration of a DCI scheduling a PUSCH per cell on each of a plurality of cells in a dual connectivity/CA mode.

FIG. 39 is an illustration of a first embodiment related to timing relationship among the received PDSCHs and PUCCH.

FIG. 40 is an illustration of a second embodiment related to timing relationship among the received PDSCHs and PUCCH.

FIG. 41 is an illustration of a first embodiment related to timing relationship among the received PDSCHs and PUSCH.

FIG. 42 is an illustration of a second embodiment related to timing relationship among the received PDSCHs and PUSCH.

FIG. 43 is an illustration of a second embodiment related to timing relationship among the received PDSCHs and PUSCH.

FIG. 44 is an illustration of a third embodiment related to timing relationship among the received PDSCHs and PUSCH.

FIG. 45 is an illustration of a first embodiment related to timing relationship among the received PDSCHs and feedback transmission on PUCCH in case of a variable sub-carrier spacings among the scheduled cells.

FIG. 46 is an illustration of a second embodiment related to timing relationship among the received PDSCHs and feedback transmission on PUCCH in case of a variable sub-carrier spacings among the scheduled cells.

FIG. 47 is an illustration of a first embodiment related to timing relationship among the transmitted PUSCHs and feedback reception on PDCCH in case of a variable sub-carrier spacings among the scheduled cells.

FIG. 48 is an illustration of a second embodiment related to timing relationship among the transmitted PUSCHs and feedback reception on PDCCH in case of a variable sub-carrier spacings among the scheduled cells.

FIG. 49 is an illustration of a first embodiment related to a UE being configured by a BS for a DCI scheduling a PDSCH per cell on each of a plurality of cells and a DCI scheduling a PUSCH per cell on each of a plurality of cells.

FIG. 50 is an illustration of a second embodiment related to a UE being configured by a BS for a DCI scheduling a PDSCH per cell on each of a plurality of cells and a DCI scheduling a PUSCH per cell on each of a plurality of cells.

FIG. 51 is an illustration of a first embodiment related to a BS configuring a UE for a DCI scheduling a PDSCH per cell on each of a plurality of cells and a DCI scheduling a PUSCH per cell on each of a plurality of cells.

FIG. 52 is an illustration of a second embodiment related to a BS configuring a UE for a DCI scheduling a PDSCH per cell on each of a plurality of cells and a DCI scheduling a PUSCH per cell on each of a plurality of cells.

### DETAILED DESCRIPTION

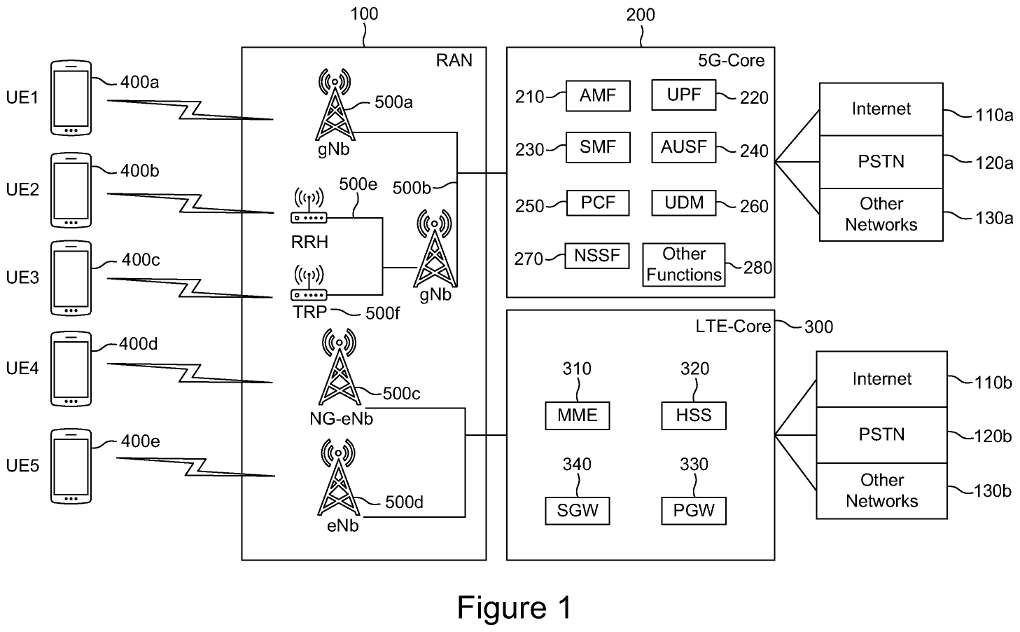

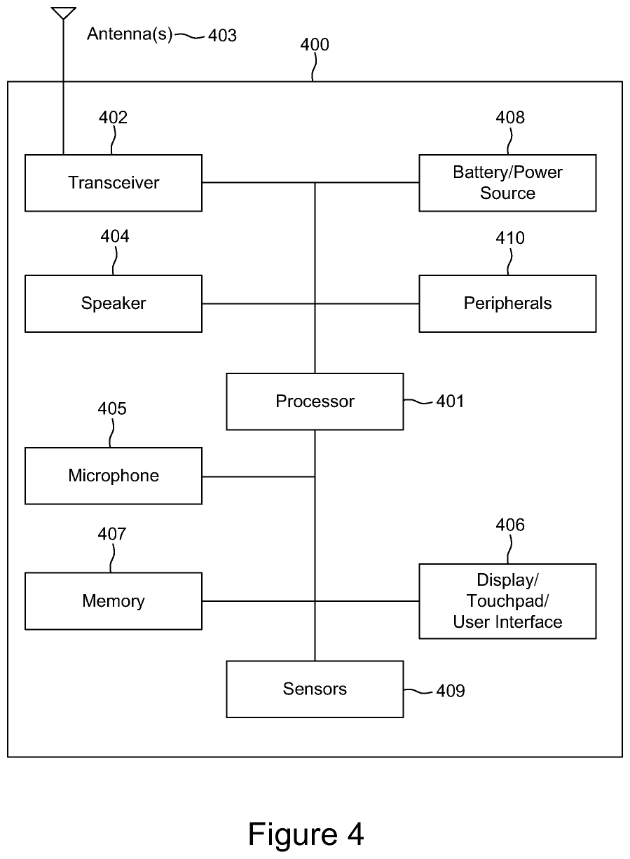

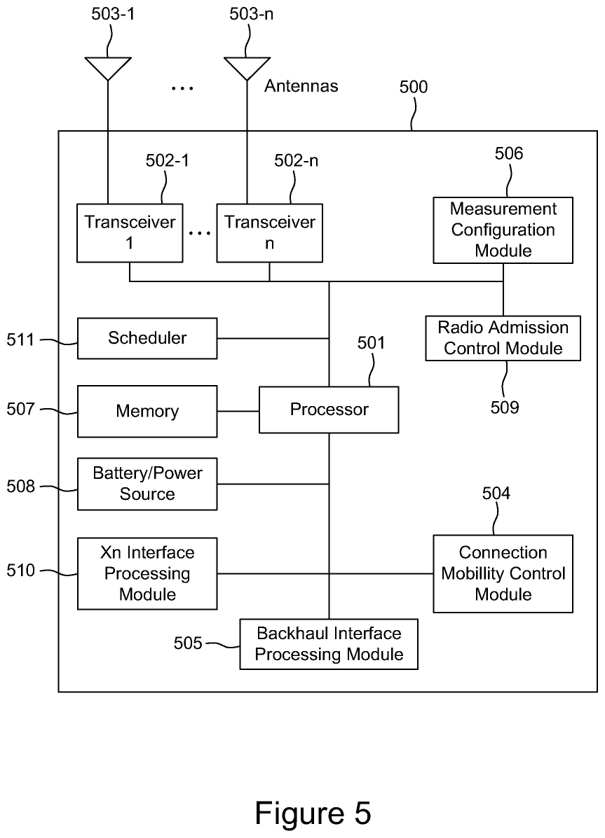

FIG. 1 is a system diagram of a wireless communication system that may be deployed to provide various communication services, such as a voice service, packet data, audio, video, and the like. The wireless communication system may include a User Equipments (UEs) (400a, 400b, 400c, 400d, 400e), RAN (100) (Radio Access Network), and a core including a 5G core (200) and/or an LTE core (300) The RAN (100) includes base stations (500a. 500b, 5000, 500d, 500e, 500f) or cells communicating with the UEs (400a, 400b, 4000, 400d, 400e). The LTE core (300) includes core network components such as MME (310), HSS (320), PGW (330), and SGW (340). The 5G core (200) includes various functions such as UPF (220), AMF (210), SMF (230), AUSF (240), NSSF (270), UDM (260), PCF (250), and other functions (280) such as NEF, NRF, AF, etc. The detailed scope and functionalities of the LTE (300) and 5G core (200) network components can be identified from the 3GPP standard specifications (including connection to internet (110a, 110b), PSTN (120a, 120b), and other networks (130a, 130b). The UEs (400a, 400b, 400c, 400d, 400e) may refer to a UE disclosed in conjunction with the description of FIG. 4 and base stations (500a, 500b, 500c, 500d, 500e, 500f) may refer to a base station disclosed in conjunction with the description of FIG. 5.

Throughout the patent specification, the user equipment may be an inclusive concept indicating a terminal utilized in wireless communication, including a UE (User Equipment) (400) in long-term evolution (LTE). 5G NR, and the like.

A base station (BS) (500) or a cell may generally refer to a station communicating with a User Equipment (UE) (400). The base station (500) may also be referred to as a Node-B, an evolved Node-B (eNb) (500c, 500d), gNodeB (gNb) (500a, 500b), MeNb, SeNb, HeNb, a Sector, a Site, transmit-receive point (TRP) (5000), a Base Transceiver System (BTS), an Access Point, a Relay Node, Integrated Access and Backhaul (IAB) node, a Remote Radio Head (RRH) (500e), a Radio Unit (RU), and the like.

In the patent specification, the base station (500) or the cell may have an inclusive concept indicating a portion of an area covered and functions performed by a Node-B, an evolved Node-B (eNb) (500d), gNodeB (gNb) (500b), MeNb, SeNb, a Sector, a Site, a Base Transceiver System (BTS), an Access Point, a Relay Node, Integrated Access and Backhaul (IAB) node, a Remote Radio Head (RRH) (500e), a Radio Unit (RU), and the like. The base station (500) or cell may include various coverage areas, such as a mega cell, a macrocell, a microcell, a picocell, a femtocell, a communication range of a relay node, an RRU, an RU, and the like.

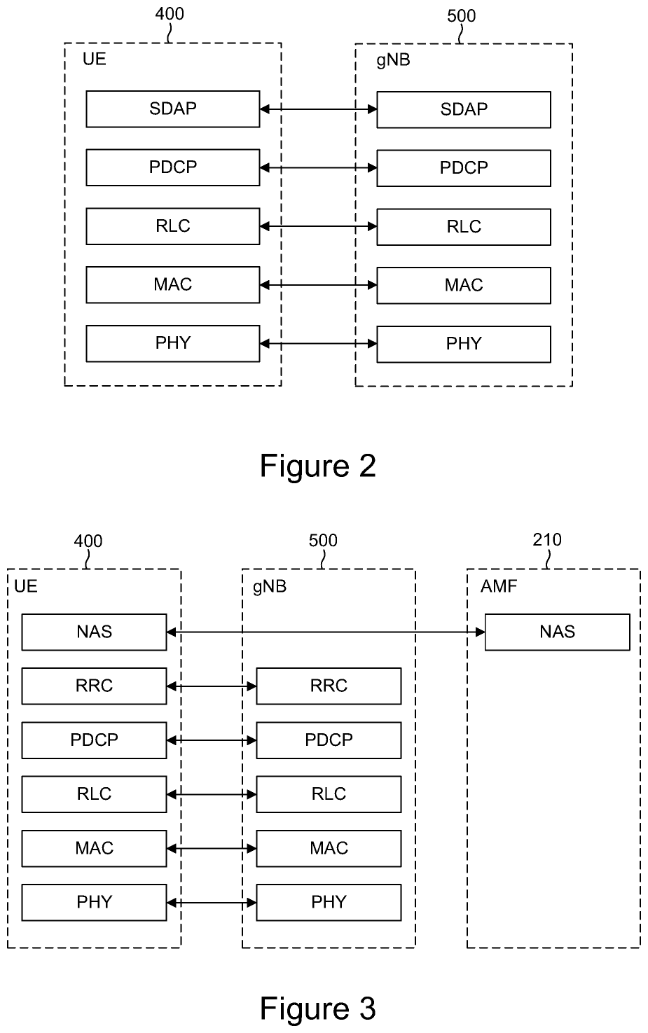

Exemplary communication between the base station (500) and UE (400) in a 5G system is disclosed in FIG. 2 for the user plane (aka data plane) protocol stack and FIG. 3 for the control plane protocol stack. A similar protocol stack also exists for UE (400) communication in an LTE system. One difference with respect to the 5G user plane protocol stack is the SDAP layer that only exists in 5G. One difference with respect to the 5G control plane protocol stack is that the NAS signalling is between UE (400) and AMF (210) whereas in LTE the NAS signalling is between UE (400) and MME (310).

As shown in FIG. 4, User Equipment (UE) (400) may include a processor (401), a transceiver (402), antenna(s) (403), a speaker (404)/microphone (405), a keypad (not shown), a display/touchpad/User interface (406), memory (non-removable memory or removable memory) (407), a power source (408) (or battery including charging circuit), sensors such as accelerometer, an e-compass, a global positioning system (GPS) chipset, NFC, and other peripherals (410) such a satellite transceiver, a digital camera (for photographs or video), a universal serial bus (USB) port, a vibration device, a hands-free headset, a Bluetooth® module, a frequency modulated (FM) radio unit, a multimedia player, a video game player module, an Internet browser, or the like. It is appreciated that the User Equipment (UE) (400) may include any sub-combination of the foregoing elements.

The processor (401) may be coupled to all or a subset of the of the following: transceiver (402), a speaker (404)/microphone (405), a keypad, a display/touchpad/User interface (406), non-removable memory, removable memory, a power source (408), sensors (409), and other peripherals (410).

As shown in FIG. 5, the Base station (500) may include a processor (501), a transceiver (502-1 . . . 502-n), antennas (503-1 . . . 503-n), memory (non-removable memory or removable memory) (507), and a power source (508) (or battery including a charging circuit). The base station (500) may be configured to host modules such as a measurement configuration module (506) for channel measurements for mobility and scheduling, radio admission control module (509) for UE (400) admission control to the network, connection mobility control (504) module for handover-related processing, backhaul Interface processing module (505) for processing messages received/transmitted to the core network, Xn interface processing module (510) for processing messages received/transmitted to other base stations, and scheduler (511) for dynamic allocation of resources to UEs in both uplink and downlink. It is appreciated that the base station (500) may include any sub-combination of the foregoing elements.

The following additional modules may also be hosted by the base station (500): Radio Resource Management for inter-cell radio resource management, radio bearer control, IP header compression, encryption and integrity protection of data, selection of an AMF (210) at UE (400) attachment when no routing to an AMF (210) can be determined from the information provided by the UE (400), routing of User Plane data towards UPF(s), routing of Control Plane information towards AMF (210), connection setup and release, scheduling and transmission of paging messages (originated from the AMF (210)), scheduling and transmission of system broadcast information (originated from the AMF (210) or Operation and Maintenance), transport level packet marking in the uplink; session management; support of network slicing, QoS flow management and mapping to data radio bearers, support of UEs (400a, 400b, 400c, 400d and 400e) in RRC_INACTIVE state, distribution function for non-access stratum (NAS) messages, radio access network sharing, dual connectivity, to name a few.

The processor (401 or 501) may be a general-purpose processor, a digital signal processor (DSP), a plurality of microprocessors, a single core, or a multi-core processor, one or more microprocessors in association with a DSP core, a controller, a microcontroller, Application-Specific Integrated Circuits (ASICs), Field Programmable Gate Array (FPGAs) circuits, any other type of integrated circuit (IC), or the like. The processor (401 or 501) may perform signal coding/decoding, data processing, power control, input/output processing, or any other functionality that enables the user equipment to operate in a wireless environment. The processor (401 or 501) may be coupled to a transceiver (402 or 502-1 . . . 502-n) that may be further coupled to the antenna(s) (403 or 503-1 . . . 503-n). While the processor (401 or 501) and the transceiver (402 or 502-1 . . . 502-n) may be separate components, it is appreciated that the processor (401 or 501) and the transceiver (402 or 502-1 . . . 502-n) may be integrated in an electronic package or chip.

The antenna(s) (403 or 503-1 . . . 503-n) may include a plurality of antennas or an antenna array. The antenna(s) (403 or 503-1 . . . 503-n) is/are capable of transmitting/receiving on the entire Radio spectrum including the mmWave spectrum.

The transceiver (402 or 502-1 . . . 502-n) may be configured to modulate the signals that are to be transmitted by the antenna(s) (403 or 503-1 . . . 503-n) and to demodulate the signals that are received by the antenna(s) (403 or 503-1 . . . 503-n).

The memory (407 or 507) may include a non-removable memory or a removable memory. The non-removable memory may include a random-access memory (RAM), read-only memory (ROM), a hard disk, SSD, or any other type of memory storage device. The removable memory may include a subscriber identity module (SIM) card, a memory stick, a secure digital (SD) memory card, and the like. The memory (407 or 507) may be used for storing instructions used by the processor (401 or 501) for performing various user equipment functions including but not limited to cellular transmission and receptions. The cellular transmission and reception functions may include transmission and reception of physical channels and signals (for example, PUSCH, PUCCH, PRACH, SRS, DMRS, PDSCH, PBCH, PDCCH, PSS, SSS, DMRS, CSI-RS, and PTRS) or may include transmission and reception of higher layer data and control signaling (for example, RRC, MAC, RLC, PDCP, NAS and SDAP).

In this specification, terms such as Component Carrier (CC) or Cell may be used interchangeably. Similarly, terms such as Downlink Control Channel (PDCCH) or Downlink Control Information (DCI) may be used interchangeably.

Further, in this specification, terms such as Cell1, Cell2, Cell3, and Cell4 corresponds to or indicate the respective Cell index and may be used interchangeably.

Furthermore, in this specification, terms such as PUCCH group and PUCCH cell group may be used interchangeably.

### Carrier Aggregation (CA)

Carrier Aggregation (CA) allows two or more Component Carriers (CCs) or cells to be aggregated. As such a base station may simultaneously transmit or receive two or more CCs. Similarly, a UE may simultaneously receive or transmit on two or more CCs:
A UE with single timing advance capability for CA can simultaneously receive and/or transmit on multiple CCs corresponding to multiple serving cells sharing the same timing advance (multiple serving cells grouped in one TAG).
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell.

CA is supported for both contiguous and non-contiguous CCs. When CA is deployed, frame timing and SFN are aligned across cells that can be aggregated, or an offset in multiples of slots between the PCell/PSCell and an SCell may be configured. In 5G NR, the maximum number of configured CCs for a UE is 16 for DL and 16 for UL. In LTE up to 32 CCs might be configured for UL/DL.

A base station may configure CA based on the UE capability, UE transmission requirement, and the cell channel conditions. The base station may configure itself to perform CA. The BS may then send RRC signalling to a UE for purposes of configuring the UE for CA. A UE may be configured to perform CA by RRC signalling received from a base station.

A UE may also be configured to perform CA with two base stations in a dual-connectivity scenario.

### Cross Carrier Scheduling

In conventional Cross-carrier scheduling, the Carrier Indicator Field (CIF) allows the PDCCH of a serving cell to schedule resources on another serving cell but with the following restrictions:
When cross-carrier scheduling from an SCell to PCell is not configured, PCell can only be scheduled via its PDCCH;
When cross-carrier scheduling from an SCell to PCell is configured:
PDCCH on that SCell can schedule PCell's PDSCH and PUSCH;
PDCCH on the PCell can schedule PCell's PDSCH and PUSCH but cannot schedule PDSCH and PUSCH on any other cell;
Only one SCell can be configured to be used for cross-carrier scheduling to PCell.
When an SCell is configured with a PDCCH, that cell's PDSCH and PUSCH are always scheduled by the PDCCH on this SCell;
When an SCell is not configured with a PDCCH, that SCell's PDSCH and PUSCH are always scheduled by a PDCCH on another serving cell;
The scheduling PDCCH and the scheduled PDSCH or PUSCH can use the same or different numerologies.

The current specification enables UE to receive a single DCI from a base station and schedule PUSCH or PDSCH per cell on each of a plurality of cells. The single DCI may cross-carrier schedule a plurality of cells or self-schedule itself along with cross-carrier scheduling one or more other cell(s).

Configuring Base Station (BS) and UE with CA and Cross Carrier Scheduling

A BS may configure itself to perform CA. The BS may then send RRC signalling to a UE for purposes of configuring the UE for CA. A UE may be configured to perform CA by RRC signalling received from a base station. The RRC signalling may include parameters such as CellGroupConfig for adding additional Scells. The RRC signalling may include parameter sCellToAddModList for adding cells.

Further, a BS may configure itself to perform cross-carrier scheduling. The BS may then send RRC signalling to a UE for purposes of configuring the UE for cross-carrier scheduling. UE may be configured to perform cross-carrier scheduling by RRC signalling received from a base station. The RRC signalling may include the CrossCarrierSchedulingConfig parameter to indicate the secondary cell (Scell) is cross-carrier scheduled by which Scell or Pcell (Primary cell). The RRC signalling may also include signalling for configuring Pcell to be cross-carrier scheduled by another Scell.

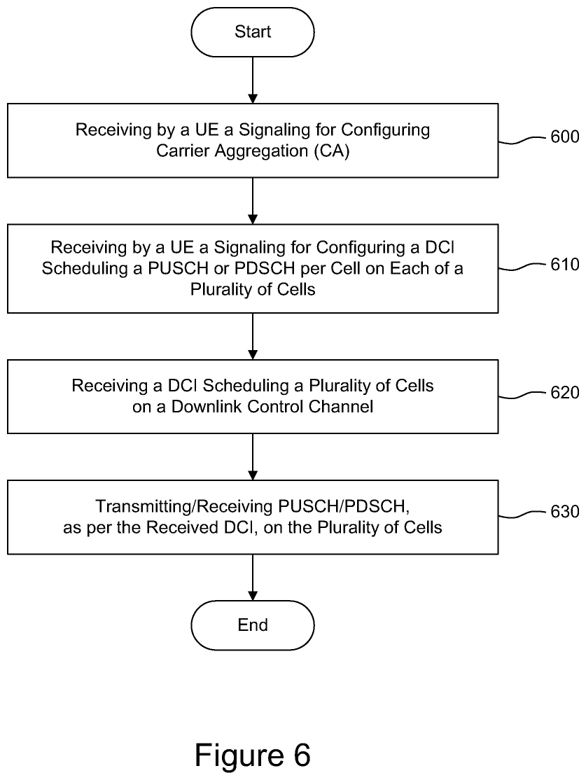

According to an embodiment, as shown in FIG. 6, a UE receives a signalling for configuring Carrier aggregation (CA) (600) from a base station and the UE configures itself for CA. The UE may also receive a signalling for configuring a DCI scheduling a PUSCH or PDSCH per cell on each of a plurality of cells (610) from a base station and the UE configures itself for DCI scheduling a PUSCH or PDSCH per cell on each of a plurality of cells. The UE may be configured for CA (600) and DCI scheduling a PUSCH or PDSCH on a plurality of cells (610), using one or more RRC messages transmitted by one or more base stations (e.g., during the initial configuration of CA or during reconfiguration of CA). Once UE is configured with CA (600) and DCI scheduling a PUSCH or PDSCH per cell on each of a plurality of cells (610), the UE may receive a PDCCH containing a DCI for scheduling the plurality of cells (620) and based on the received DCI, the UE may transmit/receive the PUSCH or PDSCH (630) on the scheduled cells.

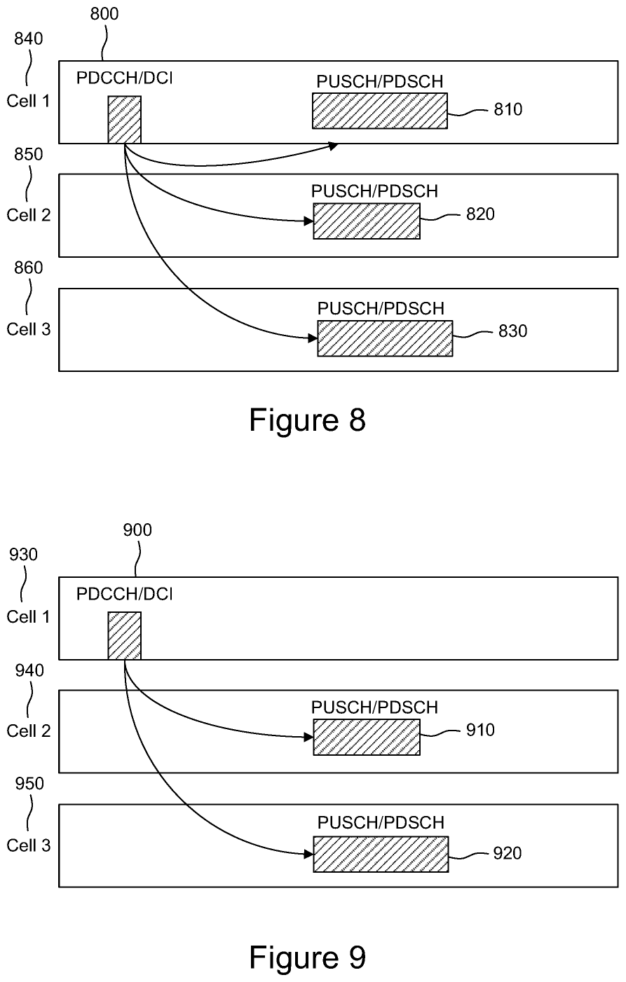

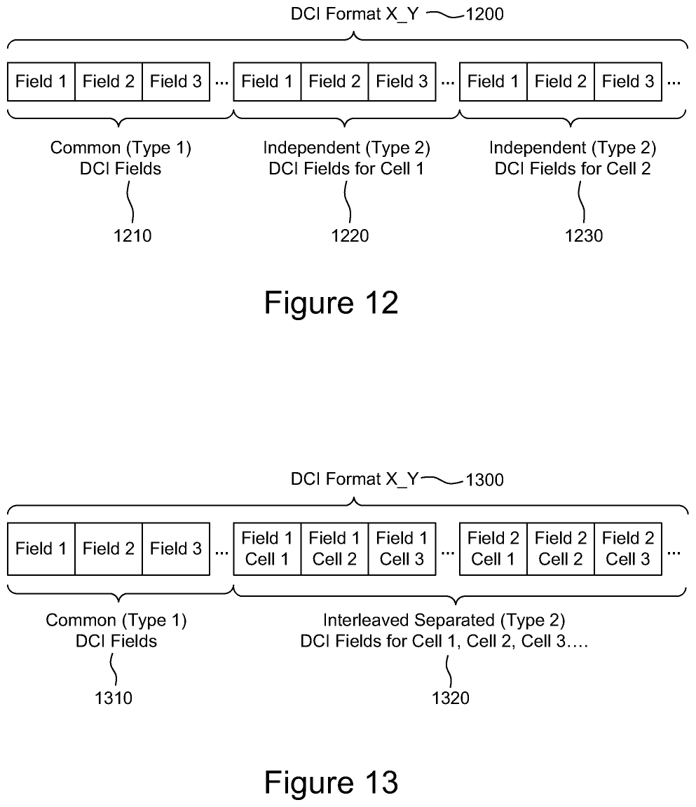

Further, in the step 620, the UE may receive the PDCCH containing the DCI (800) on a scheduling cell (840) for scheduling the plurality of cells (840, 850, 860) as shown in FIG. 8 for self-scheduling a PUSCH or PDSCH (810) and cross-carrier scheduling PUSCH or PDSCH (820, 830) on other co-scheduled cells (850, 860). Alternatively, the UE may receive the PDCCH containing the DCI (900) on a scheduling cell (930) for scheduling the plurality of cells (940, 950) as shown in FIG. 9 for cross-carrier scheduling PUSCHs or PDSCHs (910, 920) on other co-scheduled cells (940, 950). The format of DCI (800, 900) may refer to one of the DCI formats disclosed in the embodiments in conjunction with the FIGS. 12-19.

In another embodiment, the UE receives the RRC configuration message/s for configuring CA (600) and DCI scheduling PUSCH or PDSCH per cell on each of a plurality of cells (610) from a base station different from a base station transmitting the PDCCH containing the DCI for scheduling PUSCH or PDSCH per cell on each of a plurality of cells (620). The UE may transmit/receive the PUSCH or PDSCH (630) to/from the base station from which it received the DCI (620).

In another embodiment, the UE receives the RRC configuration message/s for configuring CA (600) and DCI scheduling PUSCH or PDSCH per cell on each of a plurality of cells (610) from a same base station transmitting the PDCCH containing the DCI for scheduling a PUSCH or PDSCH on a plurality of cells (620).

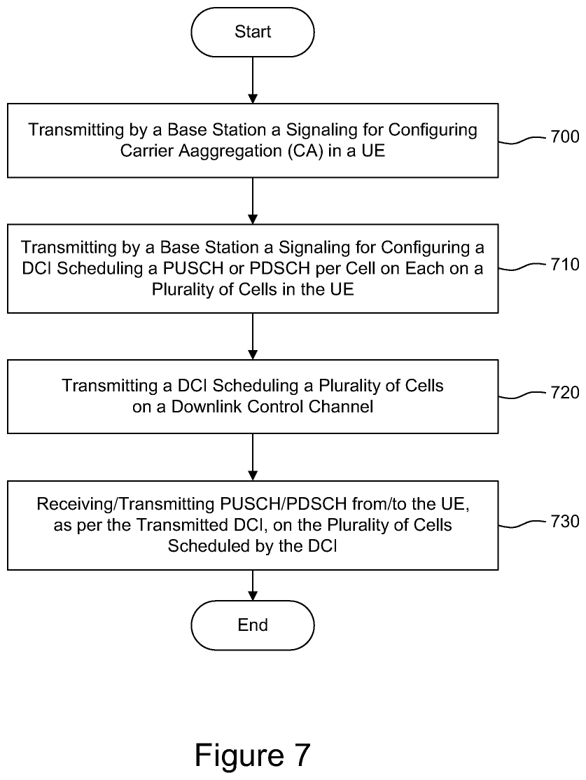

According to an embodiment, as shown in FIG. 7, a base station transmits signalling for configuring CA in a UE (700) and signalling for configuring a DCI scheduling PUSCH or PDSCH per cell on each of a plurality of cells with a single DCI in the UE (710). The base station may configure CA (700) and DCI scheduling PUSCH or PDSCH per cell on each of a plurality of cells (710), using one or more RRC messages (e.g., during the initial configuration of CA or during reconfiguration of CA). Once UE is configured with CA based on signalling received in 700 and configured with DCI scheduling PUSCH or PDSCH per cell on each of a plurality of cells based on signalling received in 710, the base station may transmit a PDCCH containing a DCI for scheduling the plurality of cells (720) and based on the transmitted DCI, the base station may receive/transmit the PUSCH/PDSCH from/to UE on the plurality of cells configured by DCI scheduling PUSCH or PDSCH per cell on each of a plurality of cells (730).

Further, in the step 720, the base station may transmit, and the UE may receive the PDCCH containing the DCI (800) on a scheduling cell (840) for scheduling the plurality of cells (840,850,860) as shown in FIG. 8 for self-scheduling a PUSCH or PDSCH (810) and cross-carrier scheduling PUSCH or PDSCH (820, 830) on other co-scheduled cells (850, 860). Alternatively, the UE may receive the PDCCH containing the DCI (900) on a scheduling cell (930) for scheduling the plurality of cells (940, 950) as shown in FIG. 9 for cross-carrier scheduling PUSCHs or PDSCHs (910, 920) on other co-scheduled cells (940, 950). The format of DCI (800, 900) may refer to one of the DCI formats disclosed in the embodiments described in conjunction with the FIGS. 12-19.

In another embodiment, the base station transmitting the RRC configuration message/s for configuring UE with CA (700) and DCI scheduling PUSCH or PDSCH per cell on each of a plurality of cells (710) is different from a base station transmitting the PDCCH containing the DCI for scheduling PUSCH or PDSCH per cell on each of a plurality of cells (720). The same base station may receive or transmit the PUSCH or PDSCH (730) from or to UE that transmitted the DCI (720).

In another embodiment, the base station transmitting the RRC configuration message/s for configuring UE with CA (700) and DCI scheduling PUSCH or PDSCH per cell on each of a plurality of cells (710) is the same base station transmitting the PDCCH containing the DCI for scheduling PUSCH or PDSCH per cell on each of a plurality of cells (720).

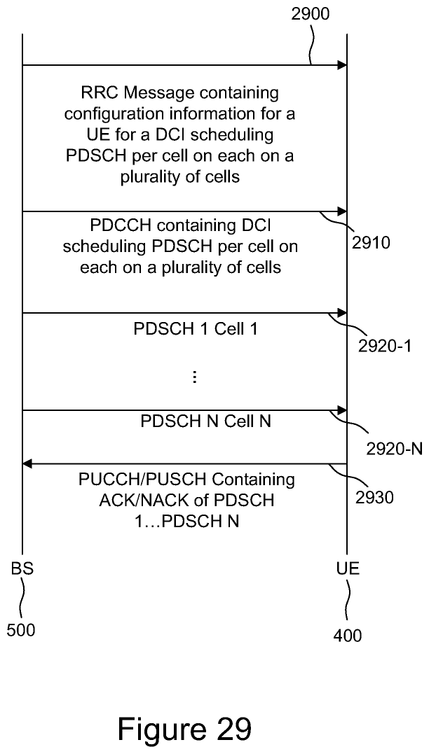

In another embodiment as shown in FIG. 29, a BS (500) (for example, a base station disclosed in conjunction with the description of FIG. 5) transmits, and a UE (400) (for example, a UE disclosed in conjunction with the description of FIG. 4) receives RRC message(s) (2900) containing information for configuring a UE (400) for DCI scheduling PDSCH per cell on each of a plurality of cells. Based on the received RRC message(s) (2900), a UE (400) configures itself for receiving a DCI scheduling PDSCH per cell on each of a plurality of cells. The plurality of cells may belong to a same PUCCH group. Once a UE (400) is configured, a BS (500) transmits and the UE (400) receives a PDCCH (2910) in a user-specific search space (USS) of a scheduling cell as configured by the RRC message(s) (2900), the PDCCH (2910) contains a DCI scheduling PDSCH per cell on each of a plurality of cells. The scheduling cell as configured by the RRC message(s) (2900) may indicate a Pcell, PSCell, or Scell. The UE (400) may blind-decode the received PDCCH (2910). Based on the received DCI information contained in the decoded PDCCH (2910) and/or the RRC message(s) (2900) received, the UE (400) may identify a plurality of scheduled cells and resources on which PDSCHs are scheduled to be received by the UE (400). The BS (500) transmits, and the UE (400) may receive the PDSCH on each of the plurality of scheduled cells (2920-1 . . . 2920-N). Each received PDSCH (2920-1 . . . 2920-N) may include a different transport block (TB). A transport block may contain one or more code block groups (CBG) and each CBG contains one or more code blocks. Based on the correct decoding or reception of PDSCH on each of the scheduled cells (2920-1 . . . 2920-N), the UE (400) may determine the ACK/NACK information (2930) for each of the transport blocks or one or more CBGs within the transport blocks, once ACK/NACK information (2930) is determined for all the received PDSCHs (2920-1 . . . 2920-N), in an embodiment, a UE (400) may transmit ACK/NACK information (2930) for all the received transport blocks or CBGs to the BS (500) on a PUCCH channel where the PUCCH channel resources are determined based on PUCCH resource indicator Type 1A field in the received DCI. In another embodiment, a UE (400) may transmit ACK/NACK information (2930) for a subset of the received transport blocks or CBGs to the BS (500) on a PUCCH channel where the PUCCH channel resources are determined based on PUCCH resource indicator Type 1A field in the received DCI. The subset of the received transport blocks or CBGs for which ACK/NACK information (2930) is to be transmitted to the BS (500) by the UE (400) is determined by a timing threshold parameter. The timing threshold parameter may indicate the timing between the received PDSCH and the PUCCH resource timing. For example, ACK/NACK information (2930) of a subset of transport blocks or CBGs may be transmitted in a PUCCH resource occasion occurring before or equal to the timing of the timing threshold parameter, ACK/NACK information (2930) of the remaining subset of transport blocks or CBGs may be transmitted in a subsequent PUCCH resource occasion. An example of a timing threshold parameter may include a PDSCH-to-HARQ timing indicator Type 1A field in the received DCI. In yet another embodiment, a UE (400) may transmit ACK/NACK information (2930) for all the received transport blocks or CBGs to the BS (500) on a PUSCH channel when the PUCCH channel resources are determined based on PUCCH resource indicator Type 1A field in the received DCI overlaps with the timing of the PUSCH transmission. In yet another embodiment, a UE (400) may transmit ACK/NACK information (2930) for a subset of the received transport blocks or CBGs to the BS (500) on a PUSCH channel when the PUCCH channel resources are determined based on PUCCH resource indicator Type 1A field in the received DCI overlaps with the timing of the PUSCH transmission.

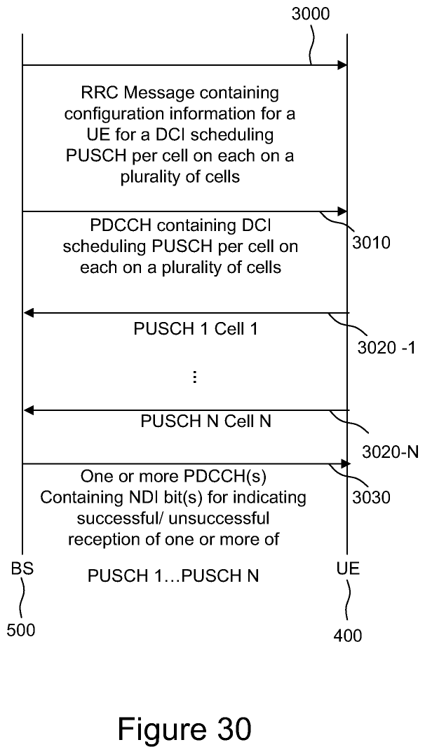

In another embodiment as shown in FIG. 30, a BS (500) (for example, a base station disclosed in conjunction with the description of FIG. 5) transmits, and a UE (for example, a UE (400) disclosed in conjunction with the description of with FIG. 4) receives RRC message(s) (3000) containing information for configuring a UE (400) for DCI scheduling PUSCH per cell on each of a plurality of cells. Based on the received RRC message(s) (3000), a UE (400) configures itself for receiving a DCI scheduling PUSCH per cell on each of a plurality of cells. The plurality of cells may belong to the same PUCCH group. Once a UE (400) is configured, the BS (500) transmits and the UE (400) receives a PDCCH (3010) in a user-specific search space (USS) of a scheduling cell as configured by the RRC message(s) (3000), the PDCCH contains a DCI scheduling PUSCH per cell on each of a plurality of cells. The scheduling cell as configured by the RRC message(s) (3000) may indicate a Pcell, PSCell, or Scell. The UE (400) may blind-decode the received PDCCH (3010). Based on the received DCI information contained in the decoded PDCCH (3010) and/or the RRC message(s) (3000) received, the UE (400) may identify a plurality of scheduled cells and resources on which PUSCHs are scheduled to be transmitted by the UE (400). The BS (500) receives, and the UE (400) may transmit the PUSCH on each of the plurality of scheduled cells (3020-1 . . . 3020-N). Each transmitted PUSCH (3020-1 . . . 3020-N) may include a different transport block (TB). A transport block may contain one or more code block groups (CBG) and each CBG contains one or more code blocks. Based on the correct decoding or reception of PUSCH on each of the scheduled cells (3020-1 . . . 3020-N), the BS (500) may determine the successful/unsuccessful reception information for each of the transport blocks or one or more CBGs within the transport blocks, once successful/unsuccessful reception information is determined for all the received PUSCHs, in an embodiment, a BS (500) may transmit one or more PDCCH(s) containing NDI bit(s) for indicating successful/unsuccessful reception of one or more of PUSCH 1 . . . PUSCH N (3030) for all the received transport blocks or CBGs to a UE (400) on a PDCCH channel where the successful/unsuccessful reception information (3030) may be explicitly or implicitly indicated to the UE (400) by the BS (500) using the NDI bit(s) transmitted in the DCI contained in the PDCCH. In another embodiment, a BS (500) may transmit successful/unsuccessful reception information (3030) for a subset of the received transport blocks or CBGs to a UE (400) on a PDCCH channel where the successful/unsuccessful reception information (3030) may be explicitly or implicitly indicated to the UE (400) by the BS (500) using the NDI bit(s) transmitted in the DCI contained in the PDCCH. The subset of the received transport blocks or CBGs for which successful/unsuccessful reception information (3030) is to be transmitted by the BS (500) to the UE (400) is determined by a timing threshold parameter. The timing threshold parameter may indicate the timing between the received PUSCH and the PDCCH transmission timing. For example, successful/unsuccessful reception information (3030) of a subset of transport blocks or CBGs may be transmitted in a PDCCH resource occasion occurring before or equal to the timing of the timing threshold parameter, successful/unsuccessful reception information (3030) of the remaining subset of transport blocks or CBGs may be transmitted in a subsequent PDCCH resource occasion.

In embodiments as shown in FIG. 29 or 30, the RRC message (for example RRC Message 2900 or 3000) contains information for activation of a DCI scheduling PDSCH/PUSCH per cell on each of the plurality of cells in a PUCCH group in a UE (400). A single bit information for activation may be included in a RRC message (for example RRC Message 2900 or 3000). A RRC message (for example RRC Message 2900 or 3000) may contain separate information for activation of a DCI scheduling PDSCH and a DCI scheduling PUSCH. Separate RRC messages (for example RRC Message 2900 and 3000) may be transmitted by a BS (500) and received by a UE (400), whereby one RRC message (for example RRC Message 2900) may contain information for activation of a DCI scheduling PDSCH and other RRC message (for example RRC Message 3000) may contain information for activation of a DCI scheduling PUSCH. The activation information indicates to the UE that the UE may start monitoring PDCCH channel for receiving a DCI scheduling PDSCH or PUSCH per cell on each of the plurality of cells. The RRC message (for example RRC Message 2900 or 3000) may contain information of a cell (scheduling cell) on which PDCCH (for example 2910 or 3010) containing DCI is to be received by a UE (400). The information of the cell on which PDCCH (for example 2910 or 3010) containing DCI is to be received may include cell index. The cell (scheduling cell) on which PDCCH (for example 2910 or 3010) containing DCI is to be received by the UE (400) may indicate any of Pcell, PSCell, or Scell. The RRC message (for example RRC Message 2900 or 3000) may contain information on cells on which PDSCH/PUSCH is to be received/transmitted by a UE (400). The information of cells may include at least one of cell indices, CSCI information and/or its association information with one or more cell combinations, number of cells (2, 3, 4, or 8), or a cell group ID (or PUCCH group ID). The CSCI information and/or its association information with one or more cell combinations may include a combination of co-scheduled cells with corresponding CSCI value(s) (for example, a combination of cells and CSCI as shown in table 5). The CSCI and/or its association information may be changed dynamically by a BS (500) depending on the number of cells configured for carrier aggregation. A separate combination of CSCI and/or its association information may be set for PDSCH scheduling and PUSCH scheduling by a BS (500) for a UE (400) and the UE (400) may configure itself for a separate combination of CSCI and/or its association information for PDSCH scheduling and PUSCH scheduling based on RRC message(s) (for example RRC Message 2900 or 3000) received from the BS (500). The RRC message (for example RRC Message 2900 or 3000) may also contain information about a reference cell within the PUCCH cell group for timing purposes. The information of a reference cell may refer to an SCell if there is no PCell or PScell in the PUCCH group, in case the PUCCH cell group contains a PCell or a PSCell, the RRC message (for example RRC Message 2900 or 3000) may contain explicit information of a PCell or a PScell, or a UE (400) may derive the reference cell to be a PCell or a PSCell based on the configuration of a PUCCH group established during a carrier aggregation step. The RRC message (for example RRC Message 2900 or 3000) may also contain information of DCI size for DCI format 0_X/1_X or PDCCH payload size of a DCI scheduling PDSCH/PUSCH per cell on each of the plurality of cells in a PUCCH group in the UE (400). The DCI size for DCI formats 0_X/1_X or PDCCH payload size may indicate the bit length of the DCI and a UE (400) may use the DCI size or payload size information in blind decoding the PDCCH. The DCI size for DCI formats 0_X/1_X may depend on number of configured co-scheduled cells and enable/disable status of offset coding for one or more Type 2 DCI fields such as MCS and FDRA fields. In case the DCI size for the configured set of co-scheduled cells comes out to be more than 140 bits, a BS (500) may reduce the number of configured cells for co-scheduling, or a BS (500) may enable the offset coding to reduce the size of DCI field within 140 bits. The DCI size for DCI formats 0_X/1_X or PDCCH payload size may be configured semi-statically and remains same for the period till a new RRC message (for example RRC Message 2900 or 3000) is received by a UE (400). The DCI size for DCI format 0_X and the DCI size for DCI format 1_X may be configured differently from each other. Also, the number of cells configured for scheduling via DCI format 0_X may vary from the number of cells configured for scheduling via DCI format 1_X.

The RRC message (for example RRC Message 2900 or 3000) may contain information of one or more DCI Type 1B fields as shown in Table 9 and 10 for PDSCH and PUSCH scheduling. The Type 1B field is a single field indicating separate information to each of the co-scheduled cells via joint indication. In an embodiment, a joint indication may use a bit map where a separate bit is assigned for each cell, for example, in the case of three co-scheduled cells Cell1, Cell2, and Cell3, an exemplary Type 1B field such as SRS request field may be configured using 3 bits each indicating SRS request for the corresponding cell. For instance, the SRS request field containing 101 may indicate SRS request for Cell 1 and Cell3 and no SRS request for Cell 2. In another embodiment, a joint indication may use predefined bits for indicating different values for different cells using bits in a Type 1B field. For example, a Time domain resource assignment (TDRA) field for indicating time domain resources for PDSCH or PUSCH reception/transmission among the scheduled cells. The TDRA field may indicate one or more parameters including SLIV, resource mapping type, and scheduling offset K0 (or K2) for multiple scheduled cell(s). The RRC signaling may contain information of various combination of cells and corresponding TDRA values and parameter values as shown in table 12 or 13. For instance, in case of 3 scheduled cells, the TDRA field may indicate as shown in tables 12 and 13 below:

TABLE 12
for PDSCH

| TDRA Field | Cell1 | Cell2 | Cell3 |
|---|---|---|---|
| 0000 | SLIV: X1 | SLIV: X2 | SLIV: X3 |
| | Resource Mapping type: | Resource Mapping type: | Resource Mapping type: |
| | Type A | Type B | Type A |
| | Scheduling offset K0: Z1 | Scheduling offset K0: Z2 | Scheduling offset K0: Z1 |
| | . . . | . . . | . . . |
| 1110 | SLIV: X2 | SLIV: X4 | SLIV: X5 |
| | Resource Mapping type: | Resource Mapping type: | Resource Mapping type: |
| | Type B | Type B | Type B |
| | Scheduling offset K0: Z1 | Scheduling offset K0: Z1 | Scheduling offset K0: Z1 |
| 1111 | SLIV: X1 | SLIV: X3 | SLIV: X4 |
| | Resource Mapping type: | Resource Mapping type: | Resource Mapping type: |
| | Type A | Type A | Type A |
| | Scheduling offset K0: Z2 | Scheduling offset K0: Z2 | Scheduling offset K0: Z2 |

TABLE 13
for PUSCH

| TDRA Field | Cell1 | Cell2 | Cell3 |
|---|---|---|---|
| 0000 | SLIV: X1 | SLIV: X2 | SLIV: X3 |
| | Resource Mapping type: | Resource Mapping type: | Resource Mapping type: |
| | Type A | Type B | Type A |
| | Scheduling offset K2: Z1 | Scheduling offset K2: Z2 | Scheduling offset K2: Z1 |
| | . . . | . . . | . . . |
| 1110 | SLIV: X2 | SLIV: X4 | SLIV: X5 |
| | Resource Mapping type: | Resource Mapping type: | Resource Mapping type: |
| | Type B | Type B | Type B |
| | Scheduling offset K2: Z1 | Scheduling offset K2: Z1 | Scheduling offset K2: Z1 |
| 1111 | SLIV: X1 | SLIV: X3 | SLIV: X4 |
| | Resource Mapping type: | Resource Mapping type: | Resource Mapping type: |
| | Type A | Type A | Type A |
| | Scheduling offset K2: Z2 | Scheduling offset K2: Z2 | Scheduling offset K2: Z2 |

In table 12 and 13, values X1, X2, and X3 indicates different values corresponding to the SLIV. Similarly, Z1 and Z2 indicates different values corresponding to the Scheduling offset.

Optionally, number of slots used for TBS determination, number of repetitions, and repetition type may also be indicated in RRC message(s) (for example RRC Message 2900 or 3000) in addition to the parameters shown in table 13.

The RRC message (for example RRC Message 2900 or 3000) may additionally contain information of one or more DCI Type 1B fields includes one or more of a field name/identifier, joint indication bits and corresponding values for each cell for creating a table to be used for determining the values for each scheduled cell corresponding to the received bits in a DCI Type 1B field, or a number of bits to be used for Type 1B DCI field.

The RRC message (for example RRC Message 2900 or 3000) may contain information of one or more DCI Type 1C fields for PUSCH or PDSCH scheduling. The Type 1C field is a single field indicating information to only one of the co-scheduled cells. The information of one or more DCI Type 1C fields includes one or more of a field name/identifier, a cell index for which the field would be applicable, or a number of bits to be used for Type 1C DCI field.

The RRC message (for example RRC Message 2900 or 3000) may contain information of one or more DCI Type 3 fields for PUSCH or PDSCH scheduling. The Type 3 DCI field is common or separate to each of the co-scheduled cells, or separate to each sub-group of cells, dependent on RRC or Network configuration. The RRC message (for example RRC Message 2900 or 3000) may contain information on which Type 3 DCI field(s) is/are configured as Type 1A/1B/1C DCI field(s) and/or which Type 3 DCI field(s) is/are configured as Type 2 DCI field(s). The information of one or more DCI Type 3 fields includes one or more of a field name/identifier, cell index if the Type 3 DCI field is configured as Type 1C DCI field for a cell, cell indices or sub-group identifier(s) if the Type 3 DCI field is configured as Type 2 DCI field for each sub-group of cells, or number of bits to be used for each Type 3 DCI field which is configured as Type 1A/1B/1C DCI field(s) or Type 2 DCI field(s).

In another embodiment as shown in FIG. 29 or 30, the RRC message (for example RRC Message 2900 or 3000) may contains information of subcarrier spacing (SCS) to be used by a plurality of cells scheduled using a single DCI for PDSCH/PUSCH per cell on each of the plurality of cells. In an embodiment, the same SCS may be configured for all the co-scheduled cells as well as the scheduling cell. In another embodiment, the same SCS may be configured for all the co-scheduled cells and scheduling cell may have different SCS. In yet another embodiment, at least one cell either scheduling cell or scheduled cell may be configured with different SCS from the other co-scheduled cells.

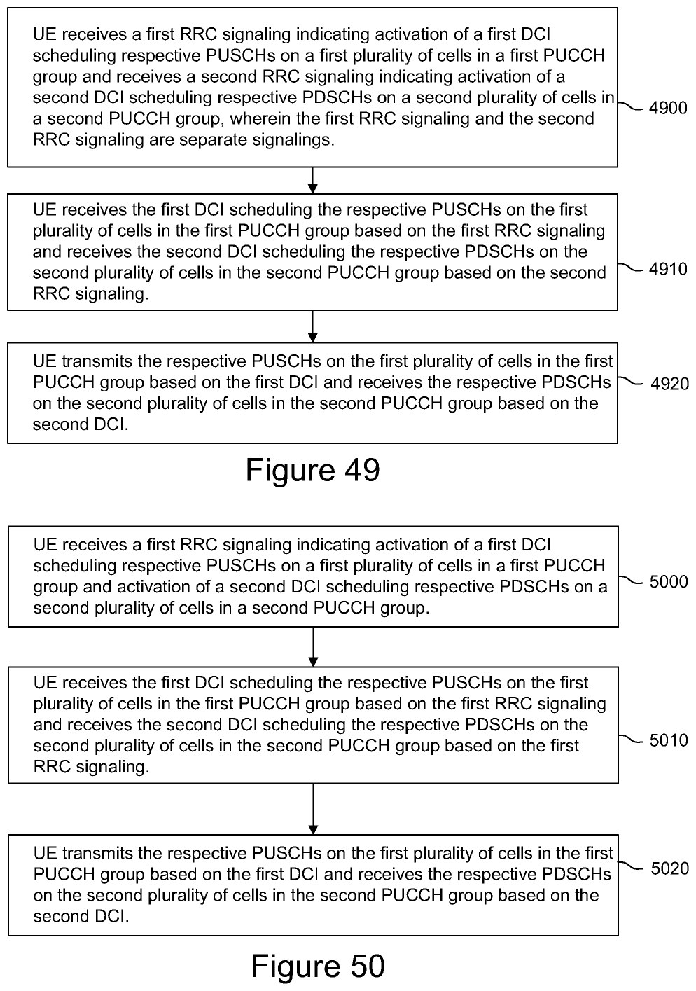

In another embodiment as shown in FIG. 49, a UE (for example, a UE as shown in conjunction with FIG. 4) may receive from a BS (for example, a BS as shown in conjunction with FIG. 5) a first RRC signaling indicating activation of a first DCI scheduling respective PUSCHs on a first plurality of cells in a first PUCCH group and receives a second RRC signaling indicating activation of a second DCI scheduling respective PDSCHs on a second plurality of cells in a second PUCCH group, wherein the first RRC signaling and the second RRC signaling are separate signalings (4900). The first RRC signaling may refer to a RRC signaling 3000 as shown in FIG. 30 and the second RRC signaling may refer to a RRC signaling 2900 as shown in FIG. 29. Based on the received first and second RRC signalings the UE configures itself for monitoring PDCCH search spaces for the first DCI and the second DCI formats. The UE receives the first DCI scheduling respective PUSCHs on the first plurality of cells in the first PUCCH group based on the first RRC signaling and receives the second DCI scheduling respective PDSCHs on the second plurality of cells in the second PUCCH group based on the second RRC signaling (4910). The UE transmits the respective PUSCHs on the first plurality of cells in the first PUCCH group based on the first DCI and receives the respective PDSCHs on the second plurality of cells in the second PUCCH group based on the second DCI (4920). The first and the second DCI may refer to any one of the DCI formats disclosed in the description in conjunction with FIG. 12-19 or 22-26. The first DCI and the second DCI may be received by the UE in different time/frequency slots. Similarly, the UE transmits the respective PUSCH for the first plurality of cells and receives the respective PDSCH for the second plurality of cells in different times time/frequency slots. The first PUCCH group and the second PUCCH group may have at least one cell which is not common. In an alternative embodiment, the first PUCCH group and the second PUCCH group may have identical cells.

The first RRC signaling may further include information of a scheduling cell on which the first DCI scheduling the respective PUSCHs on the first plurality of cells is received. The scheduling cell on which the first DCI scheduling the respective PUSCHs on the first plurality of cells is received by the UE is part of the first PUCCH group but may or may not be a part of the first plurality of cells. The first RRC signaling may further include information of the first plurality of cells on which the respective PUSCHs are to be transmitted and the information of the first plurality of cells may include the respective cell indices. The first RRC signaling may further includes CSCI information and its association information with one or more combinations of the subsets of the first plurality of cells and/or at least one association may indicate all the cells in the first plurality of cells, and the CSCI information may be indicated in the first DCI scheduling the respective PUSCHs on the first plurality of cells or the subset of the first plurality of cells. The first RRC signaling may further include information of number of cells in the first plurality of cells and the information of the number of cells in the first plurality of cells may be selected from 2, 3, 4, or 8. The first RRC signaling may further includes information of a cell group ID of the first plurality of cells or a PUCCH group ID of the first PUCCH group. The first RRC signaling may further includes information of a reference cell within the first PUCCH group for the purpose of determining transmission timing of the respective PUSCHs by the UE on the first plurality of cells or for determining timing of receiving feedback (may be on PDCCH) of the transmitted PUSCHs by the UE on at least one cell of the first plurality of cells. The first RRC signaling may further includes information of one or more first DCI fields in the first DCI configured for indicating separate information for a set of scheduled cells and the set of scheduled cells corresponds to the first plurality of cells or a subset of cells from the first plurality of cells. The information of the one or more first DCI fields includes two or more of first DCI field names or first DCI field identifiers, number of bits to be used for the first DCI fields, or joint indication bits and corresponding values for each scheduled cell of the set of scheduled cells wherein the joint indication bits are included in the first DCI when the one or more first DCI fields are used for scheduling the respective PUSCHs on the first plurality of cells in the first PUCCH group. The one or more first DCI fields in the first DCI may refer to a Time domain resource assignment (TDRA) field or an SRS request field. The first RRC signaling may further includes information of one or more second DCI fields in the first DCI which are dynamically configured based on a network configuration as common fields for indicating common information for a set of scheduled cells or as separate fields for indicating separate information for each scheduled cell of a set of scheduled cells and the set of scheduled cells corresponds to the first plurality of cells or a subset of cells from the first plurality of cells. The information of the one or more second DCI fields in the first DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The one or more second DCI fields in the first DCI may refer to an Antenna port(s) field, an SRS resource indicator field or a Precoding information and number of layers field.

The second RRC signaling may further include information of a scheduling cell on which the second DCI scheduling the respective PDSCHs on the second plurality of cells is received. The scheduling cell on which the second DCI scheduling the respective PDSCHs on the second plurality of cells is received is part of the second PUCCH group but may or may not be a part of the second plurality of cells. The second RRC signaling may further include information of the second plurality of cells on which the respective PDSCHs are to be received and the information of the second plurality of cells may include the respective cell indices. The second RRC signaling may further includes CSCI information and its association information with one or more combinations of the subsets of the second plurality of cells and/or at least one association may indicate all the cells in the second plurality of cells and the CSCI information may be indicated in the second DCI scheduling the respective PDSCHs on the second plurality of cells or the subset of the second plurality of cells. The second RRC signaling may further include information of number of cells in the second plurality of cells and the information of the number of cells in the second plurality of cells may be selected from 2, 3, 4, or 8. The second RRC signaling may further include information of a cell group ID of the second plurality of cells or a PUCCH group ID of the second PUCCH group. The second RRC signaling may further include information of a reference cell within the second PUCCH group for the purpose of determining reception timing of the respective PDSCHs by the UE on the second plurality of cells or for determining timing of transmitting feedback (may be on PUCCH or PUSCH) of the received PDSCHs by the UE on at least one cell of the second plurality of cells. The second RRC signaling may further includes information of one or more first DCI fields in the second DCI configured for indicating separate information for a set of scheduled cells and the set of scheduled cells corresponds to the second plurality of cells or a subset of cells from the second plurality of cells. The information of the one or more first DCI fields includes two or more of DCI field names or DCI field identifiers, number of bits to be used for the first DCI fields, or joint indication bits and corresponding values for each scheduled cell of the set of scheduled cells wherein the joint indication bits are included in the second DCI when the first DCI field is used for scheduling the respective PDSCHs on the second plurality of cells in the second PUCCH group. The one or more first DCI fields in the second DCI may refer to a Time domain resource assignment (TDRA) field or an SRS request field. The second RRC signaling may further includes information of one or more second DCI fields in the second DCI which are dynamically configured based on a network configuration as common fields for indicating common information for a set of scheduled cells or as separate fields for indicating separate information for each scheduled cell of a set of scheduled cells and the set of scheduled cells corresponds to the second plurality of cells or a subset of cells from the second plurality of cells. The information of the one or more second DCI fields in the second DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The second DCI field in the second DCI may refer to an Antenna port(s) field.

In another embodiment as shown in FIG. 50, a UE (for example, a UE as shown in conjunction with FIG. 4) may receive from a BS (for example, a BS as shown in conjunction with FIG. 5) a first RRC signaling indicating activation of a first DCI scheduling respective PUSCHs on a first plurality of cells in a first PUCCH group and activation of a second DCI scheduling respective PDSCHs on a second plurality of cells in a second PUCCH group (5000). The first RRC signaling may refer to a RRC signaling 3000 as shown in FIG. 30 or to a RRC signaling 2900 as shown in FIG. 29. Based on the received first RRC signaling the UE configures itself for monitoring PDCCH search space for the first DCI and the second DCI formats. The UE receives the first DCI scheduling the respective PUSCHs on the first plurality of cells in the first PUCCH group based on the first RRC signaling and receives the second DCI scheduling the respective PDSCHs on the second plurality of cells in the second PUCCH group based on the first RRC signaling (5010). The UE transmits the respective PUSCHs on the first plurality of cells in the first PUCCH group based on the first DCI and receives the respective PDSCHs on the second plurality of cells in the second PUCCH group based on the second DCI (5020). The first and the second DCI may refer to any one of the DCI formats disclosed in the description in conjunction with FIG. 12-19 or 22-26. The first DCI and the second DCI may be received by the UE in different time/frequency slots. Similarly, the UE transmits the respective PUSCH for the first plurality of cells and receives the respective PDSCH for the second plurality of cells in different times time/frequency slots. The first PUCCH group and the second PUCCH group may have at least one cell which is not common. In an alternative embodiment, the first PUCCH group and the second PUCCH group may have identical cells.

The first RRC signaling may further include information of a scheduling cell on which the first DCI scheduling the respective PUSCHs on the first plurality of cells is received. The scheduling cell on which the first DCI scheduling the respective PUSCHs on the first plurality of cells is received is part of the first PUCCH group but may or may not be a part of the first plurality of cells. The first RRC signaling may further include information of the first plurality of cells on which the respective PUSCHs are to be transmitted and the information of the first plurality of cells may include the respective cell indices. The first RRC signaling may further includes CSCI information and its association information with one or more combinations of the subsets of the first plurality of cells and/or at least one association may indicate all the cells in the first plurality of cells, and the CSCI information may be indicated in the first DCI scheduling the respective PUSCHs on the first plurality of cells or the subset of the first plurality of cells. The first RRC signaling may further include information of number of cells in the first plurality of cells and the information of the number of cells in the first plurality of cells may be selected from 2, 3, 4, or 8. The first RRC signaling may further includes information of a cell group ID of the first plurality of cells or a PUCCH group ID of the first PUCCH group. The first RRC signaling may further includes information of a reference cell within the first PUCCH group for the purpose of determining transmission timing of the respective PUSCHs by the UE on the first plurality of cells or for determining timing of receiving feedback (may be on PDCCH) of the transmitted PUSCH by the UE on at least one cell of the first plurality of cells. The first RRC signaling may further includes information of one or more first DCI fields in the first DCI configured for indicating separate information for a set of scheduled cells and the set of scheduled cells corresponds to the first plurality of cells or a subset of cells from the first plurality of cells. The information of the one or more first DCI field includes two or more of first DCI field names or first DCI field identifiers, number of bits to be used for the first DCI fields, or joint indication bits and corresponding values for each scheduled cell of the set of scheduled cells wherein the joint indication bits are included in the first DCI when the one or more first DCI fields are used for scheduling the respective PUSCHs on the first plurality of cells in the first PUCCH group. The one or more first DCI fields in the first DCI may refer to a Time domain resource assignment (TDRA) field or an SRS request field. The first RRC signaling may further includes information of one or more second DCI fields in the first DCI which are dynamically configured based on a network configuration as common fields for indicating common information for a set of scheduled cells or as separate fields for indicating separate information for each scheduled cell of a set of scheduled cells and the set of scheduled cells corresponds to the first plurality of cells or a subset of cells from the first plurality of cells. The information of the one or more second DCI field in the first DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The one or more second DCI fields in the first DCI may refer to an Antenna port(s) field, an SRS resource indicator field or a Precoding information and number of layers field.

The first RRC signaling may further include information of a scheduling cell on which the second DCI scheduling respective PDSCHs on the second plurality of cells is received. The scheduling cell on which the second DCI scheduling respective PDSCHs on the second plurality of cells is received is part of the second PUCCH group but may or may not be a part of the second plurality of cells. The first RRC signaling may further include information of the second plurality of cells on which the respective PDSCHs are to be received and the information of the second plurality of cells may include the respective cell indices. The first RRC signaling may further includes CSCI information and its association information with one or more combinations of the subsets of the second plurality of cells and/or at least one association may indicate all the cells in the second plurality of cells and the CSCI information may be indicated in the second DCI scheduling the respective PDSCHs on the second plurality of cells or the subset of the second plurality of cells. The first RRC signaling may further include information of number of cells in the second plurality of cells and the information of the number of cells in the second plurality of cells may be selected from 2, 3, 4, or 8. The first RRC signaling may further include information of a cell group ID of the second plurality of cells or a PUCCH group ID of the second PUCCH group. The first RRC signaling may further include information of a reference cell within the second PUCCH group for the purpose of determining reception timing of the respective PDSCHs by the UE on the second plurality of cells or for determining timing of transmitting feedback (may be on PUCCH or PUSCH) of the received PDSCHs by the UE on at least one cell of the second plurality of cells. The first RRC signaling may further includes information of one or more first DCI fields in the second DCI configured for indicating separate information for a set of scheduled cells and the set of scheduled cells corresponds to the second plurality of cells or a subset of cells from the second plurality of cells. The information of the one or more first DCI fields includes two or more of DCI field names or DCI field identifiers, number of bits to be used for the first DCI fields, or joint indication bits and corresponding values for each scheduled cell of the set of scheduled cells wherein the joint indication bits are included in the second DCI when the first DCI field is used for scheduling the respective PDSCHs on the second plurality of cells in the second PUCCH group. The one or more first DCI fields in the second DCI may refer to a Time domain resource assignment (TDRA) field or an SRS request field. The first RRC signaling may further includes information of one or more second DCI fields in the second DCI which are dynamically configured based on a network configuration as common fields for indicating common information for a set of scheduled cells or as separate fields for indicating separate information for each scheduled cell of a set of scheduled cells and the set of scheduled cells corresponds to the second plurality of cells or a subset of cells from the second plurality of cells. The information of the one or more second DCI fields in the second DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The second DCI field in the second DCI may refer to an Antenna port(s) field.

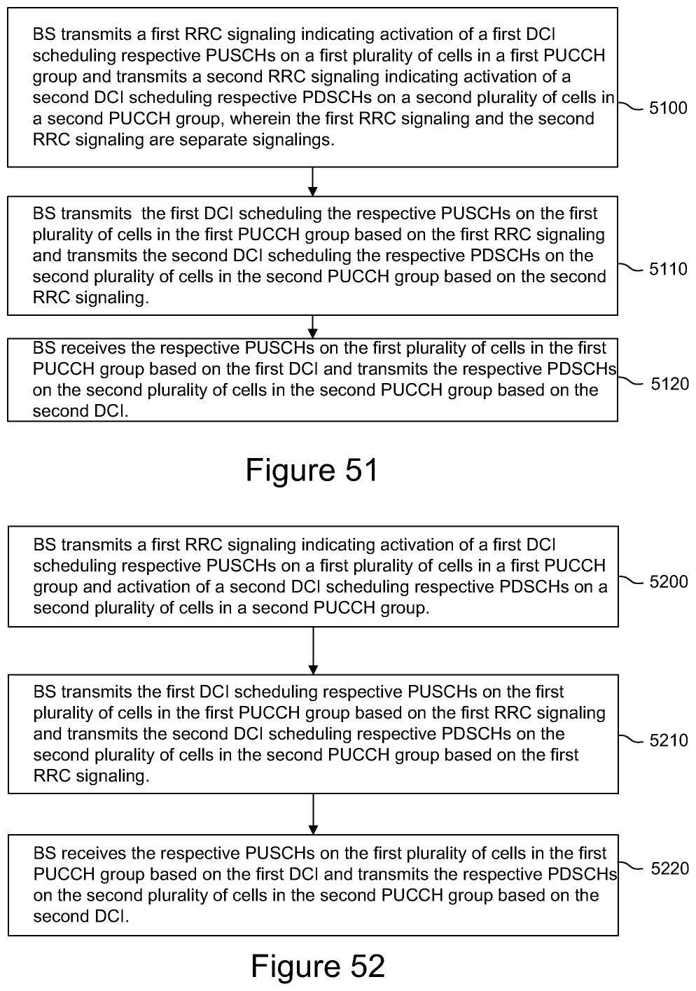

In another embodiment as shown in FIG. 51, a BS (for example, a BS as shown in conjunction with FIG. 5) may transmits to a UE (for example, a UE as shown in conjunction with FIG. 4) a first RRC signaling indicating activation of a first DCI scheduling respective PUSCHs on a first plurality of cells in a first PUCCH group and transmits a second RRC signaling indicating activation of a second DCI scheduling respective PDSCHs on a second plurality of cells in a second PUCCH group, wherein the first RRC signaling and the second RRC signaling are separate signalings (5100). The first RRC signaling may refer to a RRC signaling 3000 as shown in FIG. 30 and the second RRC signaling may refer to a RRC signaling 2900 as shown in FIG. 29. Based on the transmitted first and second RRC signalings the BS configures itself for transmitting PDCCH in the PDCCH search spaces with the first DCI and the second DCI formats. The BS transmits the first DCI scheduling respective PUSCHs on the first plurality of cells in the first PUCCH group based on the first RRC signaling and transmits the second DCI scheduling respective PDSCHs on the second plurality of cells in the second PUCCH group based on the second RRC signaling (5110). The BS receives the respective PUSCHs on the first plurality of cells in the first PUCCH group based on the first DCI and transmits the respective PDSCHs on the second plurality of cells in the second PUCCH group based on the second DCI (5120). The first and the second DCI may refer to any one of the DCI formats disclosed in the description in conjunction with FIG. 12-19 or 22-26. The first DCI and the second DCI may be transmitted by the BS in different time/frequency slots. Similarly, the BS receives the respective PUSCH for the first plurality of cells and transmits the respective PDSCH for the second plurality of cells in different times time/frequency slots. The first PUCCH group and the second PUCCH group may have at least one cell which is not common. In an alternative embodiment, the first PUCCH group and the second PUCCH group may have identical cells.

The first RRC signaling may further include information of a scheduling cell on which the first DCI scheduling the respective PUSCHs on the first plurality of cells is transmitted by the BS. The scheduling cell on which the first DCI scheduling the respective PUSCHs on the first plurality of cells is transmitted by the BS is part of the first PUCCH group but may or may not be a part of the first plurality of cells. The first RRC signaling may further include information of the first plurality of cells on which the respective PUSCHs are to be transmitted by the UE and the information of the first plurality of cells may include the respective cell indices. The first RRC signaling may further include CSCI information and its association information with one or more combinations of the subsets of the first plurality of cells and/or at least one association may indicate all the cells in the first plurality of cells, and the CSCI information may be indicated in the first DCI scheduling the respective PUSCHs in the UE on the first plurality of cells or the subset of the first plurality of cells. The first RRC signaling may further include information of number of cells in the first plurality of cells and the information of the number of cells in the first plurality of cells may be selected from 2, 3, 4, or 8. The first RRC signaling may further includes information of a cell group ID of the first plurality of cells or a PUCCH group ID of the first PUCCH group. The first RRC signaling may further includes information of a reference cell to be used by the UE within the first PUCCH group for the purpose of determining transmission timing of the respective PUSCHs by the UE on the first plurality of cells or for determining timing of receiving feedback (may be on PDCCH) of the transmitted PUSCHs by the UE on at least one cell of the first plurality of cells. The first RRC signaling may further includes information of one or more first DCI fields to be transmitted in the first DCI configured for indicating separate information for a set of scheduled cells and the set of scheduled cells corresponds to the first plurality of cells or a subset of cells from the first plurality of cells. The information of the one or more first DCI field includes two or more of first DCI field names or first DCI field identifiers, number of bits to be used for the first DCI fields, or joint indication bits and corresponding values for each scheduled cell of the set of scheduled cells wherein the joint indication bits are included in the first DCI when the one or more first DCI fields are used for scheduling the respective PUSCHs by the UE on the first plurality of cells in the first PUCCH group. The one or more first DCI fields in the first DCI may refer to a Time domain resource assignment (TDRA) field or an SRS request field. The first RRC signaling may further includes information of one or more second DCI fields to be transmitted in the first DCI which are dynamically configured based on a network configuration as common fields for indicating common information for a set of scheduled cells or as separate fields for indicating separate information for each scheduled cell of a set of scheduled cells and the set of scheduled cells corresponds to the first plurality of cells or a subset of cells from the first plurality of cells. The information of the one or more second DCI field in the first DCI includes second DCI field names or second DCI field identifiers and an indicator of configuration as the common fields for indicating common information for the set of scheduled cells or an indicator of configuration as separate fields for indicating separate information for each scheduled cell of the set of the scheduled cells. The one or more second DCI fields in the first DCI may refer to an Antenna port(s) field, an SRS resource indicator field or a Precoding information and number of layers field.

The second RRC signaling may further include information of a scheduling cell on which the second DCI scheduling the respective PDSCHs on the second plurality of cells is transmitted by the BS. The scheduling cell on which the second DCI scheduling the respective PDSCHs on the second plurality of cells is transmitted by the BS is part of the second PUCCH group but may or may not be a part of the second plurality of cells. The second RRC signaling may further include information of the second plurality of cells on which the respective PDSCHs are to be received by the UE and the information of the second plurality of cells may include the respective cell indices. The second RRC signaling may further includes CSCI information and its association information with one or more combinations of the subsets of the second plurality of cells and/or at least one association may indicate all the cells in the second plurality of cells and the CSCI information may be indicated in the second DCI by the BS for scheduling the respective PDSCHs on the second plurality of cells or the subset of the second plurality of cells. The second RRC signaling may further include information of number of cells in the second plurality of cells and the information of the number of cells in the second plurality of cells may be selected from 2, 3, 4, or 8. The second RRC signaling may further include information of a cell group ID of the second plurality of cells or a PUCCH group ID of the second PUCCH group. The second RRC signaling may further include information of a reference cell to be used by the UE within the second PUCCH group for the purpose of determining reception timing of the respective PDSCHs by the UE on the second plurality of cells or for determining timing of transmitting feedback (may be on PUCCH or PUSCH) of the received PDSCHs by the UE on at least one cell of the second plurality of cells. The second RRC signaling may further includes information of one or more first DCI fields in the second DCI to be transmitted by the BS configured for indicating separate information for a set of scheduled cells and the set of scheduled cells corresponds to the second plurality of cells or a subset of cells from the second plurality of cells. The information of the one or more first DCI fields includes two or more of DCI field names or DCI field identifiers, number of bits to be used for the first DCI fields, or joint indication bits and corresponding values for each scheduled cell of the set of scheduled cells wherein the joint indication bits are included in the second DCI when the first DCI field is used for scheduling the respective PDSCHs by the UE on the second plurality of cells in the second PUCCH group. The one or more first DCI fields in the second DCI may refer to a Time domain resource assignment (TDRA) field or an SRS request field. The second RRC signaling may further includes information of one or more second DCI fields in the second DCI to be transmitted by the BS which are dynamically configured based on a network configuration as common fields for indicating common information for a set of scheduled cells or as separate fields for indicating separate information for each scheduled cell of a set of scheduled cells and the set of scheduled cells corresponds to the second plurality of cells or a subset of cells from the second plurality of cells. The information of the one or more second DCI fields in the second includes second DCI field names or second DCI field identifiers and an indicator of configuration as the common fields for indicating common information for the set of scheduled cells or an indicator of configuration as separate fields for indicating separate information for each scheduled cell of the set of scheduled cells. The second DCI field in the second DCI may refer to an Antenna port(s) field.

In another embodiment as shown in FIG. 52, a BS (for example, a BS as shown in conjunction with FIG. 5) may transmits to a UE (for example, a UE as shown in conjunction with FIG. 4) a first RRC signaling indicating activation of a first DCI scheduling respective PUSCHs on a first plurality of cells in a first PUCCH group and activation of a second DCI scheduling respective PDSCHs on a second plurality of cells in a second PUCCH group (5200). The first RRC signaling may refer to a RRC signaling 3000 as shown in FIG. 30 or to a RRC signaling 2900 as shown in FIG. 29. Based on the transmitted first RRC signaling the BS configures itself for transmitting PDCCH in the PDCCH search spaces containing the first DCI and the second DCIs formats. The BS transmits the first DCI scheduling the respective PUSCHs on the first plurality of cells in the first PUCCH group based on the first RRC signaling and transmits the second DCI scheduling the respective PDSCHs on the second plurality of cells in the second PUCCH group based on the first RRC signaling (5210). The BS receives the respective PUSCHs on the first plurality of cells in the first PUCCH group based on the first DCI and transmits the respective PDSCHs the second plurality of cells in the second PUCCH group based on the second DCI (5220). The first and the second DCI may refer to any one of the DCI formats disclosed in the description in conjunction with FIG. 12-19 or 22-26. The first DCI and the second DCI may be transmitted by the BS in different time/frequency slots. Similarly, the BS receives the respective PUSCH for the first plurality of cells and transmits the respective PDSCH for the second plurality of cells in different times time/frequency slots. The first PUCCH group and the second PUCCH group may have at least one cell which is not common. In an alternative embodiment, the first PUCCH group and the second PUCCH group may have identical cells.

The first RRC signaling may further include information of a scheduling cell on which the first DCI scheduling the respective PUSCHs on the first plurality of cells is transmitted by the BS. The scheduling cell on which the first DCI scheduling the respective PUSCHs on the first plurality of cells is transmitted by the BS is part of the first PUCCH group but may or may not be a part of the first plurality of cells. The first RRC signaling may further include information of the first plurality of cells on which the respective PUSCHs are to be transmitted by the UE and the information of the first plurality of cells may include the respective cell indices. The first RRC signaling may further includes CSCI information and its association information with one or more combinations of the subsets of the first plurality of cells and/or at least one association may indicate all the cells in the first plurality of cells, and the CSCI information may be indicated in the first DCI scheduling the respective PUSCHs on the first plurality of cells or the subset of the first plurality of cells. The first RRC signaling may further include information of number of cells in the first plurality of cells and the information of the number of cells in the first plurality of cells may be selected from 2, 3, 4, or 8. The first RRC signaling may further includes information of a cell group ID of the first plurality of cells or a PUCCH group ID of the first PUCCH group. The first RRC signaling may further includes information of a reference cell within the first PUCCH group for the purpose of determining transmission timing of the respective PUSCHs by the UE on the first plurality of cells or for determining timing of receiving feedback (may be on PDCCH) of the transmitted PUSCHs by the UE on at least one cell of the first plurality of cells. The first RRC signaling may further includes information of one or more first DCI fields in the first DCI to be transmitted by the BS configured for indicating separate information for a set of scheduled cells and the set of scheduled cells corresponds to the first plurality of cells or a subset of cells from the first plurality of cells. The information of the one or more first DCI field includes two or more of first DCI field names or first DCI field identifiers, number of bits to be used for the first DCI fields, or joint indication bits and corresponding values for each scheduled cell of the set of scheduled cells wherein the joint indication bits are included in the first DCI when the one or more first DCI fields are used for scheduling the respective PUSCHs by the UE on the first plurality of cells in the first PUCCH group. The one or more first DCI fields in the first DCI may refer to a Time domain resource assignment (TDRA) field or an SRS request field. The first RRC signaling may further includes information of one or more second DCI fields in the first DCI to be transmitted by the BS which are dynamically configured based on a network configuration as common fields for indicating common information for a set of scheduled cells or as separate fields for indicating separate information for each scheduled cell of a set of scheduled cells and the set of scheduled cells corresponds to the first plurality of cells or a subset of cells from the first plurality of cells. The information of the one or more second DCI field in the first DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The one or more second DCI fields in the first DCI may refer to an Antenna port(s) field, an SRS resource indicator field or a Precoding information and number of layers field.

The first RRC signaling may further include information of a scheduling cell on which the second DCI scheduling the respective PDSCHs on the second plurality of cells is transmitted by the BS. The scheduling cell on which the second DCI scheduling the respective PDSCHs on the second plurality of cells is transmitted by the BS is part of the second PUCCH group but may or may not be a part of the second plurality of cells. The first RRC signaling may further include information of the second plurality of cells on which the respective PDSCHs are to be transmitted by the BS and the information of the second plurality of cells may include the respective cell indices. The first RRC signaling may further includes CSCI information and its association information with one or more combinations of the subsets of the second plurality of cells and/or at least one association may indicate all the cells in the second plurality of cells and the CSCI information may be indicated in the second DCI scheduling the respective PDSCHs by the UE on the second plurality of cells or the subset of the second plurality of cells. The first RRC signaling may further include information of number of cells in the second plurality of cells and the information of the number of cells in the second plurality of cells may be selected from 2, 3, 4, or 8. The first RRC signaling may further include information of a cell group ID of the second plurality of cells or a PUCCH group ID of the second PUCCH group. The first RRC signaling may further include information of a reference cell within the second PUCCH group for the purpose of determining reception timing of the respective PDSCHs by the UE on the second plurality of cells or for determining timing of transmitting feedback (may be on PUCCH or PUSCH) of the received PDSCHs by the UE on at least one cell of the second plurality of cells. The first RRC signaling may further includes information of one or more first DCI fields in the second DCI to be transmitted by the BS configured for indicating separate information for a set of scheduled cells and the set of scheduled cells corresponds to the second plurality of cells or a subset of cells from the second plurality of cells. The information of the one or more first DCI fields includes two or more of DCI field names or DCI field identifiers, number of bits to be used for the first DCI fields, or joint indication bits and corresponding values for each scheduled cell of the set of scheduled cells wherein the joint indication bits are included in the second DCI to be transmitted by the BS when the first DCI field is used for scheduling the respective PDSCHs by the UE on the second plurality of cells in the second PUCCH group. The one or more first DCI fields in the second DCI may refer to a Time domain resource assignment (TDRA) field or an SRS request field. The first RRC signaling may further includes information of one or more second DCI fields in the second DCI to be transmitted by the BS which are dynamically configured based on a network configuration as common fields for indicating common information for a set of scheduled cells or as separate fields for indicating separate information for each scheduled cell of a set of scheduled cells and the set of scheduled cells corresponds to the second plurality of cells or a subset of cells from the second plurality of cells. The information of the one or more second DCI fields in the second DCI includes second DCI field names or second DCI field identifiers and an indicator of configuration as the common fields for indicating common information for the set of scheduled cells or an indicator of configuration as separate fields for indicating separate information for each scheduled cell of the set of scheduled cells. The second DCI field in the second DCI may refer to an Antenna port(s) field.

### UE Configurations for a Single DCI Scheduling a PUSCH Per Cell on Each of a Plurality of Cells or Scheduling a PDSCH Per Cell on Each of a Plurality of Cells.

Since NR Release-15 Dynamic spectrum sharing (DSS) between NR cell and LTE cell is supported. NR UEs are expected to outnumber LTE UEs with time. The existing DSS feature needs enhancement to address the growing number of NR UEs. A possible enhancement to reduce the load on the shared carrier is to offload the downlink control channel (PDCCH) of the shared carrier to another carrier. This can be achieved by cross-carrier scheduling a PCell from an SCell, if the Pcell is deployed in the shared carrier. Although, cross-carrier scheduling a PCell from an Scell reduces the load on the Pcell, it may add more PDCCH monitoring load on the Scell. To reduce PDCCH monitoring load on the Scell, it may be advantageous to support a single DCI on the SCell for scheduling a PUSCH or PDSCH per cell on each of a plurality of cells. By using a single DCI scheduling a PUSCH or PDSCH per cell on each of a plurality of cells, the number of monitored PDCCHs is reduced, so too is the PDCCH blocking probability.

Although problems of PCell PDCCH monitoring, while deployed in a DSS spectrum, can be solved by using a single DCI scheduling a PUSCH or PDSCH per cell on each of a plurality of cells, this solution is not limited to DSS spectrum only. Similar benefits can be achieved for cells deployed in FR1, FR2-1, FR2-2, and combinations thereof. Further, it may be beneficial to use a single DCI scheduling PUSCH or PDSCH per cell on each of a plurality of cells across RATs, for instance, LTE Cells scheduling NR Cells or vice versa.

Some of the advantages of using single DCI scheduling PUSCH or PDSCH per cell on each of a plurality of cells may include the following:
PDCCH overhead may be reduced. For example, CRC bits and common DCI bits (Type 1 DCI fields) among the scheduling and scheduled cell(s) may be saved.
PDCCH resources on the scheduled cell may be re-used for PDSCH/PUSCH transmission.
At the UE side, less PDCCH processing may be required as compared with the situation where a plurality of PDCCHs are required for scheduling a plurality of PUSCH or PDSCH.

In an embodiment, a UE may receive a signalling from a base station to configure a small bandwidth scheduling cell and ultra-wide bandwidth scheduled cells in the UE, such that UE power can be saved as a result of PDCCH monitoring occasions being reduced because of the smaller bandwidth of the scheduling cell. Additionally, the UE may receive a signalling from the base station for configuring the UE to not monitor a PDCCH for single-cell PUSCH or PDSCH scheduling when configured to monitor a PDCCH for scheduling PUSCH or PDSCH per cell on each of a plurality of cells such that UE power can be saved.

In an embodiment, a base station may be configured to transmit a signalling for configuring a UE with a small bandwidth scheduling cell and ultra-wide bandwidth scheduled cells, such that UE power can be saved as a result of PDCCH monitoring occasions being reduced because of the smaller bandwidth of the scheduling cell. Additionally, the base station may be configured to transmit a signalling to configure the UE to not monitor a PDCCH for single-cell PUSCH or PDSCH scheduling when configured for monitoring a PDCCH for scheduling PUSCH or PDSCH per cell on each of a plurality of cells such that UE power can be saved.

In another embodiment, a single DCI for scheduling a PUSCH or PDSCH per cell on each of a plurality of cells with at least one of the following UE configurations:
A DCI on a Pcell self-schedules a PUSCH or PDSCH on the PCell as well as cross-carrier schedules a PUSCH or PDSCH on other Scell(s).
A DCI on a Pcell cross-carrier schedules a PUSCH or PDSCH on Scells.
A DCI on an Scell cross-carrier schedules a PUSCH or PDSCH on a PCell as well as cross-carrier schedules PUSCH/PDSCH on other Scell(s).
A DCI on an Scell cross-carrier schedules a PUSCH or PDSCH on other SCells.
A DCI on an Scell self-schedules a PUSCH or PDSCH as well as cross-carrier schedules a PUSCH or PDSCH on a PCell and/or other PUSCH or PDSCH on Scell(s).

In another embodiment, scheduling and scheduled cells may be intra-band cells. In another embodiment, scheduling and scheduled cells may be inter-band cells. In another embodiment, scheduling and scheduled cells may include a combination of inter-band and intra-band cells.

In another embodiment, scheduling and scheduled cells may belong to the same RAT (Radio Access Technology) including, for example, LTE or NR. In another embodiment, the scheduling and scheduled cells may belong to different RATs, for example an LTE scheduling cell and NR scheduled cells, or an NR scheduling cell and LTE scheduled cells, or an LTE or NR scheduling cell and a combination of LTE and NR scheduled cells.

In another embodiment, DCI for scheduling a PUSCH or PDSCH per cell on each of a plurality of cells may be received on two or more scheduling cells to reduce PDCCH monitoring load on a single scheduling cell.

In another embodiment, a BS may configure itself to allow a group of co-scheduled cells to be scheduled only on a single scheduling cell. The BS may then send RRC signalling to a UE for purposes of configuring the UE to allow a group of co-scheduled cells to be scheduled only on a single scheduling cell. The UE may configure itself to allow a group of co-scheduled cells to be scheduled only on a single scheduling cell.

In another embodiment, a UE may be configured based on a RRC signalling received from a base station to receive a plurality of DCIs, each DCI scheduling a different group of scheduled cells, whereby each of the plurality of DCIs may be received on their respective scheduling cells, whereby the scheduling cells receiving the DCIs are different from each other.

In another embodiment, a UE may be configured based on RRC signalling received from a base station to receive a DCI scheduling either PUSCH on plurality of cells or PDSCH on plurality of cell for simplicity. No scheduling of simultaneous PUSCHs and PDSCHs is allowed among the co-scheduled cells.

In another embodiment, DCI on an unlicensed cell may schedule a PUSCH or PDSCH per cell on each of a plurality of unlicensed co-scheduled cells, or an unlicensed cell may schedule plural unlicensed and licensed co-scheduled cells, or a licensed cell may schedule plural unlicensed and/or licensed co-scheduled cells. An advantage of using DCI on an unlicensed cell for scheduling plurality of cells may be that in 5G NR multiple unlicensed bands are now available with wider bandwidths including bands 46, 96, and 60 GHz unlicensed band in the FR2-2 spectrum. In another embodiment, a UE may not be configured for unlicensed cell scheduling a set of co-scheduled licensed and/or unlicensed cells as LBT failure may affect the scheduling of plurality of cells leading to a decrease in throughput.

In another embodiment, a DCI for scheduling a PUSCH or PDSCH per cell on each of a plurality of cells is monitored by the UE in a user specific search space.

In another embodiment, a scheduling cell may schedule a plurality of cells other than the scheduling cell, where the same carrier type (FDD or TDD, licensed or unlicensed, FR1 or FR2-1 or FR2-2) is used among all the co-scheduled cells which may be the same or different to the subcarrier spacing (SCS) of the scheduling cell. The SCS of the co-scheduled cells may also be configured to be the same or different.

In another embodiment, a scheduling cell may schedule a plurality of cells other than the scheduling cell, where a different carrier type (FDD or TDD, licensed or unlicensed, FR1 or FR2-1 or FR2-2) is used among all the co-scheduled cells which may be the same or different to the SCS of the scheduling cell. The SCS of the co-scheduled cells may be configured as the same or different.

In another embodiment, a scheduling cell may schedule a plurality of cells including the scheduling cell, where the same or different carrier type (FDD or TDD, licensed or unlicensed, FR1 or FR2-1 or FR2-2) is used among all the co-scheduled cells. The SCS of the co-scheduled cells may be configured as the same or different.

### Signalling Co-Scheduled Cells

According to an embodiment a signalling mechanism is disclosed for indicating to a UE which cells are scheduled from a single DCI. A BS may configure itself with carrier aggregation (CA) and cross-carrier scheduling. The BS may then send RRC signalling to a UE for purposes of configuring the UE with carrier aggregation (CA) and cross-carrier scheduling. The UE may configure itself based on the received RRC signalling with carrier aggregation (CA) and cross-carrier scheduling.

In the conventional CA mechanism, the Carrier indicator field (CIF) in the DCI corresponds to one scheduled cell. To schedule PUSCH/PDSCH on two or more cells via a single DCI, a new indicator field indicating co-scheduled cells (CSCI field) is disclosed below in accordance with an embodiment.

In an embodiment, a bitmap may be used for the co-scheduled cells indicator (CSCI) field, where each bit represents a cell. As will be appreciated by one of ordinary skill in the art, this technique will increase the number of CSCI bits needed as the number of cells to be scheduled from a single DCI increase. For a smaller number of co-scheduled cells, however, this technique may provide a simple option for scheduling a plurality of cells. Table 1 provides an example of bitmap coding for 3 bits CSCI where each bit corresponds to a cell. In the below example LSB corresponds to cell 2, middle bit corresponds to Cell 3 and MSB corresponds to Cell 4. In this example, DCI is received on Cell 1. A person of ordinary skill in the art will appreciate that more or less bits could be used to signal more or less scheduling arrangements and that the bits therein could correspond to different cells than those shown in Table 1.

TABLE 1

| 3 bits CSCI | Definition |
|---|---|
| 000 | Self-scheduling Cell 1 |
| 001 | Cross-Scheduling Cell 2 |
| 010 | Cross-Scheduling Cell 3 |
| 011 | Cross-Scheduling Cell 2 and Cell 3 |
| 100 | Cross-Scheduling Cell 4 |
| 101 | Cross-Scheduling Cell 2 and Cell 4 |
| 110 | Cross-Scheduling Cell 3 and Cell 4 |
| 111 | Cross-Scheduling Cell 2, Cell 3, and Cell 4 |

In another embodiment, a way of scheduling multiple cells using a single DCI can includes the steps of:
receiving a downlink control information (DCI) on a cell for scheduling at least a plurality of other cells;
wherein the DCI includes a bitmap including a plurality of bit positions;
wherein each bit position of the plurality of bit positions corresponds to a respective cell among the plurality of other cells;
wherein the presence of a 1 bit in a bit position of the plurality of bit positions indicates that the respective cell among the plurality of other cells indicated by the bit position is scheduled.

A more specific embodiment of this broader concept is described in conjunction with table 1. A person of skill in the art will appreciate, however, that the number of bits represented is merely for exemplary purposes and that other numbers of bits could be used.

In another embodiment, Table 1 may be modified to include the additional self-scheduling situations for scheduling at least 2 cells as shown in table 2. A person of ordinary skill in the art will appreciate that more or less bits could be used to signal more or less scheduling arrangements and that the bits therein could correspond to different cells than those shown in Table 2.

TABLE 2

| 3 bits CSCI | Definition |
|---|---|
| 000 | Self-scheduling Cell 1 |
| 001 | Self-scheduling Cell 1 and Cross-Scheduling Cell 2 |
| 010 | Self-scheduling Cell 1 and Cross-Scheduling Cell 3 |
| 011 | Self-scheduling Cell 1 and Cross-Scheduling Cell 2 and Cell 3 |
| 100 | Self-scheduling Cell 1 and Cross-Scheduling Cell 4 |
| 101 | Self-scheduling Cell 1 and Cross-Scheduling Cell 2 and Cell 4 |
| 110 | Self-scheduling Cell 1 and Cross-Scheduling Cell 3 and Cell 4 |
| 111 | Self-scheduling Cell 1 and Cross-Scheduling Cell 2, Cell 3, and Cell 4 |

The advantage of using the above 3 bits CSCI is that it covers self-scheduling for a single cell and self-scheduling and cross-carrier scheduling for scheduling up to 3 cells.

In another embodiment, a way of scheduling multiple cells using a single DCI can includes the steps of:
receiving a downlink control information (DCI) on a cell for scheduling the cell and a plurality of other cells;
wherein the DCI includes a bitmap having a plurality of bit positions;
wherein a respective bit position of the plurality of bit positions corresponds to a respective cell among the plurality of other cells;
wherein the presence of a 1 bit in the respective bit position of the plurality of bit positions indicates that the respective cell among the plurality of other cells corresponding to the bit position, and the cell upon which the DCI is received, are scheduled.

A more specific embodiment of this broader concept is described in conjunction with table 2. A person of skill in the art will appreciate, however, that the number of bits represented is merely for exemplary purposes and that other numbers of bits could be used.

In another embodiment, table 2 can be further modified to include self-scheduling of cell 1 for all the combinations. This may facilitate scheduling up to 4 cells using a 3 bits CSCI.

Further, similar to tables 1 and 2, more tables can be created for additional CSCI bits such as 4, 5, and 6 bits to enable the scheduling of more cells.

In another bitmap embodiment, each bit indicates a self-scheduling or cross-carrier scheduling for a given cell. For scheduling 4 cells, 4 bits are assigned, where each bit indicates self-scheduling or cross-carrier scheduling. Similarly, for scheduling 3 cells a 3-bit bitmap may be used.

In another embodiment, instead of using a bitmap, an encoding may be used as shown in table 3. A person of ordinary skill in the art will appreciate that more or less bits could be used to encode more or less scheduling arrangements and that the bits therein could correspond to different cells than those shown in Table 3.

TABLE 3

| 3 bits CSCI | Definition |
|---|---|
| 000 | Self-scheduling Cell 1 |
| 001 | Cross-Scheduling Cell 2 |
| 010 | Cross-Scheduling Cell 3 |
| 100 | Cross-Scheduling Cell 4 |
| 011 | Cross-Scheduling Cell 2 and Cell 3 |
| 101 | Cross-Scheduling Cell 2 and Cell 4 |
| 110 | Cross-Scheduling Cell 3 and Cell 4 |
| 111 | Cross-Scheduling Cell 2, Cell 3, and Cell 4 |

In another embodiment, a way of scheduling multiple cells using a single DCI can includes the steps of:
receiving a downlink control information (DCI) on a cell for scheduling a plurality of other cells;
wherein the DCI includes a plurality of bits for identifying the plurality of other cells;
wherein a first non-zero sequence of bits indicates a first cell among the plurality of other cells is scheduled; and,
wherein a second non-zero sequence of bits indicates a first cell among the plurality of other cells and a second cell among the plurality of other cells are scheduled.

A more specific embodiment of this broader concept is described in conjunction with table 3. A person of skill in the art will appreciate, however, that the number of bits represented is merely for exemplary purposes and that other numbers of bits could be used.

In another embodiment, table 3 can be modified to include additional self-scheduling situations for scheduling at least 2 cells as shown in table 4.

TABLE 4

| 3 bits CSCI | Definition |
|---|---|
| 000 | Self-scheduling Cell 1 |
| 001 | Self-scheduling Cell 1 and Cross-Scheduling Cell 2 |
| 010 | Self-scheduling Cell 1 and Cross-Scheduling Cell 3 |
| 011 | Self-scheduling Cell 1 and Cross-Scheduling Cell 4 |
| 100 | Self-scheduling Cell 1 and Cross-Scheduling Cell 2, and Cell 3 |
| 101 | Self-scheduling Cell 1 and Cross-Scheduling Cell 2, and Cell 4 |
| 110 | Self-scheduling Cell 1 and Cross-Scheduling Cell 3, and Cell 4 |
| 111 | Self-scheduling Cell 1 and Cross-Scheduling Cell 2, Cell 3, and Cell 4 |

In another embodiment, a way of scheduling multiple cells using a single DCI can includes the steps of:
receiving a downlink control information (DCI) on a cell for scheduling the cell and a plurality of other cells;
wherein the DCI includes a plurality of bits for identifying the plurality of other cells;
wherein a first non-zero sequence of bits indicates a first cell among the plurality of other cells, and the cell upon which the DCI is received, are self-scheduled; and,
wherein a second non-zero sequence of bits indicates a first cell among the plurality of other cells, a second cell among the plurality of other cells, and the cell upon which the DCI is received are scheduled.

A more specific embodiment of this broader concept is described in conjunction with table 4. A person of skill in the art will appreciate, however, that the number of bits represented is merely for exemplary purposes and that other numbers of bits could be used.

In another embodiment, table 3 may be modified to include a cross-carrier scheduling entry at the place of self-scheduling entry, when a UE is configured for scheduling a plurality of cells using cross-carrier scheduling only.

Table 4 may be modified to include self-scheduling cell 1 to all the combinations. This may help schedule up to 4 cells using a 3 bits CSCI.

Further, like table 3 and 4, more tables may be created for additional CSCI bits such as 4, 5, and 6 bits to enable scheduling of more cells.

In another embodiment, the CSCI field may include a 1-bit flag and a 3-bit CSCI field, where the 1-bit flag indicates whether the DCI schedules a plurality of cells or a single cell. If the 1-bit flag indicates scheduling for the plurality of cells, the 3-bit CSCI field is interpreted as the indicator of co-scheduled cells, and if the 1-bit flag indicates single-cell scheduling, the 3-bit CSCI field is interpreted as a CIF field for single-cell scheduling.

In another embodiment, an RRC signalling mechanism may be used to indicate to a UE which cells are scheduled from a single DCI. A method of creating a group of cells for simultaneous scheduling is disclosed where a group of cells is created during the (re) configuring step of cells in the UE. A predefined group of cells may be created before configuring UE for a PUSCH or PDSCH scheduling (one PDSCH or PUSCH per cell) on a plurality of cells with a single DCI. The following could be considered for purposes of creating the cell groups:
Intra-band cell grouping: the scheduling and scheduled cells belong to the same band.
Inter-band cell grouping: the scheduling cell belongs to one band and the scheduled cells belong to a different band.
Mixed cell grouping: the scheduling cell and some scheduled cells belong to the same band and other scheduled cells belong to a different band.

An advantage of using Intra-band cell grouping is that intra-band cells have more commonalities in the DCI fields and these commonalities can help in reducing overhead. An advantage of using Inter-band cell grouping is that the scheduling cell is deployed in a band where interference may be less or PDCCH blind detection probability may be higher as compared to the other scheduled cells leading to a better PUSCH or PDSCH throughput. The advantages of both intra-band cell grouping, and Inter-band cell grouping can be combined in the mixed cell grouping.

In another embodiment, a BS (for example, a BS as disclosed in conjunction with the description of FIG. 5) may configure itself with cell groups for scheduling PUSCH or PDSCH per cell on each of a plurality of cells with a single DCI. Separate cell groups may also be configured for PUSCH or PDSCH scheduling. The BS may then send RRC signalling (for example, signaling disclosed in 610 of FIG. 6 or 710 of FIG. 7) to a UE (for example, a UE as disclosed in conjunction with the description of FIG. 4) for purposes of configuring the UE for scheduling PUSCH or PDSCH per cell on each of a plurality of cells with a single DCI. The UE may configure itself based on the RRC signalling with cell groups for scheduling PUSCH or PDSCH per cell on each of a plurality of cells with a single DCI. The RRC signalling may include one or more of the following:
Cell Group ID.
Indices of the cells in the configured group
Index of the scheduling Cell

The RRC signalling may include one or more of the above parameters in a CrossCarrierSchedulingConfig or ServingCellConfig message. Also, regarding ServingCellConfig of each serving cell, an IE indicating scheduling for a plurality of cells using a single DCI may be included which configures whether the cells are scheduled by a DCI scheduling a plurality of cells.

The Cell Group ID may indicate a cell group containing a plurality of cells or a cell group containing a sub-set of the plurality of cells. The Cell Group ID is helpful in identifying a cell group when multiple cell groups are configured in the UE by the base station. When multiple cell groups are configured the RRC signaling may include multiple Cell Group IDs. The RRC signaling may also include a number of cell groups configured for scheduling PUSCH or PDSCH per cell on each of a plurality of cells with a single DCI.

Indices of the cells in the configured cell group in the RRC signaling may be arranged in an increasing order of cell indices. For example, RRC signaling containing cell indices as disclosed in conjunction with the description of table 5.

In another embodiment, the co-scheduled cells are identified from the RRC signalling configuring UE for scheduling PUSCH or PDSCH per cell on each of a plurality of cells with a single DCI.

In another embodiment, BS may associate a scheduling cell with scheduled cells in a group, and RRC signalling is provided to a UE to indicate the indices of cells in the cell group. Once a cell group is configured for scheduling PUSCH or PDSCH per cell on each of a plurality of cells with a single DCI, the subsequently received DCI on the scheduling cell for scheduling any cell in the cell group may schedules all the cells in the group. For example, receiving a DCI on a scheduling cell for self-scheduling PUSCH or PDSCH or cross-carrier scheduling PUSCH or PDSCH on any cell in the group also implicitly indicates scheduling of PUSCH or PDSCH on the other cells in the group.

In another embodiment, an RNTI may be defined for indicating a PDCCH containing a DCI for scheduling PUSCH or PDSCH per cell on each of a plurality of cells to a UE. The RNTI for indicating a PDCCH scheduling a plurality of cells is different from the RNTI(s) used for self-scheduling or cross-carrier scheduling on a single cell.

In another embodiment, for a simplified design in terms of PDCCH monitoring capabilities and RRC configuration, one cell is allowed to be part of one cell group only. The PUCCH cell group may also be configured as a cell group for scheduling PUSCH or PDSCH per cell on each of a plurality of cells with a single DCI.

In another embodiment, a CSCI field in a DCI format points to a group of scheduled cells. The group of scheduled cells acts as a virtual cell. The association of a group of scheduled cells may be pre-configured in a UE by the RRC signalling transmitted by the base station. There can be multiple groups of scheduled cells configured in a UE. The association of a group of scheduled cells may be semi-statically configured and may be reconfigured by the RRC signalling.

In another embodiment, scheduled cells follow a predefined combination configured to UE by RRC signalling. For example, a cell corresponding to Cell index=001 and cells corresponding to cell indices 010, 011, etc. may be bundled together. In this case, a CSC/field indicates one cell yet may schedule plural cells. The cell bundling configuration may be semi-static and may be updated as per requirement.

In another embodiment, scheduled cells may be configured to be scheduled by a DCI scheduling a plurality of cells in only one scheduling cell.

In another embodiment, to limit DCI size, a maximum number of scheduled cells configured for scheduling PUSCH or PDSCH per cell on each of a plurality of cells in a UE by RRC configuration is selected from a set of {2,3,4}. Depending on the selected configuration of maximum number of cells, various combinations of co-scheduled cells may be formed (for example, as shown in table 5) for co-scheduling PUSCH or PDSCH on a plurality of cells.

In another embodiment, a way of scheduling multiple cells using a single DCI can includes the steps of:
receiving an RRC message including information correlating a first value to a first plurality of cells and correlating a second value to a second plurality of cells; and
receiving a downlink control information (DCI), after receiving the RRC message, the DCI includes the first value or the second value for scheduling the plurality of cells indicated by the first value or the second value.

A more specific embodiment of this broader concept is described in conjunction with table 5. A person of skill in the art will appreciate, however, that the number of bits represented is merely for exemplary purposes and that other numbers of bits could be used.

In another embodiment, BS (for example, a BS as disclosed in conjunction with the description of FIG. 5) may configure a set of co-scheduled cell indicator (CSCI) values and associate each CSCI value with one or more cells as presented in an exemplary table 5. Then, the BS provides RRC signalling (for example, signaling disclosed in 710 of FIG. 7) for configuring a UE (for example, a UE as disclosed in conjunction with the description of FIG. 4) with the set of CSCI values and the associated cell or cells. As shown in table 5, cell values in each row may be arranged as per the ascending order of cell indices. Further, as shown in table 5, RRC signaling includes configuration for each row of the table including a CSCI value and corresponding combinations of co-scheduled cells. The RRC signaling may also include a number of rows, for example, in table 5, 8 rows are indicated. The UE may configure itself based on the received RRC signalling (for example, signaling disclosed in 610 of FIG. 6) with the set of co-scheduled cell indicator (CSCI) values and store the received set of CSCI values and the associated cell combinations, where each CSCI value in the set corresponds to a combination of the cells. Table 5 below shows one such example for CSCI values for 3 bits (0-7). A person of ordinary skill in the art will appreciate that more or less bits could be used to signal more or less scheduling arrangements and that the bits therein could correspond to different cells than those shown in Table 5.

TABLE 5

| CSCI | Scheduled cells |
|---|---|
| 0 | Cell 1, Cell 2 |
| 1 | Cell 1, Cell 3, Cell 4 |
| 2 | Cell 2, Cell 3 |
| . . . | . . . |
| 7 | Cell 1, Cell 2, Cell 3, Cell 4 |

The DCI scheduling UE for PUSCH or PDSCH per cell on each of a plurality of cells (620, 720) may contain a CSCI value in the DCI for indicating a combination of cells from the set of combinations of cells configured by RRC. The UE may extract the CSCI value and identify the cells for which the received DCI is applicable by comparing it with the stored CSCI values and cell combinations received from the BS and accordingly transmit/receive PUSCH or PDSCH on each of the identified cells (630, 730). The DCI format for scheduling a UE for PUSCH or PDSCH per cell on each of a plurality of cells may refer to any one of a DCI format disclosed in the embodiments described in conjunction with the FIGS. 12-19.

### Enhancements to DCI Format for Scheduling PUSCH or PDSCH Per Cell on Each of a Plurality of Cells

For scheduling PUSCH or PDSCH per cell on each of a plurality of cells with a single DCI, a different DCI format may be used for scheduling. The DCI format design may consider scheduling trade-off between DCI scheduling efficiency and scheduling flexibility:
For intra-band CA, the focus may be more on DCI scheduling efficiency because intra-band carriers can have the same channel properties.
For inter-band CA, the focus may be more on scheduling flexibility because inter-band carriers may require different physical-layer configurations for better data transmission efficiency due to different channel properties.

If the scheduled cells are in different bands and have different bandwidths/numerologies, more DCI fields may need to be independent, while if they are in the same band, more DCI fields may be joint/common.

In an embodiment, the size of a DCI for scheduling PUSCH or PDSCH per cell on each of a plurality of cells is selected as the minimum DCI size according to different configurations of the scheduled cells. Many DCI fields may be present only once, for example, HARQ-ACK-related fields for PDSCH scheduling such as DAI, K1, and PUCCH resources may be signalled only once.

In another embodiment, a predefined relationship can be established between the DCI fields of scheduled cells. For example, one of the scheduled cells can be considered as the primary scheduled cell and the DCI fields of the other scheduled cell(s) may be interpreted from the DCI fields of the primary scheduled cell.

In another embodiment, the primary scheduled cell is the one with the largest DCI format size.

In another embodiment, the interpretation of the DCI fields for other scheduled cell(s) may be done according to the BWP switching rules, for example, the UE may
for each information field in the DCI format
if the size of the information field is smaller than the one required for the DCI format interpretation for the UL BWP or DL BWP that is indicated by the bandwidth part indicator, the UE prepends zeros to the information field until its size is the one required for the interpretation of the information field for the UL BWP or DL BWP prior to interpreting the DCI format information fields, respectively
if the size of the information field is larger than the one required for the DCI format interpretation for the UL BWP or DL BWP that is indicated by the bandwidth part indicator, the UE uses a number of least significant bits of the DCI format equal to the one required for the UL BWP or DL BWP indicated by bandwidth part indicator prior to interpreting the DCI format information fields, respectively
set the active UL BWP or DL BWP to the UL BWP or DL BWP indicated by the bandwidth part indicator in the DCI format

If a bandwidth part indicator field is configured in a DCI format for PUSCH and indicates an active UL BWP with different SCS configuration μ, or with different number

$${N}_{RB - set , UL}^{BWP}$$

of RB sets, than a current active UL BWP, the UE may determine an uplink frequency domain resource allocation Type 2 based on X′ bits and Y′ bits that are generated by independently truncating or padding the X MSBs and the Y LSBs [6, TS 38.214, release 17] of the frequency domain resource assignment field of DCI format 0_1, where truncation starts from the MSBs of the X bits or the Y bits, zero-padding prepends zeros to the X bits or the Y bits, and
if the indicated active UL BWP has SCS configuration μ=1 and the current active BWP has SCS configuration μ=0, the X MSBs may be truncated to X′=X−1 bits, or
if the indicated active UL BWP has SCS configuration μ=0 and the current active BWP has SCS configuration μ=1, the X MSBs may be zero-padded to X′=X+1 bits
otherwise, the X MSBs may remain unchanged
and
the Y LSBs may be truncated or zero-padded to

$$\begin{matrix}{Y}^{′} = ⌈ {log}_{2} ( \frac{{N}_{RB - set , UL}^{BWP} ( {N}_{RB - set , UL}^{BWP} + 1 )}{2} ) ⌉ bits where \\ {N}_{RB - set , UL}^{BWP}\end{matrix}$$

is a number of RB sets configured for the indicated active UL BWP

A UE may not expect to detect a DCI format with a BWP indicator field that indicates an active DL BWP or an active UL BWP change with the corresponding time domain resource assignment field providing a slot offset value for a PDSCH reception or PUSCH transmission that is smaller than a delay required by the UE for an active DL BWP change or UL BWP change, respectively.

### Single Transport Block (TB) Per Cell

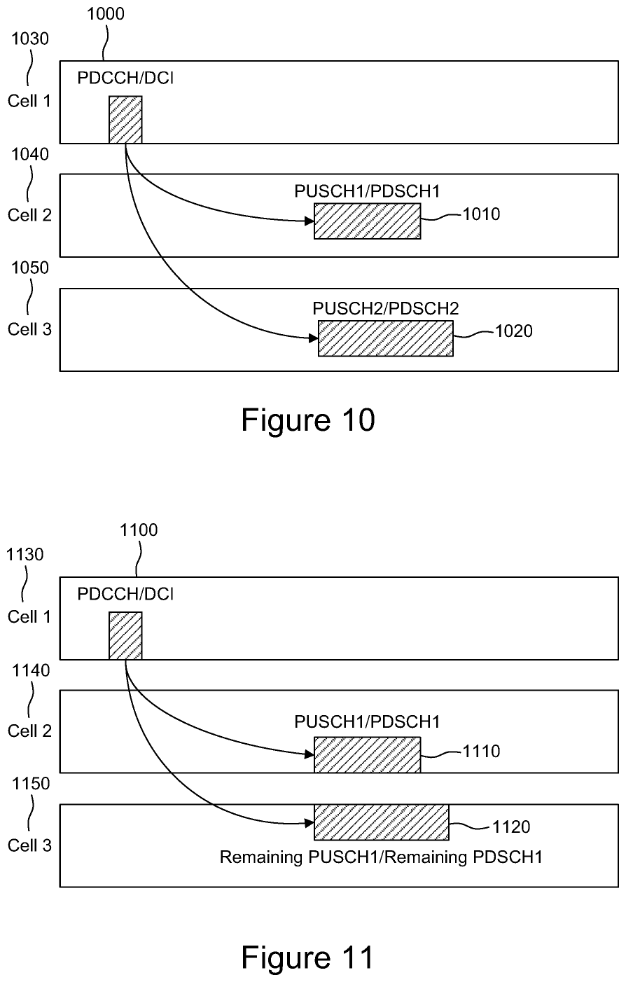

In an embodiment, FIG. 10 presents scheduling PUSCH or PDSCH per cell using a scheduling cell (1030) on each of a plurality of cells (1040, 1050) with a single DCI (1000) in accordance with an embodiment, where plural PUSCH or PDSCH may carry different transport blocks (TBs) (1010 and 1020).

The DCI payload may be reduced by exploiting the redundancy and semi-static configuration of the various transmission/reception parameters:

The fields of the DCI may be divided into three types:
Type 1 field: common for each of the co-scheduled cells for the scheduled PUSCH/PDSCH
Type 2 field: independent for each of the co-scheduled cells for the scheduled PUSCH/PDSCH
Type 3 field: flexible either common or independent among the co-scheduled cells for the scheduled PUSCH/PDSCH depending on network configuration.

The DCI payload size may be reduced significantly by exploiting the redundancies provided by Type 1 DCI fields. The Type 3 DCI field(s) may be semi-statically (re) configured as Type 1 or Type 2 DCI fields. The base station may semi-statically (re) configure the Type 3 field(s) and share the information of such field(s) to UE via RRC signalling. The network operator may also pre-configure the Type 3 DCI fields as Type 1 or Type 2 DCI fields as per the network requirement. An example of Type 3 fields includes the following: in case of collocated deployments, co-scheduled cells may share beam related DCI fields such as transmission configuration indication (TCI), SRS resource indicator (SRI), antenna port indication, etc., and these DCI fields may be configured as Type 1, while for non-collocated deployments beam related DCI fields may be configured as Type 2.

Exemplary Type 1 and Type 2 DCI fields of a DCI format for scheduling PDSCH on a plurality of cells:
Type 1 DCI fields: CSCI field, Identifier for DCI formats, Downlink assignment index, TPC for scheduled PUCCH, PUCCH resource indicator, PDSCH-to-HARQ timing indicator.
Type 2 DCI fields: New data indicator, Redundancy version, Modulation and coding scheme, Frequency domain resource assignment, Time domain resource assignment, Bandwidth part indicator, HARQ process number.
Type 3 DCI fields: Antenna port(s), transmission configuration indication (TCI), SRS request, DMRS sequence initialization.

One or more of the following additional DCI fields may be configured in a DCI format scheduling PDSCH on a plurality of cells either as Type 1 or Type 2 DCI field: PRB bundling size indicator, Rate matching indicator, ZP CSI-RS trigger, VRB-to-PRB mapping, One-shot HARQ-ACK request, ChannelAccess-Cpext, etc.

Exemplary Type 1 and Type 2 DCI fields of a DCI format for scheduling PUSCH on a plurality of cells:
Type 1 DCI fields: CSCI field, Identifier for DCI formats, Downlink assignment index.
Type 2 DCI fields: New data indicator, Redundancy version, Modulation and coding scheme, Frequency domain resource assignment, Time domain resource assignment, Bandwidth part indicator, HARQ process number.
Type 3 DCI fields: Antenna port(s), SRS request, SRS resource indicator (SRI), DMRS sequence initialization.

One or more of the following additional DCI fields may be configured in a DCI format scheduling PDSCH on a plurality of cells either as Type 1 or Type 2 DCI field: TPC command for scheduled PUSCHs, ChannelAccess-Cpext, CSI request, beta offset indicator, etc.

In an embodiment, one or more of DCI field(s) in tables 6 and 7 may be semi-statically (re) configured as Type 1 fields by RRC signalling. For example, Frequency domain resource assignment (FDRA) and/or Time-domain resource assignment (TDRA) may be semi-statically (re) configured as Type 1 DCI fields for the co-scheduled cells. Hence, a single field in the DCI can indicate the FDRA or TDRA for all the co-scheduled cells.

For simplicity, it may be beneficial to have a common start time for the scheduled PUSCH or PDSCH across cells, as a DCI field can indicate the time domain resources for the co-scheduled cells. The configuration of a common start time for scheduled PUSCH or PDSCH may be indicated to the UE by RRC signalling or physical layer signalling. Alternatively, a predefined time offset may be configured for PUSCH/PDSCH transmission/reception start time across the cells, with this configuration also the UE may transmit/receive PUSCH or PDSCH across cells using a DCI field. The predefined time offset value may be provided to UE by either RRC signalling or physical layer signalling.

The DCI fields in table 6 are a list of fields in the DCI formats that may be used for scheduling PDSCH.

TABLE 6
DCI field types for PDSCH
DCI field

Identifier for DCI formats
CSCI
Bandwidth part indicator
PRB bundling size indicator
Rate matching indicator
ZP CSI-RS trigger
Frequency domain resource assignment
Time domain resource assignment
Modulation and coding scheme TB1
New data indicator TB1
Redundancy version TB1
Modulation and coding scheme TB2
New data indicator TB2
Redundancy version TB2
HARQ process number
VRB-to-PRB mapping
Downlink assignment index
TPC command for scheduled PUCCH
PUCCH resource indicator
PDSCH-to-HARQ feedback timing indicator
Antenna port(s)
SRS request
DMRS sequence initialization
Transmission configuration indication
CBG transmission information (CBGTI)
CBG flushing out information (CBGFI)
One-shot HARQ-ACK request
PDSCH group index
New feedback indicator
Number of requested PDSCH group(s)
ChannelAccess-CPext
Priority indicator
Minimum applicable scheduling offset indicator
SCell dormancy indication
CRC

The DCI fields in table 7 are a list of DCI fields that may be used for scheduling PUSCH.

TABLE 7
DCI field types for PUSCH
DCI field

Identifier for DCI formats
CSCI
DFI flag
Bandwidth part indicator
Frequency domain resource assignment
Time domain resource assignment
Frequency hopping flag
Modulation and coding scheme TB1
New data indicator TB1
Redundancy version TB1
Modulation and coding scheme TB2
New data indicator TB2
Redundancy version TB2
HARQ process number
TPC command for scheduled PUSCH
Second TPC command for scheduled PUSCH
ChannelAccess-CPext
ChannelAccess-CPext-CAPC
Open-loop power control parameter set indication
Priority indicator
Invalid symbol pattern indicator
Minimum applicable scheduling offset indicator
SCell dormancy indication
Sidelink assignment index*
PDCCH monitoring adaptation indication
UL/SUL indicator**
HARQ-ACK bitmap
1st downlink assignment index
2nd downlink assignment index
SRS resource set indicator
Second SRS resource indicator
SRS resource indicator
Precoding information and number of layers
Second Precoding information
Antenna ports
SRS request
SRS offset indicator
CSI request
CBG transmission information (CBGTI)
PTRS-DMRS association
Second PTRS-DMRS association
beta_offset indicator
DMRS sequence initialization
UL-SCH indicator
CRC
*“Sidelink assignment index” field may not be applicable for a DCI format for scheduling a plurality of cells.
**In a cell group at most one SUL is configured, therefore, a DCI format for scheduling a plurality of cells may not need

a “UL/SUL indicator” field in the DCI. If required, the “UL/SUL indicator” may be dynamically determined by the RRC configuration.

In an embodiment, Release-16 NR-U/URLLC/Power saving related DCI fields may not be included in a DCI format for scheduling a plurality of cells. Examples of such DCI fields for PDSCH scheduling are One-shot HARQ-ACK request, PDSCH group index, New feedback indicator, Number of requested PDSCH group(s), ChannelAccess-Cpext, Priority indicator, Minimum applicable scheduling offset indicator and SCell dormancy indication. Similarly, examples of such DCI fields for PUSCH scheduling are ChannelAccess-Cpext, ChannelAccess-CPext-CAPC, Priority indicator, Invalid symbol pattern indicator, Minimum applicable scheduling offset indicator, SCell dormancy indication, Open-loop power control parameter set indication, and DFI Flag.

In another embodiment, a Cell Bit Size Field indicating bits allocated to each cell in the DCI may be included in a DCI format for scheduling PUSCH or PDSCH per cell on each of a plurality of cells. For example, a single DCI in 5G supports 140 bits (excluding CRC), the 140 bits may include the Type 1 fields and Type 2 fields. Since the bits for Type 1 fields may be fixed and common for all the scheduled cells, hence, only Type 2 fields would vary among the scheduled cells. The Cell Bit Size Field may indicate which cells are scheduled with a predefined number of bits in Type 2 fields. The predefined number of bits in Type 2 fields may be configured as a cumulative number of bits in Type 2 fields that are present for each scheduled cell. In an alternative embodiment, the Cell Bit Size Field may indicate a predefined combination of bits per cell as shown in table 8. The information of predefined combinations may be provided to UE by RRC signalling during the configuration of scheduling PUSCH or PDSCH per cell on each of a plurality of cells. Table 8 is provided with an example of 2 bits, but it may not be restricted to 2 bits only, it may be extended as per the need and number of co-scheduled cells.

TABLE 8

| Cell Bit Size Field | Cell 1 | Cell 2 | Cell 3 |
|---|---|---|---|
| 00 | X1 bits | X2 Bits | X2 Bits |
| 01 | X1 bits | X2 Bits | X1 Bits |
| 10 | X2 bits | X1 Bits | X2 Bits |
| 11 | X1 bits | X1 Bits | X1 Bits |

In another embodiment, a way of scheduling multiple cells using a single DCI can includes the steps of:
receiving a downlink control information (DCI) for scheduling a plurality of cells,
wherein the DCI includes at least one common field applicable to the plurality of cells;
wherein the DCI includes at least one independent field applicable to a first cell of the plurality of cells;
and wherein the DCI includes at least one independent field applicable to a second cell of the plurality of cells.

A more specific embodiment of this broader concept is described in conjunction with FIG. 12. A person of skill in the art will appreciate, however, that the number of cells and fields represented is merely for exemplary purposes and that other numbers of cells/fields could be used.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1200) for scheduling PUSCH/PDSCH on the plural cells is disclosed in FIG. 12. As shown therein Type 1 DCI fields may be grouped together (1210), and Type 2 DCI fields may be grouped cell-wise starting from cell 1 (1220), cell 2 (1230), and so on. The Type 2 DCI fields (1220 and 1230) may be grouped according to cell indices (starting from a smallest or a largest cell index) or according to the Type 2 DCI fields payload sizes of the cells. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

An advantage of using the DCI format, as disclosed in FIG. 12, is that the processing of cell 1 is completed before cell 2, and UE may start preparing for earlier transmission/reception for cell 1 as compared to cell 2 reducing the wait time for cell 1.

In another embodiment, a way of scheduling multiple cells using a single DCI can includes the steps of:
receiving a downlink control information (DCI) for scheduling a plurality of cells;
wherein the DCI includes at least one common field applicable to the plurality of cells;
wherein the DCI includes a first independent field applicable to a first cell of the plurality of cells and a second independent field applicable to the first cell of the plurality of cells;
wherein the DCI includes a first independent field applicable to a second cell of the plurality of cells and a second independent field applicable to the second cell of the plurality of cells;
wherein the first independent field applicable to a first cell of the plurality of cells and the first independent field applicable to a second cell of the plurality of cells precede, in the DCI, the second independent field applicable to a first cell of the plurality of cells and the second independent field applicable to a second cell of the plurality of cells.

A more specific embodiment of this broader concept is described in conjunction with FIG. 13. A person of skill in the art will appreciate, however, that the number of cells and fields represented is merely for exemplary purposes and that other numbers of cells/fields could be used.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1300) for scheduling PUSCH/PDSCH on the plural cells is disclosed in FIG. 13. As shown therein Type 1 DCI fields (1310) may be grouped together, and Type 2 DCI fields may be cell interleaved (1320), where field 1 may be grouped for all the co-scheduled cells followed by field 2 for all the co-scheduled cells, and so on. The interleaved Type 2 DCI fields may have a predefined order, for example, field 1 of cell index 1 is followed by field 1 of cell index 2, and so on. The predefined order may be based on cell indices, or the order may be pre-configured by RRC signalling while configuring the co-scheduled cell group. The cell index-based ordering may be done such that the combinations of cells with the smallest (or biggest) cell index may come first as compared to the others cell indices. For example, for the co-scheduled cell indices of 1, 3, and 4, Type 2 field 1 of cell index 1 is followed by Type 2 field 1 of cell index 3 which is followed by Type 2 field 1 of cell index 4. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

In another embodiment, a way of scheduling multiple cells using a single DCI can includes the steps of:
receiving a downlink control information (DCI) for scheduling a plurality of cells;
wherein the DCI includes at least one common field applicable to a first cell of the plurality of cells and a second cell of the plurality of cells;
wherein the DCI includes at least one common field applicable to a third cell of the plurality of cells and a fourth cell of the plurality of cells.

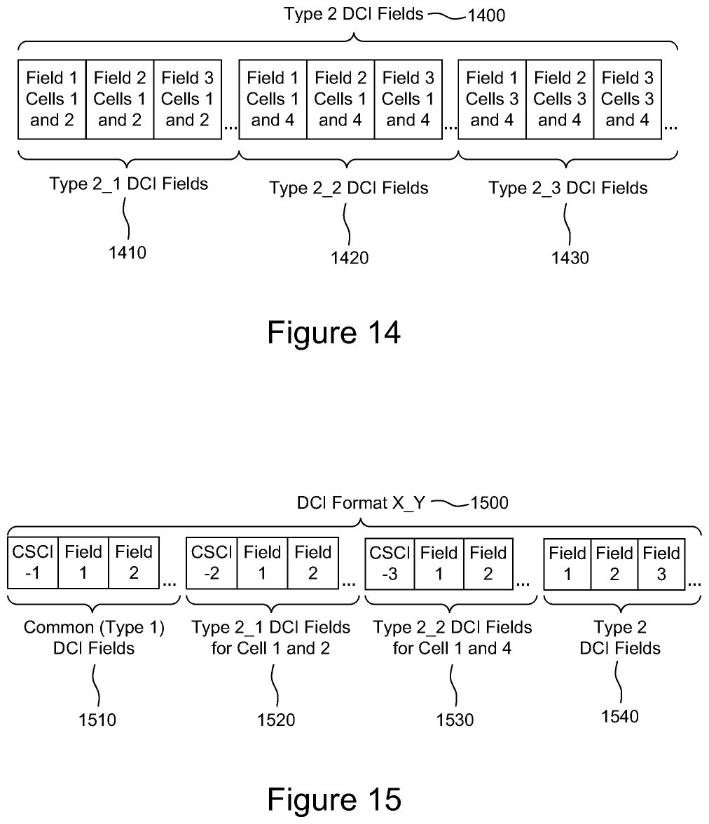

A more specific embodiment of this broader concept is described in conjunction with FIG. 14. A person of skill in the art will appreciate, however, that the number of cells and fields represented is merely for exemplary purposes and that other numbers of cells/fields could be used.

In another embodiment, Type 2 DCI fields (1400) may further have commonalities among the sub-set of the cells as shown in FIG. 14. For example, in a group of 4 co-scheduled cells in addition to Type 1 fields (for example, 1210 or 1310 as show in in FIGS. 12 and 13) some of the Type 2 DCI fields may have commonalities among the subset of 2 or 3 cells. The common Type 2 field combination for Cells 1 and 2 may be called Type 2_1 (1410), similarly cells 1 and 4 may be called Type 2_2 (1420), cells 3 and 4 may be called Type 2_3 (1430), and so on. These additional commonalities among the sub-set of the cells may be due to collocation of cells, due to intra-band CA, due to similar interference characteristics, etc. Therefore, it may be beneficial to exploit additional redundancy in the Type 2 DCI fields. A person of skill in the art will appreciate that the Type 2 DCI fields for PUSCH or PDSCH scheduling may include DCI fields categorized as Type 2 in other embodiments of the present disclosure.

In another embodiment, a way of scheduling multiple cells using a single DCI can includes the steps of:
receiving a downlink control information (DCI) comprising
   a first co-scheduled cell indicator (CSCI) indicating a first plurality of cells; wherein the first CSCI associated with a first common field;
   a second CSCI indicating a second plurality of cells from amongst the first plurality of cells;
      wherein the second CSCI associated with a second common field.

A more specific embodiment of this broader concept is described in conjunction with FIG. 8. A person of skill in the art will appreciate, however, that the number of cells and fields represented is merely for exemplary purposes and that other numbers of cells/fields could be used.

As shown in FIG. 15, DCI format X_Y (1500) may have plural co-scheduled cell indicator fields (CSCIs) to indicate the various combinations of co-scheduled cells for the DCI fields in accordance with an embodiment. For example, CSCI-1 may be used to indicate the group of co-scheduled cells and it is part of the Type-1 DCI fields (1510), while CSCI-2 may be used to indicate a subset of co-scheduled cells among the group of co-scheduled cells for Type 2_1 DCI fields (1520), similarly, CSCI-3 may be used to indicate a subset of co-scheduled cells among the group of co-scheduled cells for Type 2_2 DCI fields (1530) and so on. The Type 2 DCI fields (1540) which have no commonality among the co-scheduled cells may also be indicated in a similar manner as shown in FIGS. 12 and 13. A predefined order may be used for ordering Type 2_1 (1520), Type 2_2 (1530), Type 2_3 (1540), etc. DCI fields. The order may be based on cell index, or the order may be pre-configured by RRC signalling while configuring the co-scheduled cell group. The cell index-based ordering may be done such that the combinations of cells with the smallest (or biggest) cell index may come first as compared to the others. Taking an example of DCI format X_Y (1400) as shown in FIG. 14 in accordance with an embodiment, Type 2_1 DCI fields (1410) indicating commonality for Cell index 1 and 2 may come first as compared to Type 2_2 DCI fields (1420) indicating commonality for Cell index 1 and 4, similarly, Type 2_3 DCI fields (1430) indicating commonality for Cell index 3 and 4 may come after the Type 2_2 DCI fields (1420) indicating commonality for Cell index 1 and 4. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5.

In another embodiment, a BS (for example, a BS described in conjunction with the description of FIG. 5) may provide a signalling (for example, signaling described in 710) to configure a UE (for example, a UE described in conjunction with the description of FIG. 4), the UE may configure itself, based on the received signalling (for example, a signaling described in 610), with a primary cell group of co-scheduled cells, and the UE may be further configured with one or more secondary cell groups, each containing a sub-set of cells in the primary cell group. The primary cell group may have one or more DCI fields common to all the co-scheduled cells and the secondary cell group may have one or more DCI fields (other than the common DCI fields of the primary cell group) common to the sub-set of cells in the secondary cell group. The UE configuration of primary and secondary cell groups may be performed semi-statically via RRC configuration information. The RRC configuration information may include at least one of cell Indices of scheduled cells, a cell index of the scheduling cell, a primary cell group ID, or a secondary cell group ID.

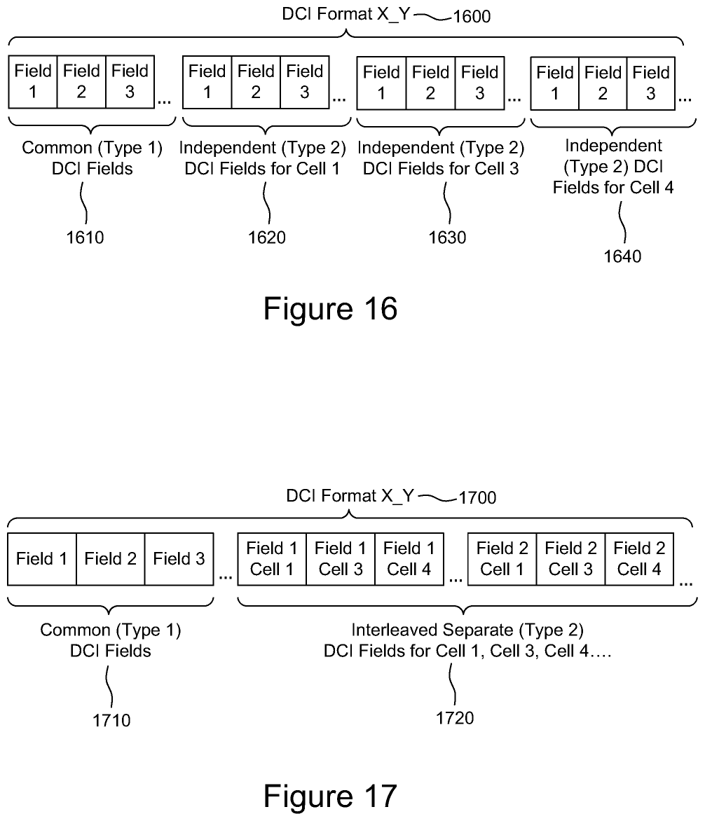

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1600) for scheduling PUSCH/PDSCH on the plural cells is disclosed in FIG. 16. As shown therein Type 1 DCI fields may be grouped together (1610), and Type 2 DCI fields may be grouped according to the cell indices. For example, Type 2 DCI fields of cell index 1 (1620) are followed by Type 2 DCI fields cell index 3 (1630), followed by Type 2 DCI fields cell index 4 (1640) and so on. The grouping of Type 2 DCI fields (1620, 1630 and 1640) may start from a smallest or a largest cell index. The cell indices of the co-scheduled cells may be contiguous or non-contiguous. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1700) for scheduling PUSCH/PDSCH on the plural cells is disclosed in FIG. 17. As shown therein Type 1 DCI fields (1710) may be grouped together, and Type 2 DCI fields may be cell interleaved (1720), where field 1 may be grouped for all the co-scheduled cells followed by field 2 for all the co-scheduled cells, and so on. The interleaved Type 2 DCI fields may have a predefined order, for example, field 1 of cell index 1 is followed by field 1 of cell index 3, which is followed by field 1 of cell index 4, and so on, in an ascending order of cell indices. The cell index-based ordering may be done such that the combinations of cells with the smallest cell index may come first as compared to the others cell indices. The cell indices of the co-scheduled cells may be contiguous or non-contiguous. For example, as shown in FIG. 17, for the co-scheduled cell indices of 1, 3, and 4, Type 2 field 1 of cell index 1 is followed by Type 2 field 1 of cell index 3 which is followed by Type 2 field 1 of cell index 4. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

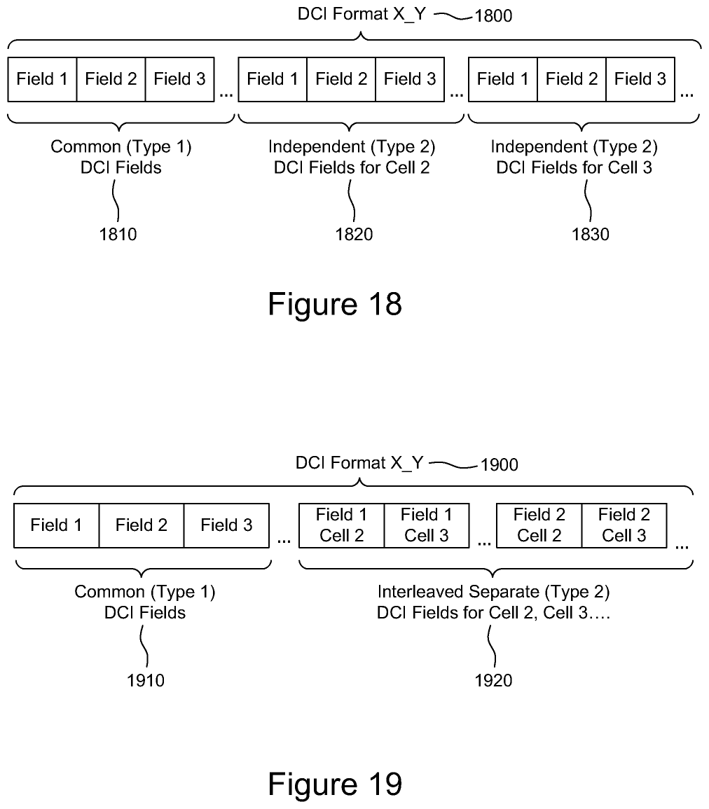

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1800) for scheduling PUSCH/PDSCH on the plural cells is disclosed in FIG. 18. As shown therein Type 1 DCI fields may be grouped together (1810), and Type 2 DCI fields may be grouped according to the cell indices. For example, Type 2 DCI fields of cell index 2 (1820) are followed by Type 2 DCI fields of cell index 3 (1830), and so on. The grouping of Type 2 DCI fields (1820 and 1830) may start from the smallest cell index. The starting cell index is the smallest cell index among the co-scheduled cells. The cell indices of the co-scheduled cells may be contiguous or non-contiguous. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1900) for scheduling PUSCH/PDSCH on the plural cells is disclosed in FIG. 19. As shown therein Type 1 DCI fields (1910) may be grouped together, and Type 2 DCI fields may be cell interleaved (1920), where field 1 may be grouped for all the co-scheduled cells followed by field 2 for all the co-scheduled cells, and so on. The interleaved Type 2 DCI fields may have a predefined order, for example, field 1 of cell index 2 is followed by field 1 of cell index 3, and so on, in an ascending order of cell indices. The cell index-based ordering may be done such that the combinations of cells with the smallest cell index may come first as compared to the others cell indices. The starting cell index is the smallest cell index among the co-scheduled cells. The cell indices of the co-scheduled cells may be contiguous or non-contiguous. For example, as shown in FIG. 19, for the co-scheduled cell indices of 2 and 3, Type 2 field 1 of cell index 2 is followed by Type 2 field 1 of cell index 3. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

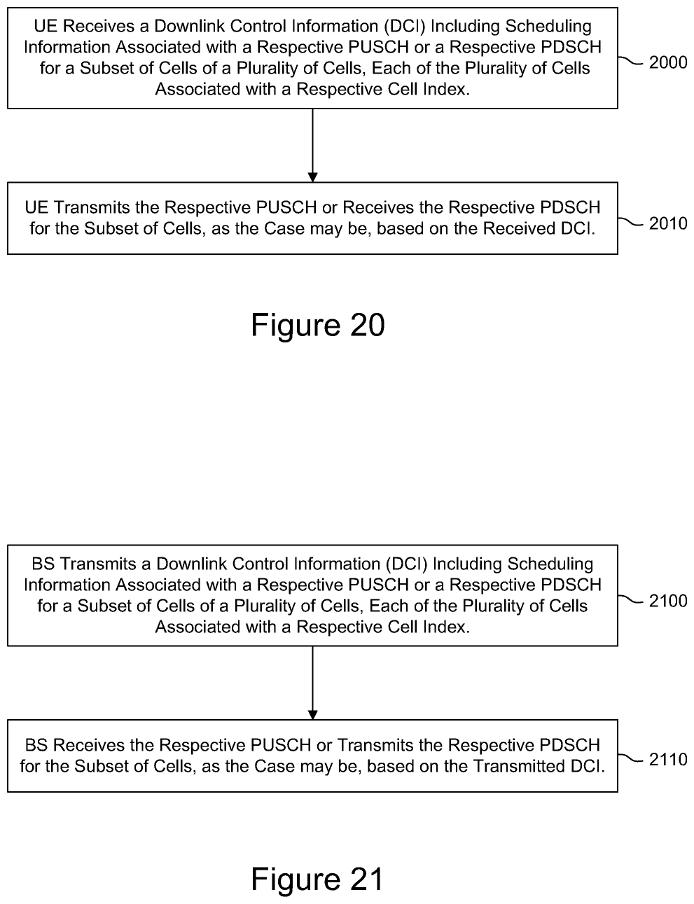

An example method performed by a user equipment according to an embodiment is shown in FIG. 20. According to this embodiment the method includes a step 2000 wherein a UE receives a downlink control information (DCI) including scheduling information associated with a respective PUSCH or a respective PDSCH for a subset of cells of a plurality of cells, each of the plurality of cells associated with a respective cell index. According to this embodiment the DCI includes a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. Further, according to this embodiment the DCI includes a first independent field including first information of a first category of information and a second independent field including second information of the first category of information, wherein the second independent field follows the first independent field in the DCI, wherein the first information is applicable to the cell having the smallest cell index of the subset of cells and wherein the second information is applicable to the scheduled cell having the second smallest cell index of the subset of cells. The method continues in a step 2010 wherein the UE transmits the respective PUSCH or receives the respective PDSCH on the subset of cells, as the case may be, based on the received DCI.

In an embodiment, the received DCI further comprises a third independent field including third information of a second category of information, and a fourth independent field including fourth information of the second category of information. The third independent field follows the second independent field in the DCI. The fourth independent field follows the third independent field in the DCI. The third information is applicable to the cell having the smallest cell index of the subset of cells and the fourth information is applicable to the cell having the second smallest cell index of the subset of cells.

In an embodiment, the received DCI further comprises a third independent field including third information of a second category of information and a fourth independent field including fourth information of the second category of information. The third independent field follows the first independent field in the DCI. The second independent field follows the third independent field in the DCI. The fourth independent field follows the second independent field in DCI. The third information is applicable to a cell having the smallest cell index of the subset of cells and the fourth information is applicable to the cell having the second smallest cell index of the subset of cells.

In an embodiment, the first common field in the received DCI further includes information indicative of a third cell index associated with a third cell of the subset of cells wherein the second cell index and the third cell index are consecutive, and the DCI further comprises a third independent field including third information of the first category of information. The third independent field follows the second independent field in the DCI and the third information is applicable to the scheduled cell having the third smallest cell index of the subset of cells.

In an embodiment, the received DCI further comprises a second common field including information applicable to the subset of cells of the plurality of cells. The information applicable to the subset of the plurality of cells includes one of DCI format information, downlink assignment index information, TPC for scheduled PUCCH information, PUCCH resource indicator information, or PDSCH-to-HARQ timing indicator information. When the information applicable to the subset of the plurality of cells includes DCI format information indicating uplink scheduling, the DCI further comprises a third common field carrying a TPC for scheduled PUCCH information and a fourth common field carrying a PUCCH resource indicator information.

In an embodiment, the first category of information in the received DCI includes one of new data indicator information, redundancy version information, modulation and coding scheme information, frequency domain resource assignment information, time domain resource assignment information, or HARQ process number information.

In an embodiment, the DCI is received on a cell other than one of the subset of cells.

In an embodiment, the DCI is received on the cell having the smallest cell index of the subset of cells.

In an embodiment, the method of wireless communication, performed by a UE, further comprising receiving a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is received on a cell of the plurality of cells and the RRC signaling further includes the cell index of the cell of the plurality of cells upon which the DCI is received. The group of cells indicated by the Cell Group ID is a PUCCH cell group. The RRC signaling is included in a ServingCellConfig message.

An example method performed by a user equipment according to an embodiment is shown in FIG. 21. According to this embodiment the method includes a step 2010 wherein a BS transmits a downlink control information (DCI) including scheduling information associated with a respective PUSCH or a respective PDSCH for a subset of cells of a plurality of cells, each of the plurality of cells associated with a respective cell index. According to this embodiment the DCI includes a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. Further, according to this embodiment the DCI includes a first independent field including first information of a first category of information and a second independent field including second information of the first category of information, wherein the second independent field follows the first independent field in the DCI, wherein the first information is applicable to the cell having the smallest cell index of the subset of cells and wherein the second information is applicable to the scheduled cell having the second smallest cell index of the subset of cells. The method continues in a step 2110 wherein the BS receives the respective PUSCH or transmits the respective PDSCH on the subset of cells, as the case may be, based on the transmitted DCI.

In an embodiment, the transmitted DCI further comprises a third independent field including third information of a second category of information, and a fourth independent field including fourth information of the second category of information. The third independent field follows the second independent field in the DCI. The fourth independent field follows the third independent field in the DCI. The third information is applicable to the cell having the smallest cell index of the subset of cells and the fourth information is applicable to the cell having the second smallest cell index of the subset of cells.

In an embodiment, the transmitted DCI further comprises a third independent field including third information of a second category of information and a fourth independent field including fourth information of the second category of information. The third independent field follows the first independent field in the DCI. The second independent field follows the third independent field in the DCI. The fourth independent field follows the second independent field in DCI. The third information is applicable to a cell having the smallest cell index of the subset of cells and the fourth information is applicable to the cell having the second smallest cell index of the subset of cells.

In an embodiment, the first common field in the transmitted DCI further includes information indicative of a third cell index associated with a third cell of the subset of cells wherein the second cell index and the third cell index are consecutive, and the DCI further comprises a third independent field including third information of the first category of information. The third independent field follows the second independent field in the DCI and the third information is applicable to the scheduled cell having the third smallest cell index of the subset of cells.

In an embodiment, the transmitted DCI further comprises a second common field including information applicable to the subset of cells of the plurality of cells. The information applicable to the subset of the plurality of cells includes one of DCI format information, downlink assignment index information, TPC for scheduled PUCCH information, PUCCH resource indicator information, or PDSCH-to-HARQ timing indicator information. When the information applicable to the subset of the plurality of cells includes DCI format information indicating uplink scheduling, the DCI further comprises a third common field carrying a TPC for scheduled PUCCH information and a fourth common field carrying a PUCCH resource indicator information.

In an embodiment, the first category of information in the received DCI includes one of new data indicator information, redundancy version information, modulation and coding scheme information, frequency domain resource assignment information, time domain resource assignment information, or HARQ process number information.

In an embodiment, the DCI is transmitted on a cell other than one of the subset of cells.

In an embodiment, the DCI is transmitted on the cell having the smallest cell index of the subset of cells.

In an embodiment, the method of wireless communication, performed by a BS, further comprising transmitting a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is received on a cell of the plurality of cells and the RRC signaling further includes the cell index of the cell of the plurality of cells upon which the DCI is transmitted. The group of cells indicated by the Cell Group ID is a PUCCH cell group. The RRC signaling is included in ServingCellConfig message.

In another embodiment, a BS as shown in conjunction with the description of FIG. 5 may provide a signalling to configure a UE, the UE may configure itself, based on the received signalling, with a primary cell group of co-scheduled cells, and the UE may be further configured with one or more secondary cell groups, each containing a sub-set of cells in the primary cell group. The primary cell group may have one or more DCI fields common to all the co-scheduled cells and the secondary cell group may have one or more DCI fields (other than the common DCI fields of the primary cell group) common to the sub-set of cells in the secondary cell group. The UE configuration of primary and secondary cell groups may be performed semi-statically via RRC configuration information. The RRC configuration information may include at least one of cell Indices of scheduled cells, a cell index of the scheduling cell, a primary cell group ID, or a secondary cell group ID.

In another embodiment, a BS as shown in conjunction with the description of FIG. 5 transmits RRC signaling as shown in conjunction with the description of FIG. 29 or 30 for configuring a UE as shown in conjunction with the description of FIG. 4 for DCI scheduling PDSCHs/PUSCHs on each of a plurality of cells. Once the UE is configured, the BS transmits one of a DCI format scheduling a plurality of cells as shown in conjunction with the description of FIGS. 12-19 and 22-26 to the UE, the UE may receive the DCI and accordingly schedule PDSCHs/PUSCHs on each of a plurality of cells.

In another embodiment Type 1 DCI field may be divided into three types:
Type-1A field: A single DCI field indicating the same information for all the co-scheduled cells.
Type-1B field: A single DCI field indicating separate information for each of co-scheduled cells via joint indication.
Type-1C field: A single DCI field indicating information to only one of co-scheduled cells.

The DCI payload size may be reduced significantly by exploiting the redundancies provided by Type 1A/1B DCI fields. The Type 3 DCI field(s) may be semi-statically (re) configured as one of Type 1A, 1B, 1C or 2 DCI field. The base station may semi-statically (re) configure the Type 3 field(s) and share the information of such field(s) to UE via RRC signalling (for example RRC message(s) 2900, 3000). The network operator may also pre-configure the Type 3 DCI fields as Type 1A, 1B, 1C or 2 DCI fields as per the network requirement. An example of Type 3 DCI fields includes the following: in case of collocated deployments, co-scheduled cells may share beam related DCI fields such as SRS resource indicator (SRI), antenna port indication, etc., and these DCI fields may be configured as Type 1A, while for non-collocated deployments beam related DCI fields may be configured as Type 2.

Exemplary Type 1A/1B and Type 2 DCI fields of a DCI format for scheduling PDSCH (DCI format 1_X) on a plurality of cells are provided in Table 9 and exemplary Type 1A/1B/1C and Type 2 DCI fields of a DCI format for scheduling PUSCH (DCI format 0_X) on a plurality of cells are provided in Table 10.

TABLE 9
DCI format 1_X fields and DCI field types
for scheduling PDSCHs on a plurality of cells

| DCI Field | DCI Field Type |
|---|---|
| Identifier for DCI formats | Type 1A |
| CSCI | Type 1 |
| HARQ process number | Type 2 |
| Modulation and coding scheme (MCS) | Type 2 |
| New data indicator per TB | Type 2 |
| Redundancy version per TB | Type 2 |
| Downlink assignment index | Type 1A |
| BWP indicator | Type 1A |
| Frequency domain resource assignment (FDRA) | Type 2 |
| Time domain resource assignment (TDRA) | Type 1B |
| VRB-to-PRB mapping | Type 1A |
| PRB bundling size indicator | Type 1A |
| Rate matching indicator | Type 1B |
| ZP CSI-RS trigger | Type 1B |
| Antenna port(s) | Configurable between |
| | Type 1A and Type 2 |
| Transmission configuration indication (TCI) | Type 1B |
| DMRS sequence initialization | Type 1A |
| SRS request | Type 1B |
| SRS offset indicator | Type 1B |
| Priority Indicator | Type 1A |
| ChannelAccess-CPext | Type 1A |
| TPC for scheduled PUCCH | Type 1A |
| PUCCH resource indicator | Type 1A |
| PDSCH-to-HARQ timing indicator | Type 1A |
| One-shot HARQ-ACK request | Type 1A |
| CRC | Type 1A |

TABLE 10
DCI format 0_X fields and DCI Field types
for scheduling PUSCHs on a plurality of cells

| DCI Field | DCI Field Type |
|---|---|
| Identifier for DCI formats | Type 1A |
| CSCI | Type 1A |
| HARQ process number | Type 2 |
| Modulation and coding scheme (MCS) | Type 2 |
| New data indicator per TB | Type 2 |
| Redundancy version per TB | Type 2 |
| Downlink assignment index | Type 1A |
| BWP indicator | Type 1A |
| Frequency domain resource assignment (FDRA) | Type 2 |
| Time domain resource assignment (TDRA) | Type 1B |
| Frequency hopping flag | Type 1A |
| TPC command for scheduled PUSCH | Type 2 |
| Open-loop power control parameter set indication | Type 1A |
| Antenna port(s) | Configurable between |
| | Type 1A and Type 2 |
| Precoding information and number of layers | Configurable between |
| | Type 1A and Type 2 |
| PTRS-DMRS association | Type 2 |
| DMRS sequence initialization | Type 1A |
| SRS request | Type 1B |
| SRS resource indicator | Configurable between |
| | Type 1A and Type 2 |
| SRS offset indicator | Type 1B |
| UL/SUL indicator | Configurable between |
| | Type 1C and Type 2 |
| Priority Indicator | Type 1A |
| beta offset indicator | Type 1A |
| CSI request | Type 1A |
| UL-SCH indicator | Type 1A |
| ChannelAccess-CPext | Type 1A |
| CRC | Type 1A |

In another embodiment, one or more of configurable DCI field(s) in tables 9 and 10 may be semi-statically (re) configured as Type 1A/1C fields by RRC signalling (for example RRC message(s) 2900, 3000). For example, Antenna port(s), Precoding information and number of layers, SRS resource indicator, and UL/SUL indicator may be semi-statically (re) configured as Type 1A/1C DCI fields or Type 2 DCI field for the co-scheduled cells. The configurable DCI field(s) in tables 9 and 10 indicates functionalities of a Type 3 DCI field.

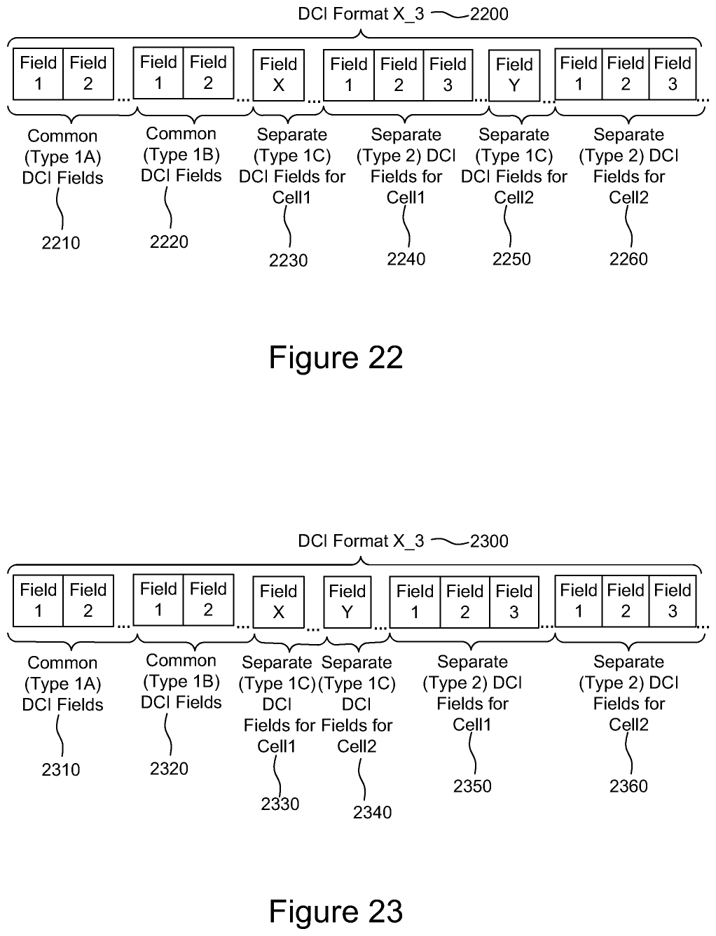

In another embodiment as presented in FIG. 22, a DCI format X_3 (2200) (It may be referred to as DCI Format X_3 where X=0 is for PUSCH scheduling, and X=1 is for PDSCH scheduling) for scheduling PUSCH/PDSCH on the plural cells is disclosed. As shown therein Type 1A (2210) and 1B (2220), DCI fields may be grouped together, and Type 1C (2230, 2250) (if present) and Type 2 DCI fields (2240, 2260) may be grouped cell-index-wise starting from cell index 1, cell index 2, and so on. The Type 1C (2230, 2250) and Type 2 DCI fields (2240, 2260) may be grouped according to cell indices (starting from a smallest or a largest cell index) or according to the Type 1C (2230, 2250) and 2 DCI fields (2240, 2260) payload sizes of the cells. Type 1C field (2230, 2250) may or may not be present for all the scheduled cells. A person of skill in the art would appreciate that the Type 1A (2210), 1B (2220), 1C (2230, 2250), or 2 (2240, 2260) DCI fields for PUSCH or PDSCH scheduling may include DCI fields categorized as Type 1A, 1B, 1C, or 2 in other embodiments of the present disclosure. Type 1A (2210)/1B (2220)/1C (2230, 2250) and Type 2 (2240, 2260) DCI fields as shown in FIG. 22 may refer to Type 1A/1B/1C and Type 2 DCI fields as shown in Table 9 or Table 10. Further, Type 1A DCI field (2210) may include a CSCI field which may be configured as per the concepts described in conjunction with the tables 1-5. Type 2 DCI fields (2240, 2260) corresponding to each scheduled cell may be ordered as described in conjunction with the description of FIG. 12, 16 or 18.

In another embodiment as presented in FIG. 23, a DCI format X_3 (2300) (It may be referred to as DCI Format X_Y where X=0 is for PUSCH scheduling, and X=1 is for PDSCH scheduling) for scheduling PUSCH/PDSCH on the plural cells is disclosed. As shown therein Type 1A (2310) and 1B (2320), DCI fields may be grouped together. Type 1C (2330, 2340) (if present) field may be grouped together cell-index-wise starting from cell index 1, cell index 2, and so on. Type 1C field (2330, 2340) may or may not be present for all the scheduled cells. Like Type 1C fields (2330, 2340), Type 2 DCI fields (2350, 2360) may be grouped cell-index-wise starting from cell 1, cell 2, and so on. The Type 1C (2330, 2340) and 2 DCI fields (2350, 2360) may be grouped according to cell indices (starting from a smallest or a largest cell index) or according to the Type 1C (2330, 2340) and 2 (2350, 2360) DCI fields payload sizes of the cells. A person of skill in the art would appreciate that the Type 1A (2310), 1B (2320), 1C (2330, 2340), or 2 DCI fields (2350, 2360) for PUSCH or PDSCH scheduling may include DCI fields categorized as Type 1A, 1B, 1C, or 2 in other embodiments of the present disclosure. Type 1A (2310)/1B (2320)/1C (2330, 2340) and Type 2 (2350, 2360) DCI fields as shown in FIG. 23 may refer to Type 1A/1B/1C and Type 2 DCI fields as shown in Table 9 or Table 10. Further, Type 1A DCI field (2310) may include a CSCI field which may be configured as per the concepts described in conjunction with the tables 1-5. Type 2 DCI fields (2350, 2360) corresponding to each scheduled cell may be ordered as described in conjunction with the description of FIG. 12, 16 or 18.

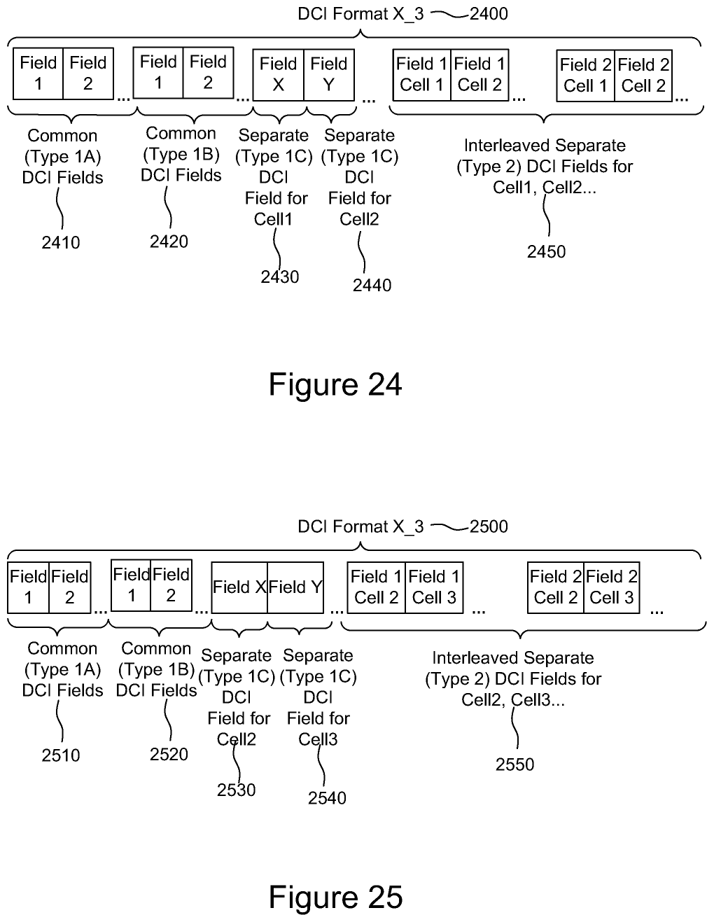

In another embodiment as presented in FIG. 24, a DCI format X_3 (2400) (It may be referred to as DCI Format X_Y where X=0 is for PUSCH scheduling, and X=1 is for PDSCH scheduling) for scheduling PUSCH/PDSCH on the plural cells is disclosed. As shown therein Type 1A (2410) and 1B (2420), DCI fields may be grouped together. The Type 1C (2430, 2440) (if present) field may be grouped together cell-index-wise starting from cell index 1, cell index 2, and so on. The Type 1C DCI fields (2430, 2440) may be grouped according to cell indices (starting from a smallest or a largest cell index) or according to the Type 1C DCI fields (2430, 2440) payload sizes of the cells. Type 1C field (2430, 2440) may or may not be present for all the scheduled cells. Type 2 DCI fields (2450) may be cell interleaved, where field 1 may be grouped for all the co-scheduled cells followed by field 2 for all the co-scheduled cells, and so on. The interleaved Type 2 DCI fields (2450) may have a predefined order, for example, field 1 of cell index 1 is followed by field 1 of cell index 2, and so on. The predefined order may be based on cell indices, or the order may be pre-configured by RRC signalling (for example RRC message(s) 2900, 3000) while configuring the co-scheduled cell group. A person of skill in the art would appreciate that the Type 1A (2410), 1B (2420), 1C (2430, 2440), or 2 (2450) DCI fields for PUSCH or PDSCH scheduling may include DCI fields categorized as Type 1A, 1B, 1C, or 2 in other embodiments of the present disclosure. Type 1A (2410)/1B (2420)/1C (2430, 2440) and Type 2 (2450) DCI fields as shown in FIG. 24 may refer to Type 1A/1B/1C and Type 2 DCI fields as shown in Table 9 or Table 10. Further, Type 1A DCI field (2410) may include a CSCI field which may be configured as per the concepts described in conjunction with the tables 1-5. Type 2 DCI fields (2450) corresponding to each scheduled cell may be ordered as described in conjunction with the description of FIG. 13.

In another embodiment as presented in FIG. 25, a DCI format X_3 (2500) (It may be referred to as DCI Format X_Y where X=0 is for PUSCH scheduling, and X=1 is for PDSCH scheduling) for scheduling PUSCH/PDSCH on the plural cells is disclosed. As shown therein Type 1A (2510) and 1B (2520), DCI fields may be grouped together. The Type 1C (2530, 2540) (if present) field may be grouped together cell-index-wise starting from cell index 2, cell index 3, and so on. The Type 1C DCI fields (2530, 2540) may be grouped according to cell indices (starting from a smallest or a largest cell index) or according to the Type 1C DCI fields (2530, 2540) payload sizes of the cells. Type 1C field (2530, 2540) may or may not be present for all the scheduled cells. Type 2 DCI fields (2550) may be cell interleaved, where field 1 may be grouped for all the co-scheduled cells followed by field 2 for all the co-scheduled cells, and so on. The interleaved Type 2 DCI fields (2550) may have a predefined order, for example, field 1 of cell index 2 is followed by field 1 of cell index 3, and so on. The predefined order may be based on cell indices, or the order may be pre-configured by RRC signalling (for example RRC message(s) 2900, 3000) while configuring the co-scheduled cell group. A person of skill in the art would appreciate that the Type 1A (2510), 1B (2520), 1C (2530, 2540), or 2 (2550) DCI fields for PUSCH or PDSCH scheduling may include DCI fields categorized as Type 1A, 1B, 1C, or 2 in other embodiments of the present disclosure. Type 1A (2510)/1B (2520)/1C (2530, 2540) and Type 2 (2550) DCI fields as shown in FIG. 25 may refer to Type 1A/1B/1C and Type 2 DCI fields as shown in Table 9 or Table 10. Further, Type 1A DCI field (2510) may include a CSCI field which may be configured as per the concepts described in conjunction with the tables 1-5. Type 2 DCI fields (2550) corresponding to each scheduled cell may be ordered as described in conjunction with the description of FIG. 19.

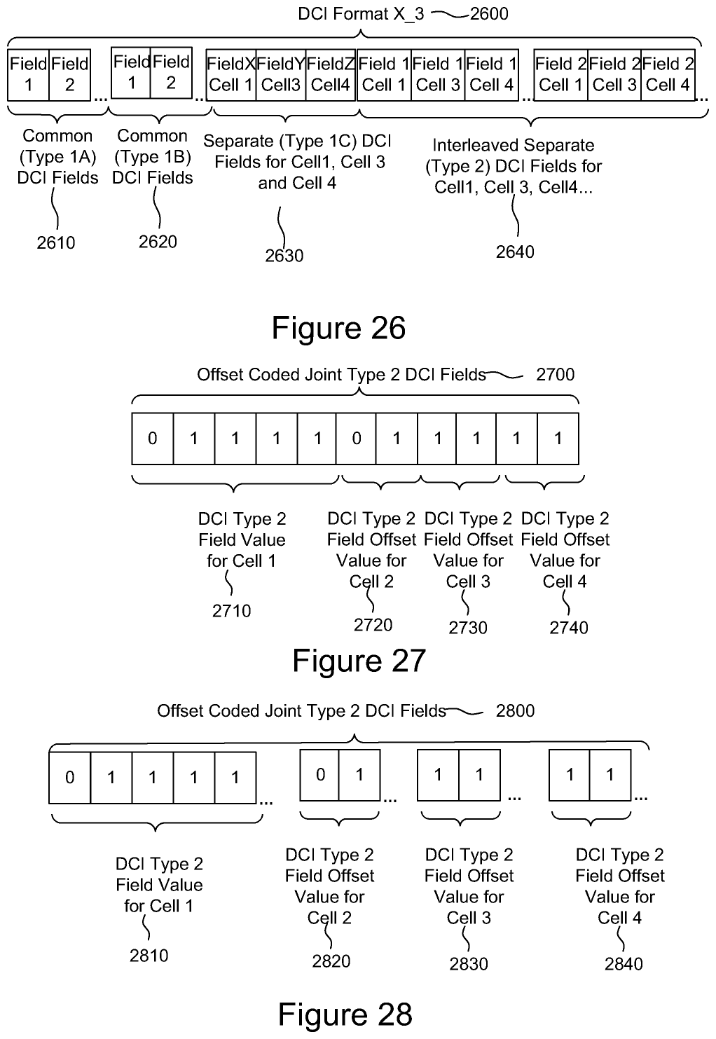

In another embodiment as presented in FIG. 26, a DCI format X_3 (2600) (It may be referred to as DCI Format X_Y where X=0 is for PUSCH scheduling, and X=1 is for PDSCH scheduling) for scheduling PUSCH/PDSCH on the plural cells is disclosed. As shown therein Type 1A (2610) and 1B (2620), DCI fields may be grouped together. The Type 1C (2630) (if present) field may be grouped together cell-index-wise starting from cell index 1, cell index 3, cell index 4 and so on. The Type 1C DCI fields (2630) may be grouped according to cell indices (starting from a smallest or a largest cell index) or according to the Type 1C DCI fields (2630) payload sizes of the cells. Type 1C field (2630) may or may not be present for all the scheduled cells. Type 2 DCI fields (2640) may be cell interleaved, where field 1 may be grouped for all the co-scheduled cells followed by field 2 for all the co-scheduled cells, and so on. The interleaved Type 2 DCI fields (2640) may have a predefined order, for example, field 1 of cell index 1 is followed by field 1 of cell index 3, followed by field 1 of cell index 4 and so on. The predefined order may be based on cell indices, or the order may be pre-configured by RRC signalling (for example RRC message(s) 2900, 3000) while configuring the co-scheduled cell group. A person of skill in the art would appreciate that the Type 1A (2610), 1B (2620), 1C (2630), or 2 (2640) DCI fields for PUSCH or PDSCH scheduling may include DCI fields categorized as Type 1A, 1B, 1C, or 2 in other embodiments of the present disclosure. Type 1A (2610)/1B (2620)/1C (2630) and Type 2 (2640) DCI fields as shown in FIG. 26 may refer to Type 1A/1B/1C and Type 2 DCI fields as shown in Table 9 or Table 10. Further, Type 1A DCI field (2610) may include a CSCI field which may be configured as per the concepts described in conjunction with the tables 1-5. Type 2 DCI fields (2640) corresponding to each scheduled cell may be ordered as described in conjunction with the description of FIG. 17.

### Offset Coding of DCI Fields

In another embodiment, a BS may transmit, and a UE may receive a PDCCH containing one of a DCI format as disclosed in the description in conjunction with FIG. 13, 17, 19, 24, 25 or 26 for PUSCH/PDSCH scheduling on a plurality of cells including one or more Type 2 fields. The number of bits used for Type 2 fields may be reduced by using an offset coding technique. The Type 2 field values of plural co-scheduled cells may be indicated by a single field (Offset Coded Joint Type 2 DCI Field) (2700), for example, as shown in FIG. 27, Type 2 DCI fields of two or more cells (2710, 2720, 2730, 2740) may be coded based on relative offsets. A type 2 field format (2700) as shown in FIG. 27 works well with the interleaved DCI field format where Type 2 fields of multiple co-scheduled cells are arranged together as shown in FIG. 13, 17, 19, 24, 25 or 26. An exemplary 5-bit Type 2 DCI field (2710) is coded as “01111” for Cell index 1, while DCI field (2720) for Cell index 2, DCI field (2730) for Cell index 3 and DCI field (2740) for Cell index 4 are respectively coded as “01”, “11”, and “11”, where values “01”, “11”, and “11” indicates offsets from the coded value of “01111” for Cell index 1. The 2-bit offset values may be pre-defined in a UE over an RRC signaling by a BS, for example, offset values “00”, “01”, “10”, and “11” may indicate offset values of “same value as Cell index 1”, “−1 shift from value of Cell index 1”, “+1 shift from value of Cell index 1”, and “−2 shift from value of Cell index 1”, where −1 or −2 indicates shifting from row of Cell index 1 by two rows before in the coding table for the Type 2 or Type 1C field. Cell index 1 (reference cell) may be selected for transmitting full 5-bit DCI field based on Cell index (smallest or largest) or it may be preconfigured by RRC signaling, other remaining cells may be set in an ascending, or descending order based on cell indices or as per a predefined order indicated by RRC signaling. The offset coding helps in saving bits in the DCI however flexibility of scheduling may be restricted as a BS have to schedule cells with a restricted set of values. The offset-based DCI field coding technique may work very well if cells have similar channel properties, for example, Modulation and Coding Scheme (MCS) field configured as Type 2 DCI field may have similar values for cells in same or adjacent frequency bands and offset coding may be utilized for coding the MCS values for multiple cells. Similarly, FDRA field may utilize offset coding for indicating different values to the co-scheduled cells using offsets.

In another embodiment, a BS may transmit, and a UE may receive a PDCCH containing one of a DCI format as disclosed in the description in conjunction with FIG. 12, 14, 15, 16, 18, 22 or 23 for PUSCH/PDSCH scheduling on a plurality of cells including one or more Type 2 fields. The number of bits used for Type 2 fields may be reduced by using an offset coding technique. The Type 2 field values of plural co-scheduled cells may be indicated by using one full bit field (2810) and one or more offset coded Type 2 fields (Offset Coded Disjointed Type 2 DCI Field) (2820, 2830, 2840), for example, as shown in FIG. 28, Type 2 DCI fields of two or more cells may be coded based on relative offsets. A type 2 field format (2800) as shown in FIG. 28 works well with the DCI field format where Type 2 fields of multiple co-scheduled cells are arranged together for cells as shown in FIG. 12, 14, 15, 16, 18, 22 or 23. In case of FIG. 14 or 15, offset coding of FIG. 28 may be used to indicate Type 2 DCI field values for different subsets of cells, for example, Field 1 of Type 2_1 may be a full bit field and Field 1 of Type 2_2 may be a offset coded field relative to Type 2_1 field. An exemplary 5-bit Type 2 DCI field (2810) is coded “01111” for Cell index 1, while DCI field (2820) for Cell index 2, DCI field (2830) for Cell index 3 and DCI field (2840) for Cell index 4 are respectively coded “01”, “11”, and “11”, where the values “01”, “11”, and “11” indicates offsets from the coded value of “01111” for Cell index 1. The 2-bit offset values may be pre-defined in a UE over an RRC signaling by a BS, for example, offset values “00”, “01”, “10”, and “11” may indicate offset values of “same value as Cell 1”, “−1 shift from value of Cell1”, “+1 shift from value of Cell1”, and “−2 shift from value of Cell1”, where −1 or −2 indicates shifting from row of Cell1 by two rows before in the coding table for the Type 2 or Type 1C field. Cell index 1 (reference cell) may be selected for transmitting full 5-bit DCI field based on Cell index (smallest or largest) or it may be preconfigured by RRC signaling, other remaining cells may be set in an ascending, or descending order based on cell indices or as per a predefined order indicated by RRC signaling. The offset coding helps in saving bits in the DCI however flexibility of scheduling may be restricted as a BS have to schedule cells with a restricted set of values. The offset-based DCI field coding technique may work very well if cells have similar channel properties, for example, Modulation and Coding Scheme (MCS) field configured as Type 2 DCI field may have similar values for cells in same or adjacent frequency bands and offset coding may be utilized for coding the MCS values for multiple cells. Similarly, FDRA field may utilize offset coding for indicating different values to the co-scheduled cells using offsets.

The person skilled in the art would appreciate that the Type 2 DCI fields may be set differently from the ones mentioned in FIG. 27 or 28. The DCI field for Cell index 1 may have bits more than or less than 5 and DCI field for Cell indices 2, 3 or 4 may have bits more than or less than 2. The offset coding definition may be coded differently from the ones mentioned in conjunction with FIG. 27 or 28 and the number of offset coding bits may be more than 2 bits but would always be lesser than the number of bits used for Type 2 DCI field to indicate values for Cell index 1 (reference cell) to save bits by use of offset coding. Also, the number of co-scheduled cells may vary from the mentioned 4 cells.

In another embodiment, offset coding as shown in FIG. 27 or 28 for DCI Type 2 fields may be dynamically enabled/disabled by RRC signaling. Enable/disable signaling for offset coding may be transmitted a BS and received by a UE, whereby the enable/disable signaling may include an explicit 1-bit information or an implicit information derived from configuration of other parameters such as enable status of offset coding may be derived from the configuration information received by UE for configuring FDRA field and/or MCS field. For example, MCS field configured as Type 2 DCI field may use 5 bits per scheduled cell when offset coding is not enabled by RRC signaling and use 5 bits for Cell index 1 and 2 bits for the other co-scheduled cells when offset coding is enabled. Similarly, FDRA field may be dynamically enabled by RRC signaling offset coding. The RRC signaling may also indicate number of offset coding bits to be used for each cell other than the Cell index 1 (reference cell), the number of offset coding bits may be more than 2 bits but would always be lesser than the number of bits used for Type 2 DCI field to indicate values for Cell index 1 (reference cell) to save bits by use of offset coding.

### Dual Connectivity

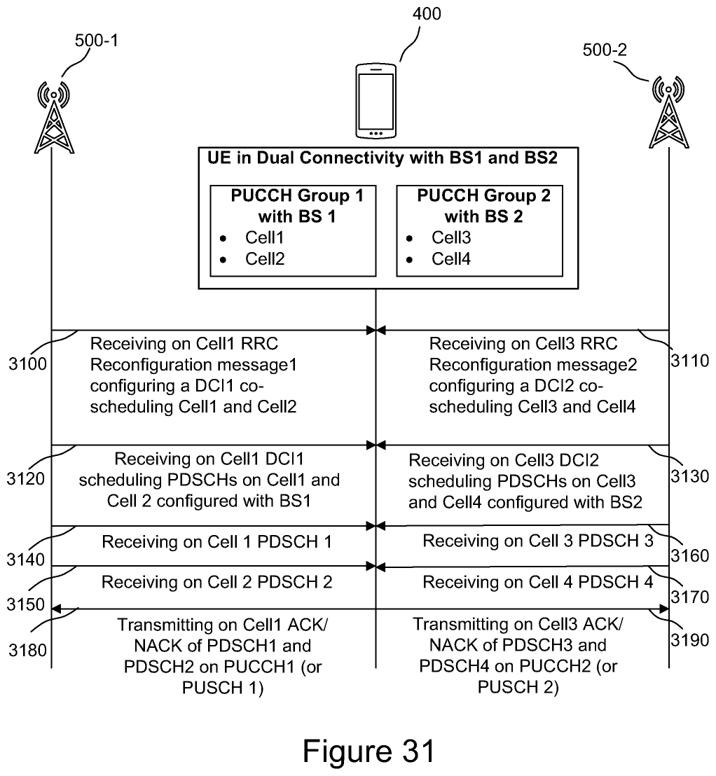

In embodiments as shown in FIGS. 31-38, a BS1 and/or BS2 may refer to a BS as shown in conjunction with the description of FIG. 5, and a UE may refer to a UE as shown in conjunction with the description of FIG. 4 for DCI scheduling PDSCHs/PUSCHs on each of a plurality of cells.

In another embodiment as presented in FIG. 31, a UE supports dual connectivity and maintains separate PUCCH groups with each base station (500-1, 500-2). For example, PUCCH Group 1 with BS1 (500-1) may include Cell1 and Cell2, and PUCCH group 2 with BS2 (500-2) may include Cell 3 and Cell4. A BS1 (500-1) may transmit, and a UE (400) may receive on Cell1 one or more RRC Reconfiguration message1 (3100) containing configuration information for configuring DCI co-scheduling PDSCHs on Cell 1 and Cell 2. Similarly, BS2 (500-2) may transmit, and a UE (400) may receive on Cell3 one or more RRC Reconfiguration message2 (3110) containing configuration information for configuring DCI co-scheduling PDSCHs on Cell 3 and Cell 4. The details of RRC Reconfiguration message1 (3100) and RRC Reconfiguration message2 (3110) may be identified from the description in conjunction with FIG. 29. Once a UE (400) is configured with PUCCH Group 1, PUCCH Group 2, DCI scheduling PDSCHs on Cell 1 and Cell 2, and DCI scheduling PDSCHs on Cell 3 and Cell 4, a UE (400) may receive DCI1 (3120) (transmitted on PDCCH1 by BS1 (500-1) on Cell1 and/or DCI2 (3130) (transmitted on PDCCH2 by BS2 (500-2) on Cell 3. The DCI1 (3120) is configured by BS1 (500-1) for scheduling Cell1 and Cell2 (where Cell1 is self-scheduling itself and cross-carrier scheduling Cell2), and DCI2 (3130) is configured by BS2 (500-2) for scheduling Cell3 and Cell4 (where Cell3 is self-scheduling itself and cross-carrier scheduling Cell4). DCI1 (3120) and DCI2 (3130) may refer to any of DCI formats disclosed in conjunction with the description of FIG. 12-19 or 22-26. Based on the received DCI1 (3120) and/or DCI2 (3130), a UE (400) may receive PDSCH1 on Cell1 (3140) and PDSCH2 on Cell2 (3150), and/or PDSCH3 on Cell3 (3160) and PDSCH4 on Cell4 (3170). The UE (400) may blind decode the PDCCH1 and/or PDCCH2 containing the respective DCI1 (3120) and/or DCI2 (3130). Based on a determination of correct reception of PDSCH 1 (3140) and PDSCH2 (3150), a UE (400) may transmit the ACK/NACK information (3180) for both PDSCH1 (3140) and PDSCH2 (3150) on a PUCCH1 on Cell1. In case PUSCH1 is also scheduled with PUCCH1, a UE (400) may transmit the ACK/NACK information (3180) for both PDSCH1 (3140) and PDSCH2 (3150) on a PUSCH1 instead of PUCCH1 on Cell1. The transmission of PUCCH1 or PUSCH1 on Cell1 may be performed as per the configuration of PUCCH Group1. In the example as shown in FIG. 31, Cell1 is configured as a PUCCH/PUSCH cell in the PUCCH Group1. Similarly, based on a determination of correct reception of PDSCH3 (3160) and PDSCH4 (3170), a UE (400) may transmit the ACK/NACK information (3190) for both PDSCH3 (3160) and PDSCH4 (3170) on a PUCCH2 on Cell3. In case PUSCH2 is also scheduled with PUCCH2, a UE (400) may transmit the ACK/NACK information (3190) for both PDSCH3 and PDSCH4 on a PUSCH2 instead of PUCCH2 on Cell3. The transmission of PUCCH2 or PUSCH2 on Cell3 may be performed as per the configuration of PUCCH Group2. In the example as shown in FIG. 31, Cell3 is configured as a PUCCH/PUSCH cell in the PUCCH Group2.

The person skilled in the art would appreciate that the PUCCH Group 1 and PUCCH Group 2 may include more than or less than 2 cells as illustrated in FIG. 31. Also, instead of self-scheduling and cross-carrier scheduling combination as disclosed in FIG. 31, only cross-carrier scheduling combinations may be used, where a Cell receiving RRC Reconfiguration message1 (3100) (or RRC Reconfiguration message2 (3110)) and/or DCI1 (3120) (or DCI2 (3130) may not receive the PDSCH. Further, a Cell configured for receiving RRC Reconfiguration message1 (3100) (or RRC Reconfiguration message2 (3110)) and/or DCI1 (3120) (or DCI2 (3130) such as Cell1 (or Cell3) as shown in FIG. 31 may be configured by a RRC message different from RRC Reconfiguration message1 (3100) (or RRC Reconfiguration message2 (3110)).

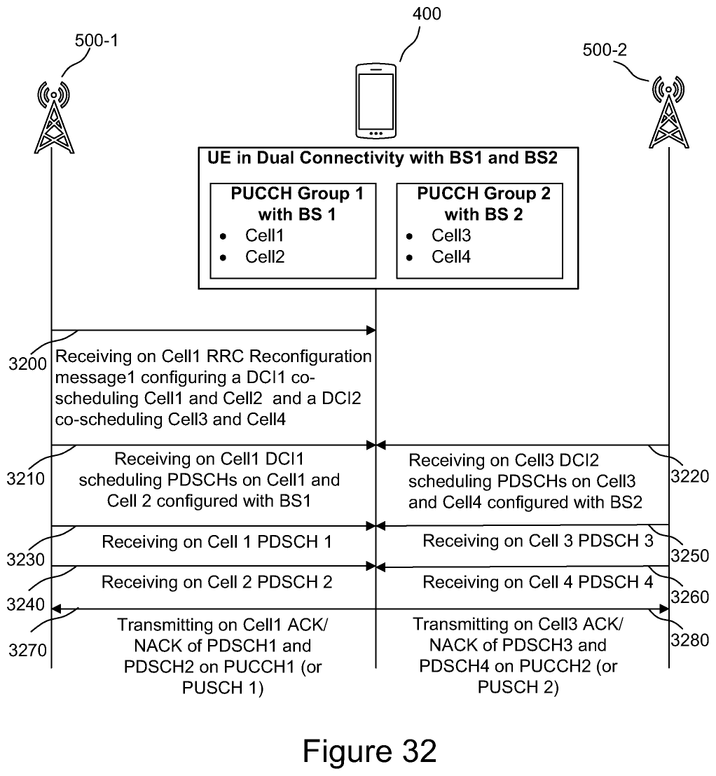

In another embodiment as presented in FIG. 32, a UE (400) supports dual connectivity and maintains separate PUCCH groups with each base station. For example, PUCCH Group 1 with BS1 (500-1) may include Cell1 and Cell2, and PUCCH group 2 with BS2 (500-2) may include Cell3 and Cell4. A BS1 (500-1) may transmit, and a UE (400) may receive on Cell1 one or more RRC Reconfiguration message1 (3200) containing configuration information for configuring DCI co-scheduling PDSCHs on Cell1 and Cell 2 and configuration information for configuring DCI co-scheduling PDSCHs on Cell3 and Cell 4. The details of RRC Reconfiguration message1 (3200) may be identified from the description in conjunction with FIG. 29. Once a UE (400) is configured with PUCCH Group 1, PUCCH Group 2, DCI scheduling PDSCHs on Cell 1 and Cell2, and DCI scheduling PDSCHs on Cell 3 and Cell 4, the UE (400) may receive DCI1 (3210) (transmitted on PDCCH1 by BS1 (500-1)) on Cell1 and/or DCI2 (3220) (transmitted on PDCCH2 by BS2 (500-2) on Cell 3. The DCI1 (3210) is configured by BS1 (500-1) for scheduling Cell1 and Cell2 (where Cell1 is self-scheduling itself and cross-carrier scheduling Cell2), and DCI2 (3220) is configured by BS2 (500-2) for scheduling Cell3 and Cell4 (where Cell3 is self-scheduling itself and cross-carrier scheduling Cell4). DCI1 (500-1) and DCI2 (500-2) may refer to one of DCI formats disclosed in conjunction with the description of FIG. 12-19 or 22-26. Based on the received DCI1 (3210) and/or DCI2 (3220), a UE (400) may receive PDSCH1 (3230) on Cell1 and PDSCH2 (3240) on Cell2, and/or PDSCH3 (3250) on Cell3 and PDSCH4 (3260) on Cell4. The UE (400) may blind decode the PDCCH1 and/or PDCCH2 containing the respective DCI1 (3210) and/or DCI2 (3220). Based on a determination of correct reception of PDSCH 1 (3230) and PDSCH2 (3240), a UE (400) may transmit the ACK/NACK information (3270) for both PDSCH1 (3230) and PDSCH2 (3240) on a PUCCH1 on Cell1. In case PUSCH1 is also scheduled with PUCCH1, a UE (400) may transmit the ACK/NACK information (3270) for both PDSCH1 (3230) and PDSCH2 (3240) on a PUSCH1 instead of PUCCH1 on Cell1. The transmission of PUCCH1 or PUSCH1 on Cell1 may be performed as per the configuration of PUCCH Group1. In the example as shown in FIG. 32, Cell1 is configured as a PUCCH/PUSCH cell in the PUCCH Group1. Similarly, based on a determination of correct reception of PDSCH3 (3250) and PDSCH4 (3260), a UE (400) may transmit the ACK/NACK information (3280) for both PDSCH3 (3250) and PDSCH4 (3260) on a PUCCH2 on Cell3. In case PUSCH2 is also scheduled with PUCCH2, a UE may transmit the ACK/NACK information for both PDSCH3 and PDSCH4 on a PUSCH2 instead of PUCCH2 on Cell3. The transmission of PUCCH2 or PUSCH2 on Cell3 may be performed as per the configuration of PUCCH Group2. In the example as shown in FIG. 32, Cell3 is configured as a PUCCH/PUSCH cell in the PUCCH Group2.

The person skilled in the art would appreciate that the PUCCH Group 1 and PUCCH Group 2 may include more than or less than 2 cells as illustrated in FIG. 32. Also, instead of self-scheduling and cross-carrier scheduling combination as disclosed in FIG. 32 only cross-carrier scheduling combinations may be used, where a Cell receiving RRC Reconfiguration message1 (3200) and/or DCI1 (3210) (or DCI2 (3220) may not receive the PDSCH. Further, a Cell configured for receiving RRC Reconfiguration message1 (3200) and/or DCI1 (3210) (or DCI2 (3220)) such as Cell1 (or Cell3) as shown in FIG. 32 may be configured by a RRC message different from RRC Reconfiguration message1 (3200).

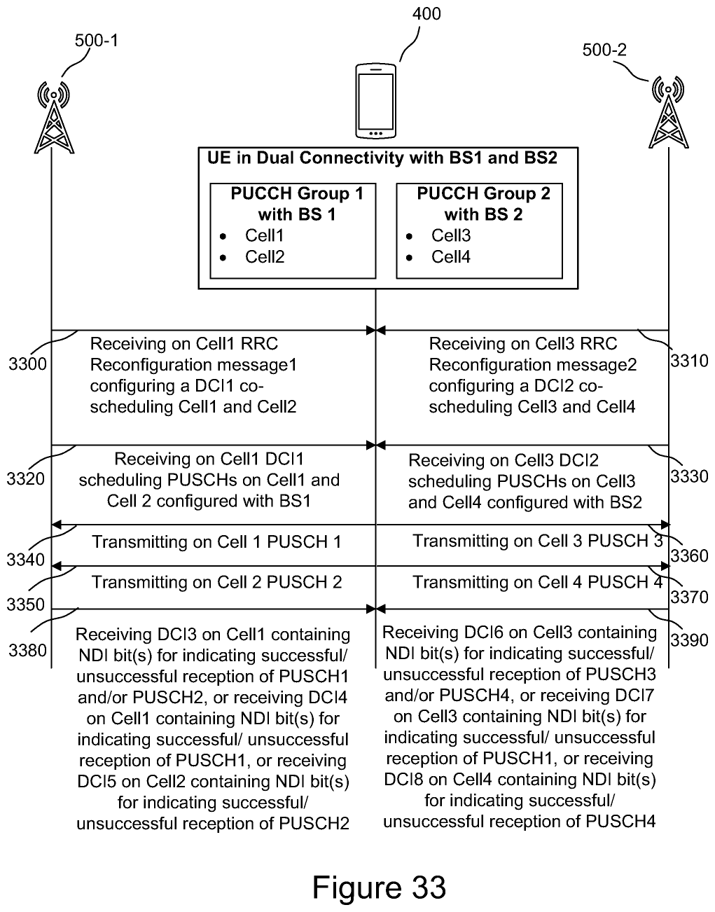

In another embodiment as presented in FIG. 33, a UE (400) supports dual connectivity and maintains separate PUCCH groups with each base station. For example, PUCCH Group 1 with BS1 (500-1) may include Cell1 and Cell2, and PUCCH group 2 with BS2 (500-2) may include Cell 3 and Cell4. A BS1 (500-1) may transmit, and a UE (400) may receive on Cell1 one or more RRC Reconfiguration message1 (3300) containing configuration information for configuring DCI co-scheduling PUSCHs on Cell 1 and Cell 2. Similarly, BS2 (500-2) may transmit, and a UE (400) may receive on Cell3 one or more RRC Reconfiguration message2 (3310) containing configuration information for configuring DCI co-scheduling PUSCHs on Cell 3 and Cell 4. The details of RRC Reconfiguration message1 (3300) and RRC Reconfiguration message2 (3310) may be identified from the description in conjunction with FIG. 30. Once a UE is configured with PUCCH Group 1, PUCCH Group 2, DCI scheduling PUSCHs on Cell 1 and Cell 2, and DCI scheduling PUSCHs on Cell 3 and Cell 4, a UE (400) may receive DCI1 (3320) (transmitted on PDCCH1 by BS1 (500-1)) on Cell1 and/or DCI2 (3330) (transmitted on PDCCH2 by BS2 (500-2)) on Cell 3. The DCI1 (3320) is configured by BS1 (500-1) for scheduling Cell1 and Cell2 (where Cell1 is self-scheduling itself and cross-carrier scheduling Cell2), and DCI2 (3330) is configured by BS2 (500-2) for scheduling Cell3 and Cell4 (where Cell3 is self-scheduling itself and cross-carrier scheduling Cell4). The DCI1 (3320) and DCI2 (3330) may refer to any of DCI formats disclosed in conjunction with the description of FIG. 12-19 or 22-26. Based on the received DCI1 (3320) and/or DCI2 (3330), a UE (400) may transmit PUSCH1 (3340) on Cell1 and PUSCH2 (3350) on Cell2, and/or PUSCH3 (3360) on Cell3 and PUSCH4 (3370) on Cell4. The UE (400) may blind decode the PDCCH1 and/or PDCCH2 containing the respective DCI1 (3320) and/or DCI2 (3330). Based on a determination of correct reception of PUSCH 1 (3340) and PUSCH2 (3350), BS1 (500-1) may transmit, and UE (400) may receive on Cell1 the ACK/NACK information for PUSCH1 and/or PUSCH2 on a DCI3 (3380) containing NDI bits indicating successful/unsuccessful reception of PUSCH1 (3340) and/or PUSCH2 (3350). Alternatively, a UE (400) may also receive the ACK/NACK information on DCI4 (3380) containing NDI bits indicating successful/unsuccessful reception of PUSCH1 (3340) on Cell1 or a UE (400) may receive the ACK/NACK information in DCI5 (3380) containing NDI bits indicating successful/unsuccessful reception of PUSCH2 (3350) on Cell2. The DCI3, DCI4 and DCI5 may have different formats, where DCI3 is used for scheduling plural cells and DCI4 and DCI5 are used for scheduling a single cell. In an embodiment, DCI3 and DCI1 may have the same format. The reception of DCI1, DCI3 or DCI4 on Cell1 may be performed as per the configuration of PUCCH Group1. In the example as shown in FIG. 33, Cell1 is configured as a scheduling cell in the PUCCH Group1. Similarly, based on a determination of correct reception of PUSCH3 (3360) and PUSCH4 (3370), BS2 (500-2) may transmit, and UE (400) may receive on Cell3 the ACK/NACK information for PUSCH3 (3360) and/or PUSCH4 (3370) on a DCI6 (3390) containing NDI bits indicating successful/unsuccessful reception of PUSCH3 (3360) and/or PUSCH4 (3370). Alternatively, a UE (400) may also receive the ACK/NACK information in DCI7 (3390) containing NDI bits indicating successful/unsuccessful reception of PUSCH3 (3360) on Cell3 or a UE (400) may receive the ACK/NACK information in DCI8 (3390) containing NDI bits indicating successful/unsuccessful reception of PUSCH4 (3370) on Cell4. The DCI6, DCI7 and DCI8 may have different formats, where DCI6 is used for scheduling plural cells and DCI7 and DCI8 are used for scheduling a single cell. In an embodiment, DCI6 and DCI2 may have the same format. The reception of DCI2, DCI6 or DCI7 on Cell3 may be performed as per the configuration of PUCCH Group2. In the example as shown in FIG. 33, Cell3 is configured as a scheduling cell in the PUCCH Group2.

The person skilled in the art would appreciate that the PUCCH Group 1 and PUCCH Group 2 may include more than or less than 2 cells as illustrated in FIG. 33. Also, instead of self-scheduling and cross-carrier scheduling combination as disclosed in FIG. 33 only cross-carrier scheduling combinations may be used, where a Cell receiving RRC Reconfiguration message1 (3300) (or RRC Reconfiguration message2 (3310)) and/or DCI1 (3320) (or DCI2 (3330)) may not transmit the PUSCH. Further, a Cell configured for receiving RRC Reconfiguration message1 (3300) (or RRC Reconfiguration message2 (3310)) and/or DCI1 (3320) (or DCI2 (3330)) such as Cell1 (or Cell3) as shown in FIG. 33 may be configured by a RRC message different from RRC Reconfiguration message1 (3300) (or RRC Reconfiguration message2 (3310)).

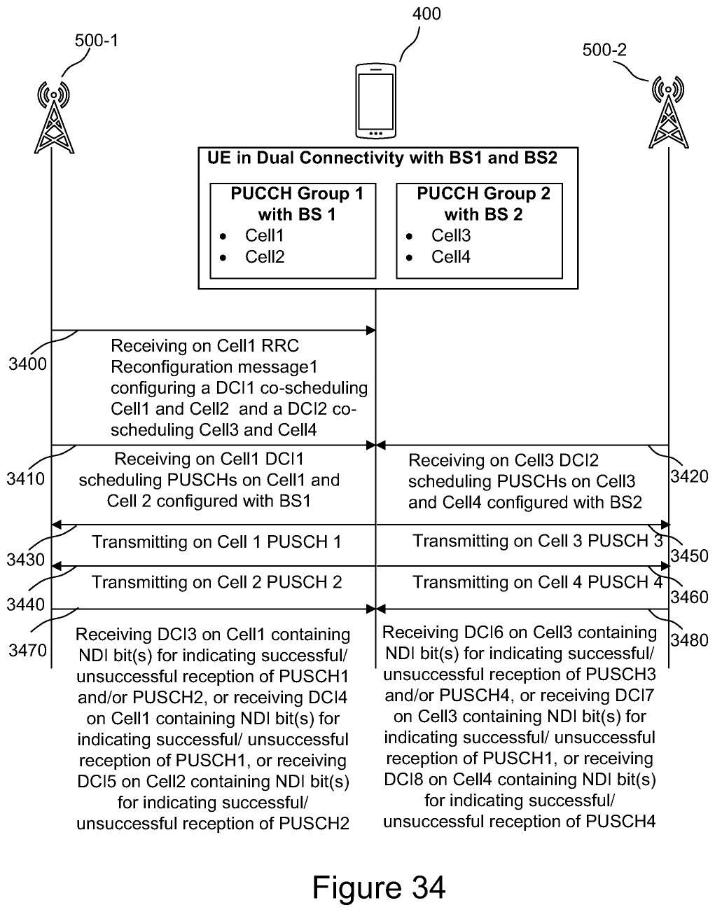

In another embodiment as presented in FIG. 34, a UE (400) supports dual connectivity and maintains separate PUCCH groups with each base station. For example, PUCCH Group 1 with BS1 (500-1) may include Cell1 and Cell2, and PUCCH group 2 with BS2 (500-2) may include Cell 3 and Cell4. A BS1 (500-1) may transmit, and a UE (400) may receive on Cell1 one or more RRC Reconfiguration message1 (3400) containing configuration information for configuring DCI co-scheduling PUSCHs on Cell 1 and Cell 2, and configuration information for configuring DCI co-scheduling PUSCHs on Cell 3 and Cell 4. The details of RRC Reconfiguration message1 (3400) may be identified from the description in conjunction with FIG. 30. Once a UE (400) is configured with PUCCH Group 1, PUCCH Group 2, DCI scheduling PUSCHs on Cell 1 and Cell 2, and DCI scheduling PUSCHs on Cell 3 and Cell 4, a UE (400) may receive DCI1 (3420) (transmitted on PDCCH1 by BS1 (500-1)) on Cell1 and/or DCI2 (3420) (transmitted on PDCCH2 by BS2 (500-2)) on Cell 3. The DCI1 (3420) is configured by BS1 (500-1) for scheduling Cell1 and Cell2 (where Cell1 is self-scheduling itself and cross-carrier scheduling Cell2), and DCI2 (3420) is configured by BS2 (500-2) for scheduling Cell3 and Cell4 (where Cell3 is self-scheduling itself and cross-carrier scheduling Cell4). The DCI1 (3420) and DCI2 (3420) may refer to any of DCI formats disclosed in conjunction with the description of FIG. 12-19 or 22-26. Based on the received DCI1 (3420) and/or DCI2 (3420), a UE (400) may transmit PUSCH1 (3430) on Cell1 and PUSCH2 (3440) on Cell2, and/or PUSCH3 (3450) on Cell3 and PUSCH4 (3460) on Cell4. The UE (400) may blind decode the PDCCH1 and/or PDCCH2 containing the respective DCI1 (3420) and/or DCI2 (3420). Based on a determination of correct reception of PUSCH 1 (3430) and PUSCH2 (3440), BS1 (500-1) may transmit, and UE (400) may receive on Cell1 the ACK/NACK information for PUSCH1 (3430) and/or PUSCH2 (3440) on a DCI3 (3470) containing NDI bits indicating successful/unsuccessful reception of PUSCH1 (3430) and/or PUSCH2 (3440). Alternatively, a UE (400) may also receive the ACK/NACK information in DCI4 (3470) containing NDI bits indicating successful/unsuccessful reception of PUSCH1 (3430) on Cell1 or a UE (400) may receive the ACK/NACK information in DCI5 (3470) containing NDI bits indicating successful/unsuccessful reception of PUSCH2 (3440) on Cell2. The DCI3, DCI4 and DCI5 may have different formats, where DCI3 is used for scheduling plural cells and DCI4 and DCI5 are used for scheduling a single cell. In an embodiment, DCI3 (3470) and DCI1 (3420) may have the same format. The reception of DCI1 (3420), DCI3 (3470) or DCI4 (3470) on Cell1 may be performed as per the configuration of PUCCH Group1. In the example as shown in FIG. 34, Cell1 is configured as a scheduling cell in the PUCCH Group1. Similarly, based on a determination of correct reception of PUSCH3 (3450) and PUSCH4 (3460), BS2 (500-2) may transmit, and UE (400) may receive on Cell3 the ACK/NACK information for PUSCH3 (3450) and/or PUSCH4 (3460) on a DCI6 (3480) containing NDI bits indicating successful/unsuccessful reception of PUSCH3 (3450) and/or PUSCH4 (3460). Alternatively, a UE (400) may also receive the ACK/NACK information in DCI7 (3480) containing NDI bits indicating successful/unsuccessful reception of PUSCH3 (3450) on Cell3 or a UE (400) may receive the ACK/NACK information in DCI8 (3480) containing NDI bits indicating successful/unsuccessful reception of PUSCH4 (3460) on Cell4. The DCI6, DCI7 and DCI8 may have different formats, where DCI6 is used for scheduling plural cells and DCI7 and DCI8 are used for scheduling a single cell. In an embodiment, DCI6 and DCI2 may have the same format. The reception of DCI2, DCI6 or DCI7 on Cell3 may be performed as per the configuration of PUCCH Group2. In the example as shown in FIG. 34, Cell3 is configured as a scheduling cell in the PUCCH Group2.

The person skilled in the art would appreciate that the PUCCH Group 1 and PUCCH Group 2 may include more than or less than 2 cells as illustrated in FIG. 34. Also, instead of self-scheduling and cross-carrier scheduling combination as disclosed in FIG. 34 only cross-carrier scheduling combinations may be used, where a Cell receiving RRC Reconfiguration message1 (3400) and/or DCI1 (3420) (or DCI2 (3420)) may not transmit the PUSCH. Further, a Cell configured for receiving RRC Reconfiguration message1 (3400) and/or DCI1 (3420) (or DCI2 (3420) such as Cell1 (or Cell3) as shown in FIG. 34 may be configured by a RRC message different from RRC Reconfiguration message1 (3400).

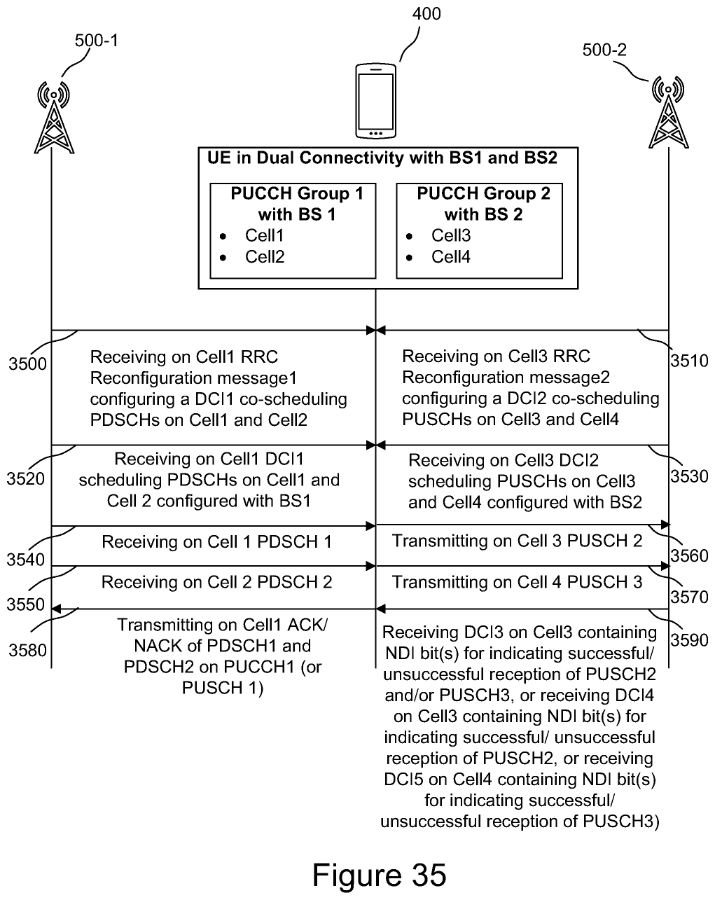

In another embodiment as presented in FIG. 35, a UE (400) supports dual connectivity and maintains separate PUCCH groups with each base station. For example, PUCCH Group 1 with BS1 (500-1) may include Cell1 and Cell2, and PUCCH group 2 with BS2 (500-2) may include Cell 3 and Cell4. A BS1 (500-1) may transmit, and a UE (400) may receive on Cell1 one or more RRC Reconfiguration message1 (3500) containing configuration information for configuring DCI co-scheduling PDSCHs on Cell 1 and Cell 2. Similarly, BS2 (500-2) may transmit, and a UE (400) may receive on Cell3 one or more RRC Reconfiguration message2 (3510) containing configuration information for configuring DCI co-scheduling PUSCHs on Cell 3 and Cell 4. The details of RRC Reconfiguration message1 (3500) and RRC Reconfiguration message2 (3510) may be identified from the description in conjunction with FIG. 29 or 30. Once a UE (400) is configured with PUCCH Group 1, PUCCH Group 2, DCI scheduling PDSCHs on Cell 1 and Cell 2, and DCI scheduling PUSCHs on Cell 3 and Cell 4, a UE (400) may receive DCI1 (3520) (transmitted on PDCCH1 by BS1 (500-1)) on Cell1 and/or DCI2 (3530) (transmitted on PDCCH2 by BS2 (500-2)) on Cell 3. The DCI1 (3520) is configured by BS1 (500-1) for scheduling Cell1 and Cell2 (where Cell1 is self-scheduling itself and cross-carrier scheduling Cell2), and DCI2 (3530) is configured by BS2 (500-2) for scheduling Cell3 and Cell4 (where Cell3 is self-scheduling itself and cross-carrier scheduling Cell4). The DCI1 (3520) and DCI2 (3530) may refer to any one of DCI formats disclosed in conjunction with the description of FIG. 12-19 or 22-26. Based on the received DCI1 (3520) and/or DCI2 (3530), a UE (400) may receive PDSCH1 (3540) on Cell1 and PDSCH2 (3550) on Cell2, and/or transmit PUSCH2 (3560) on Cell3 and PUSCH3 (3570) on Cell4. The UE may blind decode the PDCCH1 and/or PDCCH2 containing the respective DCI1 (3520) and/or DCI2 (3530). Based on a determination of correct reception of PDSCH 1 (3540) and PDSCH2 (3550), a UE (400) may transmit the ACK/NACK information for both PDSCH1 (3540) and PDSCH2 (3550) on a PUCCH1 (3580) on Cell1. In case PUSCH1 is also scheduled with PUCCH1, a UE (400) may transmit the ACK/NACK information for both PDSCH1 (3540) and PDSCH2 (3550) on a PUSCH1 (3580) instead of PUCCH1 on Cell1. The transmission of PUCCH1 or PUSCH1 on Cell1 may be performed as per the configuration of PUCCH Group1. In the example as shown in FIG. 35, Cell1 is configured as a PUCCH/PUSCH cell in the PUCCH Group1. Similarly, based on a determination of correct reception of PUSCH2 (3560) and PUSCH3 (3570), BS2 (500-2) may transmit, and UE (400) may receive on Cell3 the ACK/NACK information for PUSCH2 (3560) and/or PUSCH3 (3570) on a DCI3 (3500) containing NDI bits indicating successful/unsuccessful reception of PUSCH2 (3560) and/or PUSCH3 (3570). Alternatively, a UE (400) may also receive the ACK/NACK information in DCI4 (3500) containing NDI bits indicating successful/unsuccessful reception of PUSCH2 (3560) on Cell3 or a UE (400) may receive the ACK/NACK information in DCI5 (3500) containing NDI bits indicating successful/unsuccessful reception of PUSCH3 (3570) on Cell4. The DCI3, DCI4 and DCI5 may have different formats, where DCI3 is used for scheduling plural cells and DCI4 and DCI5 are used for scheduling a single cell. In an embodiment, DCI3 and DCI2 may have the same format. The reception of DCI2, DCI3 or DCI4 on Cell3 may be performed as per the configuration of PUCCH Group2. In the example as shown in FIG. 35, Cell3 is configured as a scheduling cell in the PUCCH Group2.

The person skilled in the art would appreciate that the PUCCH Group 1 and PUCCH Group 2 may include more than or less than 2 cells as illustrated in FIG. 35. Also, instead of self-scheduling and cross-carrier scheduling combination as disclosed in FIG. 35 only cross-carrier scheduling combinations may be used, where a Cell receiving RRC Reconfiguration message1 (3500)/RRC Reconfiguration message2 (3510) and/or DCI1 (3520)/DCI2 (3530) may not receive/transmit the PDSCH/PUSCH. Further, a Cell configured for receiving RRC Reconfiguration message1 (3500)/RRC Reconfiguration message2 (3510) and/or DCI1 (3520)/DCI2 (3530) such as Cell1/Cell3 as shown in FIG. 35 may be configured by a RRC message different from RRC Reconfiguration message1 (3500) or RRC Reconfiguration message2 (3510).

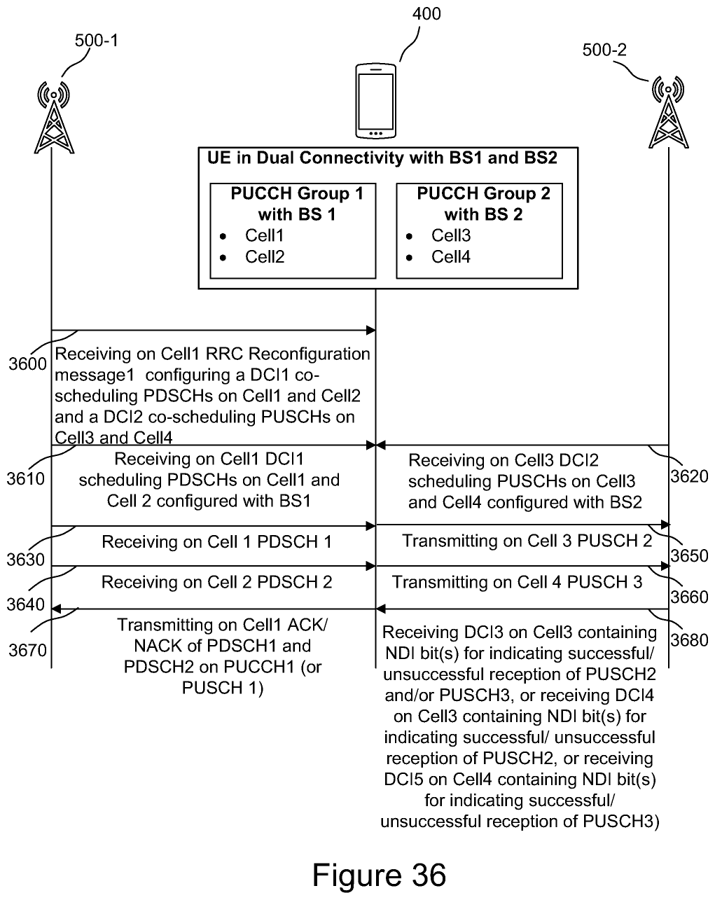

In another embodiment as presented in FIG. 36, a UE (400) supports dual connectivity and maintains separate PUCCH groups with each base station. For example, PUCCH Group 1 with BS1 (500-1) may include Cell1 and Cell2, and PUCCH group 2 with BS2 (500-2) may include Cell 3 and Cell4. A BS1 (500-1) may transmit, and a UE (400) may receive on Cell1 one or more RRC Reconfiguration message1 (3600) containing configuration information for configuring DCI co-scheduling PDSCHs on Cell 1 and Cell 2, and configuration information for configuring DCI co-scheduling PUSCHs on Cell 3 and Cell 4. The details of RRC Reconfiguration message1 (3600) may be identified from the description in conjunction with FIG. 29 or 30. Once a UE (400) is configured with PUCCH Group 1, PUCCH Group 2, DCI scheduling PDSCHs on Cell 1 and Cell 2, and DCI scheduling PUSCHs on Cell 3 and Cell 4, a UE (400) may receive DCI1 (3610) (transmitted on PDCCH1 by BS1 (500-1)) on Cell1 and/or DCI2 (3620) (transmitted on PDCCH2 by BS2 (500-2)) on Cell 3. In an alternative embodiment, in case of heterogeneous network deployment where BS1 (500-1) (configured as macro cell) is used only for downlink transmissions to a UE (400) and BS2 (500-2) (configured as micro cell) is used only for uplink transmissions from the UE (400), the UE (400) may both receive DCI1 (3610) and DCI2 (3620) from BS1 (500-1). The DCI1 (3610) is configured by BS1 (500-1) for scheduling Cell1 and Cell2 (where Cell1 is self-scheduling itself and cross-carrier scheduling Cell2), and DCI2 (3620) is configured by BS2 (500-2) for scheduling Cell3 and Cell4 (where Cell3 is self-scheduling itself and cross-carrier scheduling Cell4). The DCI1 (3610) and DCI2 (3620) may refer to any of DCI formats disclosed in conjunction with the description of FIG. 12-19 or 22-26. Based on the received DCI1 (3610) and/or DCI2 (3620), a UE (400) may receive PDSCH1 (3630) on Cell1 and PDSCH2 (3640) on Cell2, and/or transmit PUSCH2 (3650) on Cell3 and PUSCH3 (3660) on Cell4. The UE (400) may blind decode the PDCCH1 and/or PDCCH2 containing the respective DCI1 (3610) and/or DCI2 (3620). Based on a determination of correct reception of PDSCH 1 (3630) and PDSCH2 (3640), a UE may transmit the ACK/NACK information for both PDSCH1 (3630) and PDSCH2 (3640) on a PUCCH1 (3670) on Cell1. In case PUSCH1 is also scheduled with PUCCH1, a UE (400) may transmit the ACK/NACK information for both PDSCH1 and PDSCH2 on a PUSCH1 (3670) instead of PUCCH1 on Cell1. The transmission of PUCCH1 or PUSCH1 on Cell1 may be performed as per the configuration of PUCCH Group1. In the example as shown in FIG. 36, Cell1 is configured as a PUCCH/PUSCH cell in the PUCCH Group1. Similarly, based on a determination of correct reception of PUSCH2 (3650) and PUSCH3 (3660), BS2 (500-2) may transmit, and UE (400) may receive on Cell3 the ACK/NACK information for PUSCH2 (3650) and/or PUSCH3 (3660) on a DCI3 (3680) containing NDI bits indicating successful/unsuccessful reception of PUSCH2 (3650) and/or PUSCH3 (3660). Alternatively, a UE (400) may also receive the ACK/NACK information in DCI4 (3680) containing NDI bits indicating successful/unsuccessful reception of PUSCH2 (3650) on Cell3 or a UE (400) may receive the ACK/NACK information in DCI5 (3680) containing NDI bits indicating successful/unsuccessful reception of PUSCH3 (3660) on Cell4. The DCI3, DCI4 and DCI5 may have different formats, where DCI3 is used for scheduling plural cells and DCI4 and DCI5 are used for scheduling a single cell. In an embodiment, DCI3 and DCI2 may have the same format. The reception of DCI2, DCI3 or DCI4 on Cell3 may be performed as per the configuration of PUCCH Group2. In the example as shown in FIG. 36, Cell3 is configured as a scheduling cell in the PUCCH Group2.

The person skilled in the art would appreciate that the PUCCH Group 1 and PUCCH Group 2 may include more than or less than 2 cells as illustrated in FIG. 36. Also, instead of self-scheduling and cross-carrier scheduling combination as disclosed in FIG. 36 only cross-carrier scheduling combinations may be used, where a Cell receiving RRC Reconfiguration message1 (3600) and/or DCI1 (3610)/DCI2 (3620) may not receive/transmit the PDSCH/PUSCH. Further, a Cell configured for receiving RRC Reconfiguration message1 (3600) and/or DCI1 (3610)/DCI2 (3620) such as Cell1/Cell3 as shown in FIG. 36 may be configured by a RRC message different from RRC Reconfiguration message1 (3600).

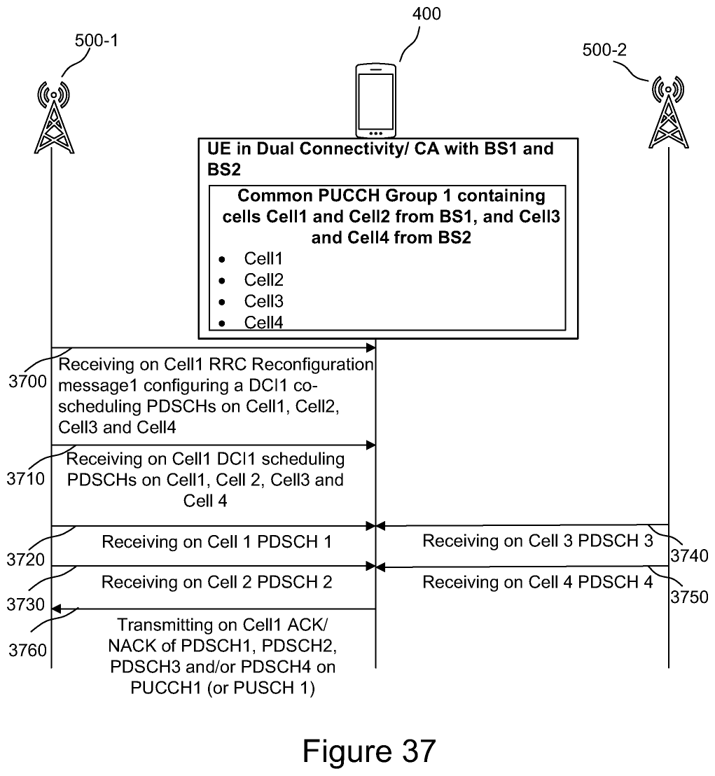

In another embodiment as presented in FIG. 37, a UE (400) supports dual connectivity/CA (Carrier Aggregation) and maintains a common PUCCH group with each base station. For example, PUCCH Group 1 may include Cell1 and Cell2 configured with BS1 (500-1) and Cell3 and Cell4 configured with BS2 (500-2). However, PUCCH is transmitted only on a PUCCH Cell (for example Cell1 may be configured as PUCCH Cell) among the Cell1, Cell2, Cell3 and Cell4. A BS1 (500-1) may transmit, and a UE (400) may receive on Cell1 one or more RRC Reconfiguration message1 (3700) containing configuration information for configuring DCI co-scheduling PDSCHs on Cell1, Cell 2, Cell3 and Cell 4. The details of RRC Reconfiguration message1 (3700) may be identified from the description in conjunction with FIG. 29. Once a UE (400) is configured with PUCCH Group 1 and DCI scheduling PDSCHs on Cell 1, Cell2, Cell 3 and Cell 4, a UE (400) may receive DCI1 (3710) (transmitted on PDCCH1 by BS1 (500-1) on Cell1. The DCI1 (3710) is configured by BS1 (500-1) for scheduling Cell1, Cell2, Cell3 and Cell4 (where Cell1 is self-scheduling itself and cross-carrier scheduling Cell2, Cell3 and Cell4). The DCI1 (3710) may refer to one of a DCI format disclosed in conjunction with the description of FIG. 12-19 or 22-26. Based on the received DCI1 (3710), a UE (400) may receive PDSCH1 (3720) on Cell1, PDSCH2 (3730) on Cell2, PDSCH3 (3740) on Cell3 and/or PDSCH4 (3750) on Cell4. The UE (400) may blind decode the PDCCH1 containing the DCI1 (3710). Based on a determination of correct reception of PDSCH1 (3720), PDSCH2 (3730), PDSCH3 (3740) and/or PDSCH4 (3750), a UE (400) may transmit the ACK/NACK information for the PDSCH1 (3720), PDSCH2 (3730), PDSCH3 (3740) and/or PDSCH4 (3750) on a PUCCH1 (3760) on Cell1. In case PUSCH1 is also scheduled with PUCCH1, a UE (400) may transmit the ACK/NACK information for PDSCH1 (3720), PDSCH2 (3730), PDSCH3 (3740) and/or PDSCH4 (3750) on a PUSCH1 (3760) instead of PUCCH1 on Cell1. The transmission of PUCCH1 or PUSCH1 on Cell1 may be performed as per the configuration of PUCCH Group1. In the example as shown in FIG. 37, Cell1 is configured as a PUCCH/PUSCH cell in the PUCCH Group 1.

The person skilled in the art would appreciate that the PUCCH Group 1 may include more than or less than 4 cells as illustrated in FIG. 37. Also, instead of self-scheduling and cross-carrier scheduling combination as disclosed in FIG. 37 only cross-carrier scheduling combinations may be used, where a Cell receiving RRC Reconfiguration message1 (3700) and/or DCI1 (3710) may not receive the PDSCH. Further, a Cell configured for receiving RRC Reconfiguration message1 (3700) and/or DCI1 (3710) such as Cell1 as shown in FIG. 37 may be configured by a RRC message different from RRC Reconfiguration message1 (3700).

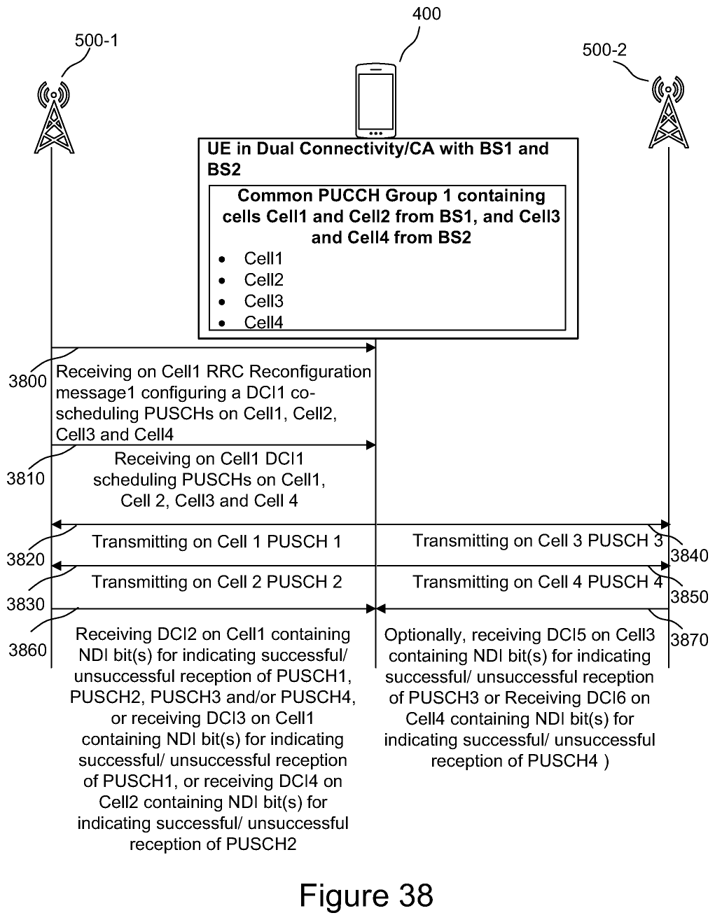

In another embodiment as presented in FIG. 38, a UE (400) supports dual connectivity/CA (Carrier Aggregation) and maintains a common PUCCH group with each base station. For example, PUCCH Group 1 may include Cell1 and Cell2 configured with BS1 (500-1) and Cell3 and Cell4 configured with BS2 (500-2). A BS1 (500-1) may transmit, and a UE (400) may receive on Cell1 one or more RRC Reconfiguration message1 (3800) containing configuration information for configuring DCI co-scheduling PUSCHs on Cell1, Cell 2, Cell3 and Cell 4. The details of RRC Reconfiguration message1 (3800) may be identified from the description in conjunction with FIG. 30. Once a UE (400) is configured with PUCCH Group 1 and DCI scheduling PUSCHs on Cell 1, Cell2, Cell 3 and Cell 4, a UE (400) may receive DCI1 (3810) (transmitted on PDCCH1 by BS1 (500-1) on Cell1. The DCI1 (3810) is configured by BS1 (500-1) for scheduling Cell1, Cell2, Cell3 and Cell4 (where Cell1 is self-scheduling itself and cross-carrier scheduling Cell2, Cell3 and Cell4). The DCI1 (3810) may refer to one of a DCI format disclosed in conjunction with the description of FIG. 12-19 or 22-26. Based on the received DCI1 (3810), a UE (400) may transmit PUSCH1 (3820) on Cell1, PUSCH2 (3830) on Cell2, PUSCH3 (3840) on Cell3 and/or PUSCH4 (3850) on Cell4. The UE (400) may blind decode the PDCCH1 containing the DCI1 (3810). Based on a determination of correct reception of PUSCH1 (3820), PUSCH2 (3830), PUSCH3 (3840) and/or PUSCH4 (3850), BS1 (500-1) may transmit, and a UE (400) may receive on Cell1 the ACK/NACK information for the PUSCH1 (3820), PUSCH2 (3830), PUSCH3 (3840) and/or PUSCH4 (3850) in a DCI2 (3860). Alternatively, a UE (400) may also receive the ACK/NACK information in DCI3 (3860) containing NDI bits indicating successful/unsuccessful reception of PUSCH1 (3820) on Cell1 or a UE (400) may receive the ACK/NACK information in DCI4 (3830) containing NDI bits indicating successful/unsuccessful reception of PUSCH2 (3830) on Cell2. The DCI2, DCI3 and DCI4 may have different formats, where DCI2 is used for scheduling plural cells and DCI3 and DCI4 are used for scheduling a single cell. In an embodiment, DCI2 and DCI1 may have the same format. The reception of DCI1, DCI2 or DCI3 on Cell1 may be performed as per the configuration of PUCCH Group1. In the example as shown in FIG. 38, Cell1 is configured as a scheduling cell in the PUCCH Group 1. A UE (400) may also receive the ACK/NACK information in DCI5 (3870) containing NDI bits indicating successful/unsuccessful reception of PUSCH3 (3840) on Cell3 or a UE (400) may receive the ACK/NACK information in DCI6 (3870) containing NDI bits indicating successful/unsuccessful reception of PUSCH4 (3850) on Cell4. The DCI5 and DCI6 may be used for scheduling a single cell.

The person skilled in the art would appreciate that the PUCCH Group 1 may include more than or less than 4 cells as illustrated in FIG. 38. Also, instead of self-scheduling and cross-carrier scheduling combination as disclosed in FIG. 38 only cross-carrier scheduling combinations may be used, where a Cell receiving RRC Reconfiguration message1 (3800) and/or DCI1 (3810) may not transmit the PUSCH. Further, a Cell configured for receiving RRC Reconfiguration message1 (3800) and/or DCI1 (3810) such as Cell1 as shown in FIG. 38 may be configured by a RRC message different from RRC Reconfiguration message1 (3800).

### Same Transport Block (TB) on Co-Scheduled Cells

As shown in FIG. 11, scheduling PUSCH or PDSCH per cell on each of a plurality of cells (1140, 1150) with a single DCI (1100) transmitted on a scheduling cell (1130), where the plural PUSCH or PDSCH carry the same transport block (TB) (1110 and 1120), is shown in accordance with an embodiment.

A portion of TB (1110 or 1120) may be transmitted to each cell. The Code Block Groups (CBGs) of the TB may be divided among the scheduled cells for PUSCH/PDSCH transmission. The number of CBGs or the size of CBGs transmitted on each cell may be indicated separately to the UE via RRC signalling or the physical layer signalling.

In an embodiment, the size of CBGs transmitted on each cell may be configured as equal, in which case, no separate signalling may be required for configuring UE.

When the same transport block is transmitted/received on the co-scheduled cells, many data fields of the DCI format are common Type 1 DCI fields as they refer to the same PUSCH or PDSCH data.

A person of skill in the art will appreciate that the DCI fields for PUSCH or PDSCH scheduling same transport block (TB) on co-scheduled cells may include a CSCI field which may be configured as per the concepts described in conjunction with the tables 1-5. Further, DCI format described in conjunction with the FIGS. 6-8 may be used for scheduling same transport block (TB) on co-scheduled cells.

### Two Stage DCI

In accordance with an embodiment, once a UE is configured for PUSCH/PDSCH scheduling on a plurality of cells with a single DCI, a two-stage DCI may be configured, whereby in the first stage DCI a portion of DCI fields may be received by the UE and subsequently a second DCI may be received for the remaining DCI fields. This technique may help keep a check on the DCI size as an overly large DCI size could reduce the PDCCH reception probability. Also, it may be beneficial to have two-stage DCI as PDCCH size is restricted to 140 bits (excluding CRC) in 5G NR and PDCCH size might exceed 140 bits when scheduling plural cells using a single DCI.

In accordance with an embodiment, a way of scheduling multiple cells using a single DCI can includes the steps of:
receiving a first downlink control information (DCI) for scheduling a plurality of cells;
wherein the first DCI including one or more common fields applicable to the plurality of cells;
receiving a second downlink control information (DCI), after receiving the first DCI, for scheduling the plurality of cells;
wherein the second DCI includes at least one independent field applicable to each of the plurality of cells.

In an embodiment, the first stage DCI may contain the Type 1 DCI fields and the second stage DCI may contain the Type 2 DCI fields.

In another embodiment, the UE may be configured to receive the first stage DCI containing the Type 1 DCI fields and portion of Type 2 DCI fields to a total of 140 bits (excluding CRC) and the second stage DCI containing the remaining Type 2 DCI fields.

In another embodiment, if the first stage DCI contains only the Type 1 DCI fields, CSCI field may not be present in the DCI, while for the second stage DCI since all the Type 2 DCI fields are configured CSCI field may be present to indicate the scheduled cells.

In another embodiment, the first stage DCI information may be stored by UE for combining with the subsequently received one or more second stage DCI(s).

In another embodiment, a UE may be configured to receive the first stage DCI on PDCCH, and the second stage DCI on PDSCH. The second stage DCI may be multiplexed with the PDSCH scheduled by the first stage DCI.

In another embodiment, if the second stage DCI is configured to be received on PDSCH by a UE, the PDSCH may be configured to be received on the same scheduling cell on which PDCCH containing the first stage DCI was received.

In another embodiment, if the second stage DCI is configured to be received on PDSCH by a UE, the PDSCH may be configured to be received on a cell indicated by the cell indicator field of the first stage DCI.

In another embodiment, a UE may be configured to receive on a scheduling cell a first stage DCI containing a first indicator field, after receiving the first stage DCI, the UE may be configured to receive a second stage DCI containing a second indicator field. The first indicator field may indicate a cell on which the second stage DCI containing the second indicator field is received. The second indicator field may indicate a plurality of scheduled cells.

In another embodiment, a UE may be configured to receive on a scheduling cell a first stage DCI containing a first indicator field and a second indicator field, after receiving the first stage DCI, the UE may be configured to receive a second stage DCI. The first indicator field may indicate a cell on which the second stage DCI containing the second indicator field is received. The second indicator field may indicate a plurality of scheduled cells.

In another embodiment, a UE may be configured to receive on a first cell a first stage DCI, after receiving the first stage DCI, the UE may be configured to receive a second stage DCI on a second cell. The second cell may be indicated implicitly by the reception of first stage DCI or may be preconfigured in the UE by RRC signalling received from a base station. In another embodiment, the first cell and the second cell may be configured to be the same or different.

In another embodiment, a UE may be configured to dynamically receive a single-stage DCI and two-stage DCIs depending on the number of co-scheduled cells. For a larger number of co-scheduled cells, two-stage DCI may be used while for a small number of co-scheduled cells single stage DCI may be used. The switching between single-stage DCI and two-stage DCI may be indicated to UE by RRC signalling or physical layer signalling or may be determined by UE depending on the determination of the number of co-scheduled cells.

In another embodiment, the first stage DCI may be linked with the second stage DCI (if UE is configured to receive second stage DCI on PDCCH) to reduce the blind decoding effort by UE. The linkage information may be provided to UE by either RRC configuration or the first stage DCI. In another embodiment, the linkage information may indicate a predefined resource offset between the first PDCCH containing the first stage DCI and the second PDCCH containing the second stage DCI. The resource offset may indicate offset of time and/or frequency resources. In another embodiment, the linkage information may indicate same frequency resources and different time resources for receiving the first PDCCH containing the first stage DCI and the second PDCCH containing the second stage DCI.

A person of skill in the art will appreciate that the Type 1 or Type 2 DCI fields for PUSCH or PDSCH scheduling using two stage DCI may include DCI fields categorized as Type 1 or Type 2 in other embodiments of the present disclosure. Further, Type 1 DCI field may include a CSCI field which may be configured as per the concepts described in conjunction with the tables 1-5.

### Scheduling PUSCH or PDSCH Per Cell on Each of a Plurality of Cells in Case of Cell Release or Deactivation

In an embodiment, if a plurality of cells are semi-statically configured for various DCI fields and one or more cells goes to a dormant state or deactivated state or the cell(s) is/are released, the semi-static configuration of the DCI fields may be accordingly updated, and UE can continue to receive DCI scheduling a plurality of cells for the remaining cells in the cell group according to the updated semi-static configuration of the DCI fields.

In an alternative embodiment, if a plurality of cells are semi-statically configured for various DCI fields and one or more cells go to a dormant state or deactivated state or the cell(s) is/are released, the UE may release the semi-static configuration of the DCI fields and UE may no longer receive DCI scheduling a plurality of cells for the remaining cells in the cell group.

In another embodiment, if a plurality of cells are semi-statically configured for various DCI fields and one or more cells goes to a dormant state or deactivated state or the cell(s) is/are released, the semi-static configuration may be released, and UE may receive DCI scheduling a plurality of cells containing independent Type 2 DCI fields for each of the remaining cell(s) corresponding to the previously configured semi-static DCI fields while Type 1 DCI fields can continue to remain common for the cells.

### Switching Between Single Cell PUSCH or PDSCH Scheduling Mode and Plural Cell PUSCH or PDSCH Scheduling Mode

In an embodiment, for simplicity, a UE may be configured in either a single cell PUSCH or PDSCH scheduling mode or plural cell PUSCH or PDSCH scheduling mode. Therefore, in accordance with an embodiment, a signalling mechanism may be used whereby a UE is configured to dynamically switch between single-cell PUSCH or PDSCH scheduling mode and plural cell PUSCH or PDSCH scheduling mode. The signaling indicates to the UE to stop monitoring the PDCCH for DCI scheduling single cell PUSCH or PDSCH and start monitoring the PDCCH for DCI scheduling plural cell PUSCH or PDSCH or vice versa.

The switching configuration signalling can be provided by RRC signalling or a physical layer signalling. While switching from a plural cell PUSCH or PDSCH scheduling mode to a single cell PUSCH or PDSCH scheduling mode, the UE may save plural cell PUSCH or PDSCH scheduling configuration information which can be re-used when the UE switches back to a plural cell PUSCH or PDSCH scheduling mode from a single cell PUSCH or PDSCH scheduling mode.

Further, switching configuration signalling can include a duration or a predefined number of occasions for the switched mode to be valid before switching back to the previous mode. For example, if UE is in a single cell PUSCH or PDSCH scheduling mode, the UE can receive a switching configuration signalling indicating a duration or a predefined number of occasions for which the UE can switch to a plural cell PUSCH or PDSCH scheduling mode before switching back to single-cell PUSCH or PDSCH scheduling mode. It may help in getting the benefits of both modes.

In an embodiment, while in a plural cell PUSCH or PDSCH scheduling mode, if one or more cells goes to a dormant state or deactivated state or the cell(s) is/are released, UE can switch to a single cell PUSCH or PDSCH scheduling mode.

### Re-Transmission Scheduling

In accordance with an embodiment, a DCI for scheduling a plurality of cells may be used for scheduling the PUSCH or PDSCH, however, for re-transmissions, a UE may be configured by the base station to use a cell-specific single-cell DCI. In an alternative embodiment, a UE may be configured by the base station to use a DCI for scheduling a plurality of cells for both transmissions and re-transmissions, the Type 2 fields may indicate the cell-specific HARQ-ID, RV & NDI, etc. for scheduling re-transmissions.

### HARQ ACK/NACK Timing

In accordance with an embodiment the DCI format 1_Y for scheduling PDSCHs (for example, one of a DCI format among the DCI formats disclosed in FIGS. 12-19) may indicate a slot level offset in the PDSCH-to-HARQ_timing indicator DCI field for PUCCH transmission by the UE (for example, a UE described in conjunction with the description of FIG. 4).

If subslotLengthForPUCCH is not provided. The PUCCH timing may be according to the PDSCH-to-HARQ_timing indicator DCI field according to the following embodiments.

In an embodiment, the UE may be configured with same Time Domain Resource Allocation (TDRA) for all the co-scheduled cells (if the TDRA field is configured as a Type 1 DCI field or TDRA field is not included in a DCI and configured by RRC) and PDSCH reception and PDSCH-to-HARQ_timing may also be the same for all the co-scheduled cells. This embodiment may be beneficial in reducing the UE complexity at the expense of lesser scheduling flexibility among the co-scheduled cells. The co-scheduled cells may be configured as part of the same PUCCH group.

In another embodiment, the UE may be configured with different PDSCHs reception timings for the co-scheduled cells, one co-scheduled cell may be made a reference cell, and timing of the reference cell may be followed for determining the common PUCCH timing. The co-scheduled cells may be configured as part of the same PUCCH group. In another embodiment, the reference cell for determining the common PUCCH timing may be the cell with the earliest PDSCH start timing. In another embodiment, the reference cell for determining the common PUCCH timing may be the cell with the later PDSCH end timing among the co-scheduled cells. In another embodiment, the reference cell for determining the common PUCCH timing may be the cell configured in the UE by RRC signalling as the reference cell.

If subslotLengthForPUCCH is provided the PUCCH timing may be according to the following embodiments:

In another embodiment, if a UE is configured with subslotLengthForPUCCH in a PUCCH-Config of co-scheduled cells, the first symbol of a PUCCH resource provided by PUCCH-ResourceSet or SPS-PUCCH-AN-List in PUCCH-Config or by n1PUCCH-AN in SPS-Config, for multiplexing HARQ-ACK in a PUCCH transmission may be relative to the symbol of a reference cell. In another embodiment, the reference cell for determining the PUCCH transmission timing may be the cell configured with the maximum value for subslotLengthForPUCCH among the co-scheduled cells. In another embodiment, the reference cell for determining the PUCCH transmission timing may be the cell configured by RRC as the reference cell. In another embodiment, the reference cell for determining the PUCCH transmission timing may be the cell configured with the earliest PDSCH symbol among the co-scheduled cells. In another embodiment, the reference cell for determining the PUCCH transmission timing may be the cell configured with later PDSCH symbol among the co-scheduled cells.

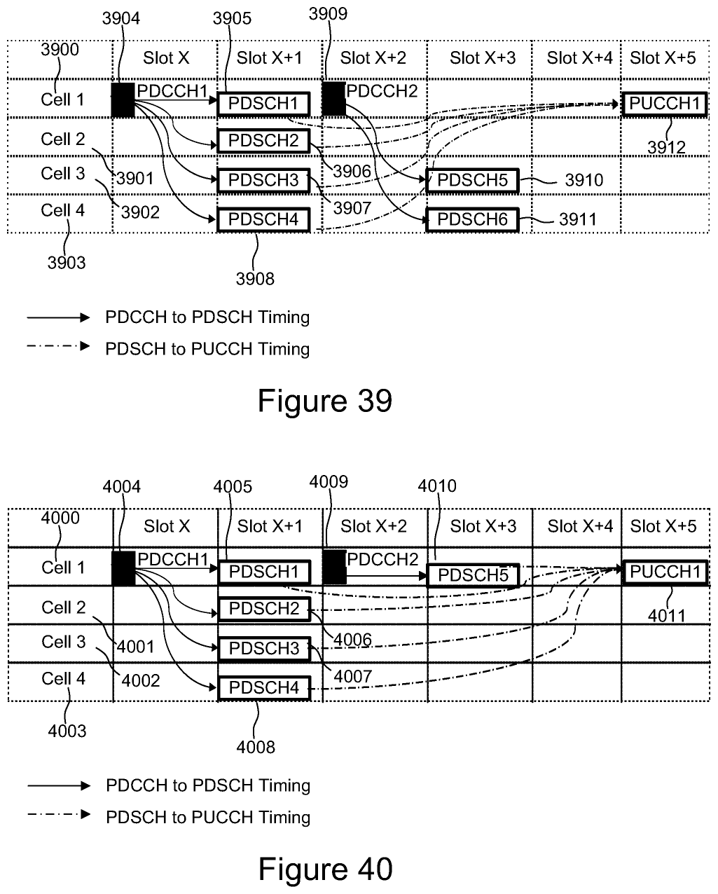

In another embodiment as presented in FIG. 39, a BS (for example, a BS as shown in conjunction with FIG. 5) may transmit and a UE (for example, a UE as shown in conjunction with FIG. 4) may receive a PDCCH1 (3904) containing DCI1 self-scheduling PDSCH1 (3905) on Cell1 (3900) and cross-carrier scheduling PDSCH2 (3906), PDSCH3 (3907), and PDSCH4 (3908) on Cell2 (3901), Cell3 (3902), and Cell4 (3903) respectively. PDCCH1 (3904) is received by a UE in Slot X and PDCCH to PDSCH reception timing of PDCCH1 (3904) is one slot and the scheduled PDSCH1 (3905), PDSCH2 (3906), PDSCH3 (3907), and PDSCH4 (3908) are received in Slot X+1 on Cell1 (3900), Cell2 (3901), Cell3 (3902), and Cell4 (3903) respectively. Similarly, a BS may transmit, and a UE may receive a PDCCH2 (3909) containing DCI2 cross-carrier scheduling PDSCH5 (3910) and PDSCH6 (3911) on Cell3 (3902) and Cell4 (3903) respectively. PDCCH2 (3909) is received by a UE in Slot X+2 and PDCCH to PDSCH reception timing of PDCCH2 (3909) is one slot and the scheduled PDSCH5 (3910) and PDSCH6 (3911) are received in Slot X+3 on Cell3 (3902), and Cell4 (3903) respectively. DCI 1 and DCI 2 may refer to one of the DCI formats disclosed in the description in conjunction with FIG. 12-19 or 22-26. Each received PDSCH may include a different transport block (TB). A transport block may contain one or more code block groups (CBG) and each CBG contains one or more code blocks. Based on the correct decoding or reception of PDSCH on each of the scheduled cells, the UE may determine the ACK/NACK information for each of the transport blocks or one or more CBGs within the transport blocks, once ACK/NACK information is determined for all the received PDSCHs, a UE may transmit ACK/NACK information for the received transport blocks or CBGs to a base station on a PUCCH channel (PUCCH1 (3912)) where the PUCCH channel resources are determined based on PUCCH resource indicator field in the received DCI1 and/or DCI2. In an embodiment, both DCI1 and DCI2 may indicate the same PUCCH resources. In an embodiment, PUCCH resources may be indicated by latest PDCCH containing DCI (PDCCH2 in case of FIG. 39). A cell on which PUCCH1 (3912) is to be transmitted may be determined from the configuration information of a PUCCH cell in a PUCCH group. The timing of PUCCH1 (3912) resources from the received PDSCHs (PDSCH to PUCCH timing) is determined based on the reception of PDSCH on a reference cell. The reference cell may be a preconfigured cell, or a cell indicated in the received DCI1 and/or DCI2 for PDSCH to PUCCH timing. The reference cell may be determined based on one of a cell index (smallest or largest), a cell receiving the DCI1 and/or DCI2 (scheduling cell), or a cell having the earliest PDSCH reception start time among the scheduled cells or later of PDSCH reception end time among the scheduled cells. The PUCCH1 (3912) may include multiplexed ACK/NACK information of one or more transport blocks or one or more CBGs contained in the respective PDSCH1 (3905), PDSCH2 (3906), PDSCH3 (3907), PDSCH4 (3908), PDSCH5 (3910), and PDSCH6 (3911).

The person skilled in the art would appreciate that the PDCCH to PDSCH reception timing of PDCCH1 (3904) and/or PDCCH2 (3909), PDCCH1 (3904)/PDCCH2 (3909) slot timing, PDSCH to PUCCH timing may be set differently from the ones mentioned in FIG. 39. The slot timings as disclosed in FIG. 39 may also be modified to indicate sub-slot timings. Also, the PDSCH reception timing on the scheduled cells may vary and UE may not receive all the co-scheduled cells starting at the same time.

In another embodiment as presented in FIG. 40, a BS (for example, a BS as shown in conjunction with FIG. 5) may transmit and a UE (for example, a UE as shown in conjunction with FIG. 4) may receive a PDCCH1 (4004) (containing DCI1 self-scheduling PDSCH1 (4007) on Cell1 (4000) and cross-carrier scheduling PDSCH2 (4006), PDSCH3 (4007), and PDSCH4 (4008) on Cell2 (4001), Cell3 (4002), and Cell4 (4003) respectively. PDCCH1 (4004) is received by a UE in Slot X and PDCCH to PDSCH reception timing of PDCCH1 (4004) is one slot and the scheduled PDSCH1 (4007), PDSCH2 (4006), PDSCH3 (4007), and PDSCH4 (4008) are received in Slot X+1 on Cell1 (4000), Cell2 (4001), Cell3 (4002), and Cell4 (4003) respectively. Similarly, a BS may transmit, and a UE may receive a PDCCH2 (4009) containing DCI2 self-scheduling PDSCH5 (4010) on Cell1 (4000). PDCCH2 (4009) is received by a UE in Slot X+2 and PDCCH to PDSCH reception timing of PDCCH2 (4009) is one slot and the scheduled PDSCH5 (4010) is received in Slot X+3 on Cell1 (4000). DCI1 may refer to one of the DCI formats disclosed in the description in conjunction with FIG. 12-19 or 22-26 and DCI2 may refer to a DCI format scheduling a single cell as disclosed in 3GPP Release 17 or one of the DCI formats disclosed in the description in conjunction with FIG. 12-19 or 22-26 modified for scheduling a single cell. Each received PDSCH may include a different transport block (TB). A transport block may contain one or more code block groups (CBG) and each CBG contains one or more code blocks. Based on the correct decoding or reception of PDSCH on each of the scheduled cells, the UE may determine the ACK/NACK information for each of the transport blocks or one or more CBGs within the transport blocks, once ACK/NACK information is determined for all the received PDSCHs, a UE may transmit ACK/NACK information for the received transport blocks or CBGs to a base station on a PUCCH channel (PUCCH1 (4011)) where the PUCCH channel resources are determined based on PUCCH resource indicator field in the received DCI1 and/or DCI2. In an embodiment, both DCI1 and DCI2 may indicate the same PUCCH resources. In an embodiment, PUCCH resources may be indicated by latest PDCCH containing DCI (PDCCH2 (4009) in case of FIG. 40). A cell on which PUCCH1 (4011) is to be transmitted may be determined from the configuration information of a PUCCH cell in a PUCCH group. The timing of PUCCH1 (4011) resources from the received PDSCHs (PDSCH to PUCCH timing) is determined based on the reception of PDSCH on a reference cell. The reference cell may be a preconfigured cell, or a cell indicated in the received DCI1 and/or DCI2 for PDSCH to PUCCH timing. The reference cell may be determined based on one of a cell index (smallest or largest), a cell receiving the DCI1 and/or DCI2 (scheduling cell), or a cell having the earliest PDSCH reception start time among the scheduled cells or later of PDSCH reception end time among the scheduled cells. The PUCCH1 (4011) may include multiplexed ACK/NACK information of one or more transport blocks or one or more CBGs contained in the respective PDSCH1 (4007), PDSCH2 (4006), PDSCH3 (4007), PDSCH4 (4008), and PDSCH5 (4010).

The person skilled in the art would appreciate that the PDCCH to PDSCH reception timing of PDCCH1 (4004) and/or PDCCH2 (4009), PDCCH1 (4004)/PDCCH2 (4009) slot timing, PDSCH to PUCCH timing may be set differently from the ones mentioned in FIG. 40. The slot timings as disclosed in FIG. 40 may also be modified to indicate sub-slot timings. Also, the PDSCH reception timing on the scheduled cells may vary and UE may not receive all the co-scheduled cells starting at the same time.

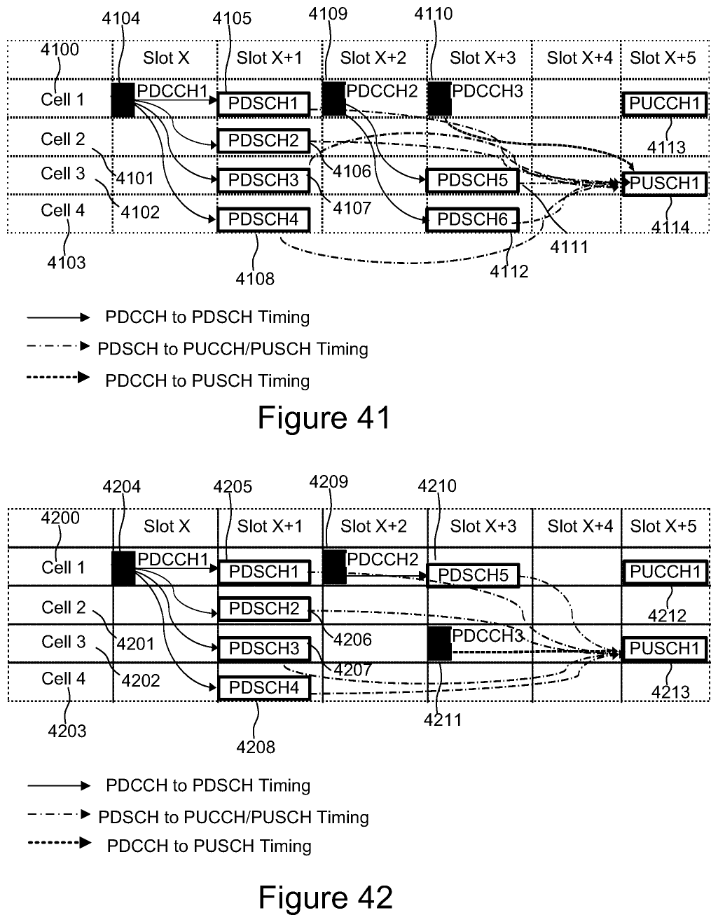

In another embodiment as presented in FIG. 41, a BS (for example, a BS as shown in conjunction with FIG. 5) may transmit and a UE (for example, a UE as shown in conjunction with FIG. 4) may receive a PDCCH1 (4104) containing DCI1 self-scheduling PDSCH1 (4105) on Cell1 (4100) and cross-carrier scheduling PDSCH2 (4106), PDSCH3 (4107), and PDSCH4 (4108) on Cell2 (4101), Cell3 (4102), and Cell4 (4103) respectively. PDCCH1 (4104) is received by a UE in Slot X and PDCCH to PDSCH reception timing of PDCCH1 (4104) is one slot and the scheduled PDSCH1 (4105), PDSCH2 (4106), PDSCH3 (4107), and PDSCH4 (4108) are received in Slot X+1 on Cell1 (4100), Cell2 (4101), Cell3 (4102), and Cell4 (4103) respectively. Similarly, a BS may transmit, and a UE may receive a PDCCH2 (4109) containing DCI2 cross-carrier scheduling PDSCH5 (4111) and PDSCH6 (4112) on Cell3 (4102) and Cell4 (4103) respectively. PDCCH2 (4109) is received by a UE in Slot X+2 and PDCCH to PDSCH reception timing of PDCCH2 (4109) is one slot and the scheduled PDSCH5 (4111) and PDSCH6 (4112) are received in Slot X+3 on Cell3 (4102), and Cell4 (4103) respectively. DCI 1 and DCI 2 may refer to one of the DCI formats disclosed in the description in conjunction with FIG. 12-19 or 22-26. A UE may receive PDCCH3 (4110) containing DCI3 in slot X+3 for cross carrier scheduling PUSCH1 (4113) on cell3 (4102) in slot X+5. The PDCCH to PUSCH timing is set to 2 slots. DCI3 may refer to a DCI format scheduling PUSCH on a single cell as disclosed in 3GPP Release 17 or one of the DCI formats disclosed in the description in conjunction with FIG. 12-19 or 22-26 modified for scheduling PUSCH on a single cell. Each received PDSCH may include a different transport block (TB). A transport block may contain one or more code block groups (CBG) and each CBG contains one or more code blocks. Based on the correct decoding or reception of PDSCH on each of the scheduled cells, the UE may determine the ACK/NACK information for each of the transport blocks or one or more CBGs within the transport blocks, once ACK/NACK information is determined for all the received PDSCHs, a UE may transmit ACK/NACK information for the received transport blocks or CBGs to a base station on PUSCH1 (4113) if the timing of a PUCCH channel (PUCCH1 (4113)) overlaps at least partially with the slot timing of PUSCH1 (4113), where the PUCCH channel resources are determined based on PUCCH resource indicator field in the received DCI1 and/or DCI2. In an embodiment, both DCI1 and DCI2 may indicate the same PUCCH resources. In another embodiment, PUCCH resources may be indicated by latest PDCCH containing DCI (PDCCH2 (4109) in case of FIG. 41). A cell on which PUCCH1 (4113) is to be transmitted may be determined from the configuration information of a PUCCH cell in a PUCCH group. The timing of PUCCH1 (4113) resources from the received PDSCHs (PDSCH to PUCCH timing) is determined based on the reception of PDSCH on a reference cell. The reference cell may be a preconfigured cell, or a cell indicated in the received DCI1 and/or DCI2 for PDSCH to PUCCH timing. The reference cell may be determined based on one of a cell index (smallest or largest), a cell receiving the DCI1 and/or DCI2 (scheduling cell), or a cell having the earliest PDSCH reception start time among the scheduled cells or later of PDSCH reception end time among the scheduled cells. The PUSCH1 (4113) may include multiplexed ACK/NACK information of one or more transport blocks or one or more CBGs contained in the respective PDSCH1 (4105), PDSCH2 (4106), PDSCH3 (4107), PDSCH4 (4108), PDSCH5 (4111), and PDSCH6 (4112).

The person skilled in the art would appreciate that the PDCCH to PDSCH reception timing of PDCCH1 (4104) and/or PDCCH2 (4109), PDCCH1 (4104)/PDCCH2 (4109)/PDCCH3 (4110) slot timing, PUSCH1 (4113) slot timing, PDSCH to PUCCH timing, PDCCH to PUSCH slot timing may be set differently from the ones mentioned in FIG. 41. The slot timings as disclosed in FIG. 41 may also be modified to indicate sub-slot timings. Also, the PDSCH reception timing on the scheduled cells may vary and UE may not receive all the co-scheduled cells starting at the same time.

In another embodiment as presented in FIG. 42, a BS (for example, a BS as shown in conjunction with FIG. 5) may transmit and a UE (for example, a UE as shown in conjunction with FIG. 4) may receive a PDCCH1 (4204) containing DCI1 self-scheduling PDSCH1 (4205) on Cell1 (4200) and cross-carrier scheduling PDSCH2 (4206), PDSCH3 (4207), and PDSCH4 (4209) on Cell2 (4201), Cell3 (4202), and Cell4 (4203) respectively. PDCCH1 (4204) is received by a UE in Slot X and PDCCH to PDSCH reception timing of PDCCH1 (4204) is one slot and the scheduled PDSCH1 (4205), PDSCH2 (4206), PDSCH3 (4207), and PDSCH4 (4209) are received in Slot X+1 on Cell1 (4200), Cell2 (4201), Cell3 (4202), and Cell4 (4203) respectively. Similarly, a BS may transmit, and a UE may receive a PDCCH2 (4209) containing DCI2 self-scheduling PDSCH5 (4210) on Cell1. PDCCH2 (4209) is received by a UE in Slot X+2 and PDCCH to PDSCH reception timing of PDCCH2 (4209) is one slot and the scheduled PDSCH5 (4210) is received in Slot X+3 on Cell1 (4200). DCI1 may refer to one of the DCI formats disclosed in the description in conjunction with FIG. 12-19 or 22-26 and DCI2 may refer to a DCI format scheduling a single cell as disclosed in 3GPP Release 17 or one of the DCI formats disclosed in the description in conjunction with FIG. 12-19 or 22-26 modified for scheduling a single cell. A UE may receive PDCCH3 (4211) containing DCI3 in slot X+3 on cell3 for self-scheduling PUSCH1 (4213) on Cell3 (4202) in slot X+5. The PDCCH to PUSCH timing is set to 2 slots. DCI3 may refer to a DCI format scheduling PUSCH on a single cell as disclosed in 3GPP Release 17 or one of the DCI formats disclosed in the description in conjunction with FIG. 12-19 or 22-26 modified for scheduling PUSCH on a single cell. Each received PDSCH may include a different transport block (TB). A transport block may contain one or more code block groups (CBG) and each CBG contains one or more code blocks. Based on the correct decoding or reception of PDSCH on each of the scheduled cells, the UE may determine the ACK/NACK information for each of the transport blocks or one or more CBGs within the transport blocks, once ACK/NACK information is determined for all the received PDSCHs, a UE may transmit ACK/NACK information for the received transport blocks or CBGs to a base station on PUSCH1 (4213) if the timing of a PUCCH channel (PUCCH1 (4212)) overlaps at least partially with the slot timing of PUSCH1 (4213), where the PUCCH channel resources are determined based on PUCCH resource indicator field in the received DCI1 and/or DCI2. In an embodiment, both DCI1 and DCI2 may indicate the same PUCCH resources. In another embodiment, PUCCH resources may be indicated by latest PDCCH containing DCI (PDCCH2 (4209) in case of FIG. 42). A cell on which PUCCH1 (4212) is to be transmitted may be determined from the configuration information of a PUCCH cell in a PUCCH group. The timing of PUCCH1 (4212) resources from the received PDSCHs (PDSCH to PUCCH timing) is determined based on the reception of PDSCH on a reference cell. The reference cell may be a preconfigured cell, or a cell indicated in the received DCI1 and/or DCI2 for PDSCH to PUCCH timing. The reference cell may be determined based on one of a cell index (smallest or largest), a cell receiving the DCI1 and/or DCI2 (scheduling cell), or a cell having the earliest PDSCH reception start time among the scheduled cells or later of PDSCH reception end time among the scheduled cells. The PUSCH1 (4213) may include multiplexed ACK/NACK information of one or more transport blocks or one or more CBGs contained in the respective PDSCH1 (4205), PDSCH2 (4206), PDSCH3 (4207), PDSCH4 (4209), and PDSCH5 (4210).

The person skilled in the art would appreciate that the PDCCH to PDSCH reception timing of PDCCH1 (4204) and/or PDCCH2 (4209), PDCCH1 (4204)/PDCCH2 (4209)/PDCCH3 (4211) slot timing, PDDCH to PUSCH timing, PDSCH to PUCCH timing may be set differently from the ones mentioned in FIG. 42. The slot timings as disclosed in FIG. 42 may also be modified to indicate sub-slot timings. Also, the PDSCH reception timing on the scheduled cells may vary and UE may not receive all the co-scheduled cells starting at the same time.

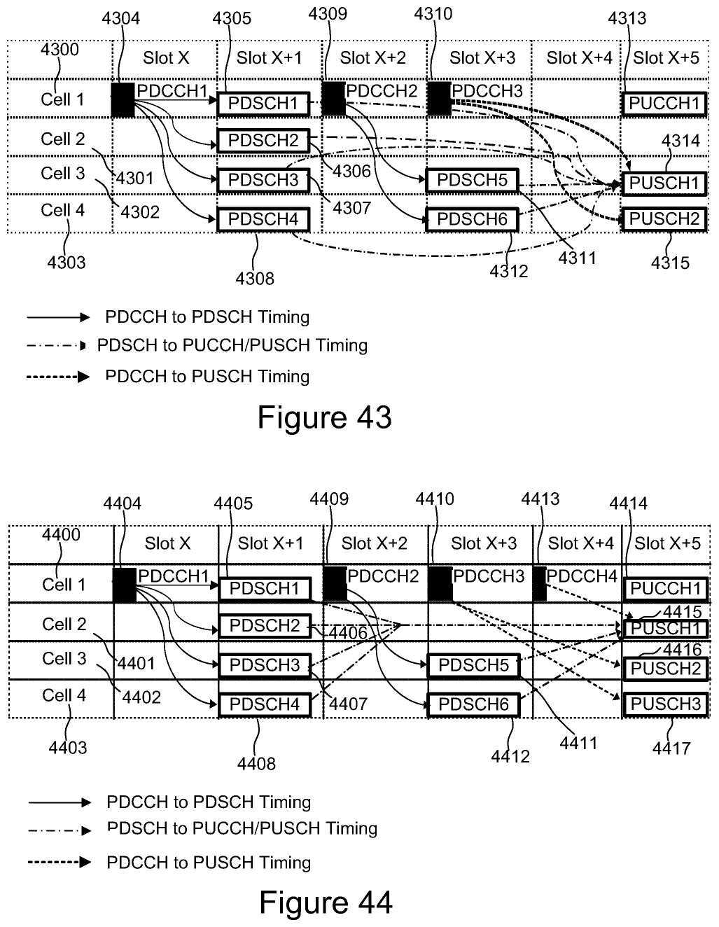

In another embodiment as presented in FIG. 43, a BS (for example, a BS as shown in conjunction with FIG. 5) may transmit and a UE (for example, a UE as shown in conjunction with FIG. 4) may receive a PDCCH1 (4304) containing DCI1 self-scheduling PDSCH1 (4305) on Cell1 (4300) and cross-carrier scheduling PDSCH2 (4306), PDSCH3 (4307), and PDSCH4 (4308) on Cell2 (4301), Cell3 (4302), and Cell4 (4303) respectively. PDCCH1 (4304) is received by a UE in Slot X and PDCCH to PDSCH reception timing of PDCCH1 (4304) is one slot and the scheduled PDSCH1 (4305), PDSCH2 (4306), PDSCH3 (4307), and PDSCH4 (4308) are received in Slot X+1 on Cell1 (4300), Cell2 (4301), Cell3 (4302), and Cell4 (4303) respectively. Similarly, a BS may transmit, and a UE may receive a PDCCH2 (4309) containing DCI2 cross-carrier scheduling PDSCH5 (4311) and PDSCH6 (4312) on Cell3 (4302) and Cell4 (4303) respectively. PDCCH2 (4309) is received by a UE in Slot X+2 and PDCCH to PDSCH reception timing of PDCCH2 (4309) is one slot and the scheduled PDSCH5 (4311) and PDSCH6 (4312) are received in Slot X+3 on Cell3 (4302), and Cell4 (4303) respectively. DCI 1 and DCI 2 may refer to one of the DCI formats disclosed in the description in conjunction with FIG. 12-19 or 22-26. A UE may receive PDCCH3 (4310) containing DCI3 in slot X+3 for cross carrier scheduling PUSCH1 (4314) on Cell3 (4302) and PUSCH2 (4315) on Cell4 (4303) in slot X+5. The PDCCH to PUSCH timing is set to 2 slots. DCI3 may refer to one of the DCI formats disclosed in the description in conjunction with FIG. 12-19 or 22-26. Each received PDSCH may include a different transport block (TB). A transport block may contain one or more code block groups (CBG) and each CBG contains one or more code blocks. Based on the correct decoding or reception of PDSCH on each of the scheduled cells, the UE may determine the ACK/NACK information for each of the transport blocks or one or more CBGs within the transport blocks, once ACK/NACK information is determined for all the received PDSCHs, a UE may transmit ACK/NACK information for the received transport blocks or CBGs to a base station on PUSCH1 (4314) if the timing of a PUCCH channel (PUCCH1 (4313) overlaps at least partially with the slot timing of PUSCH1 (4314), where the PUCCH channel resources are determined based on PUCCH resource indicator field in the received DCI1 and/or DCI2. In an embodiment, both DCI1 and DCI2 may indicate the same PUCCH resources. In another embodiment, PUCCH resources may be indicated by latest PDCCH containing DCI (PDCCH2 (4309) in case of FIG. 43). A cell on which PUCCH1 (4313) is to be transmitted may be determined from the configuration information of a PUCCH cell in a PUCCH group. The timing of PUCCH1 (4313) resources from the received PDSCHs (PDSCH to PUCCH timing) is determined based on the reception of PDSCH on a reference cell. The reference cell may be a preconfigured cell, or a cell indicated in the received DCI1 and/or DCI2 for PDSCH to PUCCH timing. The reference cell may be determined based on one of a cell index (smallest or largest), a cell receiving the DCI1 and/or DCI2 (scheduling cell), or a cell having the earliest PDSCH reception start time among the scheduled cells or later of PDSCH reception end time among the scheduled cells. If more than one PUSCHs such as PUSCH1 (4314) and PUSCH2 (4315) are available each one at least partially overlapping with PUCCH1 (4313), UE may select a cell on which PUSCH is scheduled for transmitting ACK/NACK based on one of a cell index (smallest or largest), scheduling cell of first DCI (Cell1 (4300) in FIG. 42), a cell having the earliest PUSCH transmission start time among the scheduled cells for PUSCH transmissions or later of PUSCH transmission end time among the scheduled cells. In FIG. 42, Cell3 (4302) is selected over Cell4 (4303) for ACK/NACK transmission on PUSCH1 (4314) based on smaller cell index. The PUSCH1 (4314) may include multiplexed ACK/NACK information of one or more transport blocks or one or more CBGs contained in the respective PDSCH1 (4305), PDSCH2 (4306), PDSCH3 (4307), PDSCH4 (4308), PDSCH5 (4311), and PDSCH6 (4312).

The person skilled in the art would appreciate that the PDCCH to PDSCH reception timing of PDCCH1 (4304) and/or PDCCH2 (4309), PDCCH1 (4304)/PDCCH2 (4309)/PDCCH3 (4310) slot timing, PUSCH1 (4314)/PUSCH2 (4315) slot timing, PDSCH to PUCCH timing, PDCCH to PUSCH slot timing may be set differently from the ones mentioned in FIG. 43. The slot timings as disclosed in FIG. 43 may also be modified to indicate sub-slot timings. Also, the PDSCH reception timing on the scheduled cells may vary and UE may not receive all the co-scheduled cells starting at the same time. Similarly, PUSCH transmission timings on the scheduled cells may vary and UE may not transmit all the co-scheduled cells starting at the same time.

In another embodiment as presented in FIG. 44, a BS (for example, a BS as shown in conjunction with FIG. 5) may transmit and a UE (for example, a UE as shown in conjunction with FIG. 4) may receive a PDCCH1 (4404) containing DCI1 self-scheduling PDSCH1 (4405) on Cell1 (4400) and cross-carrier scheduling PDSCH2 (4406), PDSCH3 (4407), and PDSCH4 (4408) on Cell2 (4401), Cell3 (4402), and Cell4 (4403) respectively. PDCCH1 (4404) is received by a UE in Slot X and PDCCH to PDSCH reception timing of PDCCH1 (4404) is one slot and the scheduled PDSCH1 (4405), PDSCH2 (4406), PDSCH3 (4407), and PDSCH4 (4408) are received in Slot X+1 on Cell1 (4400), Cell2 (4401), Cell3 (4402), and Cell4 (4403) respectively. Similarly, a BS may transmit, and a UE may receive a PDCCH2 (4409) containing DCI2 cross-carrier scheduling PDSCH5 (4411) and PDSCH6 (4412) on Cell3 (4402) and Cell4 (4403) respectively. PDCCH2 (4409) is received by a UE in Slot X+2 and PDCCH to PDSCH reception timing of PDCCH2 (4409) is one slot and the scheduled PDSCH5 (4411) and PDSCH6 (4412) are received in Slot X+3 on Cell3 (4402), and Cell4 (4403) respectively. DCI 1 and DCI 2 may refer to one of the DCI formats disclosed in the description in conjunction with FIG. 12-19 or 22-26. A UE may receive PDCCH3 (4410) containing DCI3 in slot X+3 for cross carrier scheduling PUSCH2 (4416) on Cell3 (4402) and PUSCH3 (4417) on Cell4 (4403) in slot X+5. The PDCCH to PUSCH timing is set to 2 slots. DCI3 may refer to one of the DCI formats disclosed in the description in conjunction with FIG. 12-19 or 22-26. A UE may receive PDCCH4 (4413) containing DCI4 in slot X+4 on cell1 for cross-carrier scheduling PUSCH1 (4415) on Cell2 (4401) in slot X+5. The PDCCH to PUSCH timing is set to 1 slot. DCI4 may refer to a DCI format scheduling PUSCH on a single cell as disclosed in 3GPP Release 17 or one of the DCI formats disclosed in the description in conjunction with FIG. 12-19 or 22-26 modified for scheduling PUSCH on a single cell. Each received PDSCH may include a different transport block (TB). A transport block may contain one or more code block groups (CBG) and each CBG contains one or more code blocks. Based on the correct decoding or reception of PDSCH on each of the scheduled cells, the UE may determine the ACK/NACK information for each of the transport blocks or one or more CBGs within the transport blocks, once ACK/NACK information is determined for all the received PDSCHs, a UE may transmit ACK/NACK information for the received transport blocks or CBGs to a base station on PUSCH1 if the timing of a PUCCH channel (PUCCH1 (4414)) overlaps at least partially with the slot timing of PUSCH1 (4415), where the PUCCH channel resources are determined based on PUCCH resource indicator field in the received DCI1 and/or DCI2. In an embodiment, both DCI1 and DCI2 may indicate the same PUCCH resources. In another embodiment, PUCCH resources may be indicated by latest PDCCH containing DCI (PDCCH2 (4409) in case of FIG. 44). A cell on which PUCCH1 (4414) is to be transmitted may be determined from the configuration information of a PUCCH cell in a PUCCH group. The timing of PUCCH1 (4414) resources from the received PDSCHs (PDSCH to PUCCH timing) is determined based on the reception of PDSCH on a reference cell. The reference cell may be a preconfigured cell, or a cell indicated in the received DCI1 and/or DCI2 for PDSCH to PUCCH timing. The reference cell may be determined based on one of a cell index (smallest or largest), a cell receiving the DCI1 and/or DCI2 (scheduling cell), or a cell having the earliest PDSCH reception start time among the scheduled cells or later of PDSCH reception end time among the scheduled cells. If more than one PUSCHs such as single cell scheduled PUSCH1 (4415) and plural cell scheduled PUSCH2 (4416) and PUSCH3 (4417) are available each one at least partially overlapping with PUCCH1 (4414), UE may preferably select a cell on which single cell PUSCH is scheduled for transmitting ACK/NACK information. PUSCH1 (4415) may include multiplexed ACK/NACK information of one or more transport blocks or one or more CBGs contained in the respective PDSCH1 (4405), PDSCH2 (4406), PDSCH3 (4407), PDSCH4 (4408), PDSCH5 (4411), and PDSCH6 (4412).

The person skilled in the art would appreciate that the PDCCH to PDSCH reception timing of PDCCH1 (4404) and/or PDCCH2 (4409), PDCCH1 (4404)/PDCCH2 (4409)/PDCCH3 (4410)/PDCCH4 (4413) slot timing, PUSCH1 (4415)/PUSCH2 (4416)/PUSCH3 (4417) slot timing, PDSCH to PUCCH timing, PDCCH to PUSCH slot timing may be set differently from the ones mentioned in FIG. 44. The slot timings as disclosed in FIG. 44 may also be modified to indicate sub-slot timings. Also, the PDSCH reception timing on the scheduled cells may vary and UE may not receive all the co-scheduled cells starting at the same time. Similarly, PUSCH transmission timings on the scheduled cells may vary and UE may not transmit all the co-scheduled cells starting at the same time.

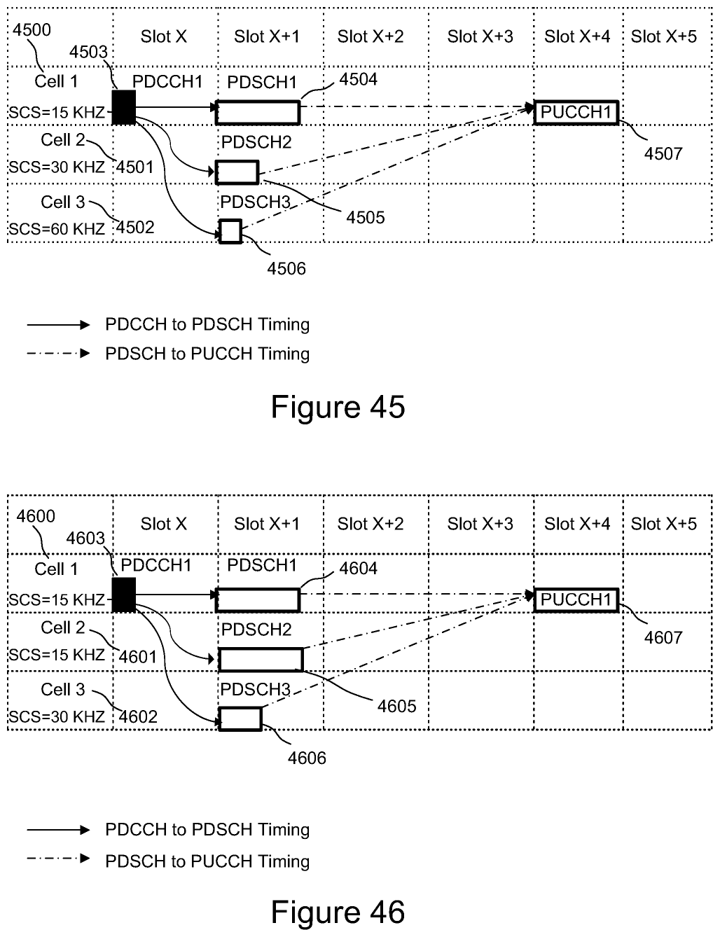

In another embodiment as presented in FIG. 45, a BS (for example, a BS as shown in conjunction with FIG. 5) may transmit and a UE (for example, a UE as shown in conjunction with FIG. 4) may receive a PDCCH1 (4503) containing DCI1 self-scheduling PDSCH1 (4504) on Cell1 (4500) and cross-carrier scheduling PDSCH2 (4505), and PDSCH3 (4506) on Cell2 (4501) and Cell3 (4502) respectively. The Sub-carrier spacings (SCSs) of Cell1 (4500), Cell2 (4501) and Cell3 (4502) are respectively configured as 15 KHZ, 30 KHZ and 60 KHZ. PDCCH1 (4503) is received by a UE in Slot X and PDCCH to PDSCH reception timing from the reception timing of PDCCH1 (4503) may be configured as one slot (this is an exemplary value other values may also be used) and the scheduled PDSCH1 (4504), PDSCH2 (4505), and PDSCH3 (4506) are received in Slot X+1 on Cell1 (4500), Cell2 (4501), and Cell3 (4502) respectively. The timing for sending the HARQ feedback for the received PDSCH1 (4504), PDSCH2 (4505), and PDSCH3 (4506) on PUCCH1 (4507) is determined based on the SCS of a reference cell configured by the UE for the timing purpose, the UE may select a cell with the smallest SCS as the reference cell. For example, as shown in FIG. 45, Cell 1 (4500) has the smallest SCS (i.e. 15 KHZ) and used as the reference cell for determining the timing for sending the HARQ feedback of the received PDSCHs on PUCCH1 (4507). In an alternative embodiment, HARQ feedback may also be transmitted on PUSCH if the timing of PUCCH1 (4507) overlaps with the timing of PUSCH. The timing for sending the HARQ feedback may include an offset in the number of slots and/or symbols from the received PDSCH timing of the reference cell (i.e. Cell 1 (4500) in case of FIG. 45). Further, the UE may determine the reference cell implicitly based on the configured SCSs of the cells. The format of DCI 1 received on PDCCH1 (4503) may refer to any one of the DCI formats disclosed in the description in conjunction with FIG. 12-19 or 22-26.

In an alternative embodiment for determining the reference cell to the one presented in FIG. 45, the UE may select a reference cell as the cell configured with the smallest time duration of an OFDM symbol (i.e. largest subcarrier spacing). The selected reference cell may be used for determining the timing for sending the HARQ feedback for the received PDSCH1 (4504), PDSCH2 (4505), and PDSCH3 (4506). For example, as shown in FIG. 45, Cell 3 (4502) has the smallest time duration of an OFDM symbol and may be used as the reference cell for determining the timing for sending the HARQ feedback of the received PDSCHs. The timing may include the offset in the number of slots and/or symbols from the received PDSCH timing of the reference cell (i.e. Cell 3 (4502) in case of FIG. 45).

In another embodiment as presented in FIG. 46, a BS (for example, a BS as shown in conjunction with FIG. 5) may transmit and a UE (for example, a UE as shown in conjunction with FIG. 4) may receive a PDCCH1 (4603) containing DCI1 self-scheduling PDSCH1 (4604) on Cell1 (4600) and cross-carrier scheduling PDSCH2 (4605), and PDSCH3 (4606) on Cell2 (4601) and Cell3 (4602) respectively. The Sub-carrier spacings (SCSs) of Cell1 (4600), Cell2 (4601) and Cell3 (4602) are respectively configured as 15 KHZ, 15 KHZ and 30 KHZ. PDCCH1 (4603) is received by a UE in Slot X and PDCCH to PDSCH reception timing from the reception timing of PDCCH1 (4603) may be configured as one slot (this is an exemplary value other values may also be used) and the scheduled PDSCH1 (4604), PDSCH2 (4605), and PDSCH3 (4606) are received in Slot X+1 on Cell1 (4600), Cell2 (4601), and Cell3 (4602) respectively. The timing for sending the HARQ feedback on PUCCH1 (4607) for the received PDSCH1 (4604), PDSCH2 (4605), and PDSCH3 (4606) is determined based on the SCS of a reference cell configured by the UE for the timing purpose, the UE may select a cell with smallest SCS as the reference cell. However, if there are a plurality of Cells with the same smallest subcarrier spacing, the reference cell with the smallest cell index is selected by the UE for determining the timing of sending the HARQ feedback on PUCCH1 (4607). For example, as shown in FIG. 46, Cell 1 (4600) and Cell 2 (4601) have the smallest SCS (i.e. 15 KHZ) but Cell index of Cell 1 (4600) is smaller than the Cell 2 (4601), hence Cell 1 (4600) is used as the reference cell for determining the timing for sending the HARQ feedback of the received PDSCHs on PUCCH1 (4607). In an alternative embodiment, HARQ feedback may also be transmitted on PUSCH if the timing of PUCCH1 (4607) overlaps with the timing of PUSCH. The timing may include an offset in the number of slots and/or symbols from the received PDSCH timing of the reference cell (i.e. Cell 1 (4600) in case of FIG. 46). Further, the UE may determine the reference cell implicitly based on the configured Cell indices and SCSs of the cells. The format of DCI 1 received on PDCCH1 (4603) may refer to any one of the DCI formats disclosed in the description in conjunction with FIG. 12-19 or 22-26.

In an alternative embodiment for determining the reference cell to the one presented in FIG. 46, the UE may select a reference cell as the cell configured with the smallest time duration of an OFDM symbol (i.e. largest subcarrier spacing). The selected reference cell may be used for determining the timing for sending the HARQ feedback for the received PDSCH1 (4604), PDSCH2 (4605), and PDSCH3 (4606). However, if there are a plurality of Cells with same smallest time duration of the OFDM symbol, the cell with the smallest cell index is selected by the UE as the reference cell. The timing may include an offset in the number of slots and/or symbols from the received PDSCH timing of the reference cell (i.e. Cell 3 (4602) in case of FIG. 46).

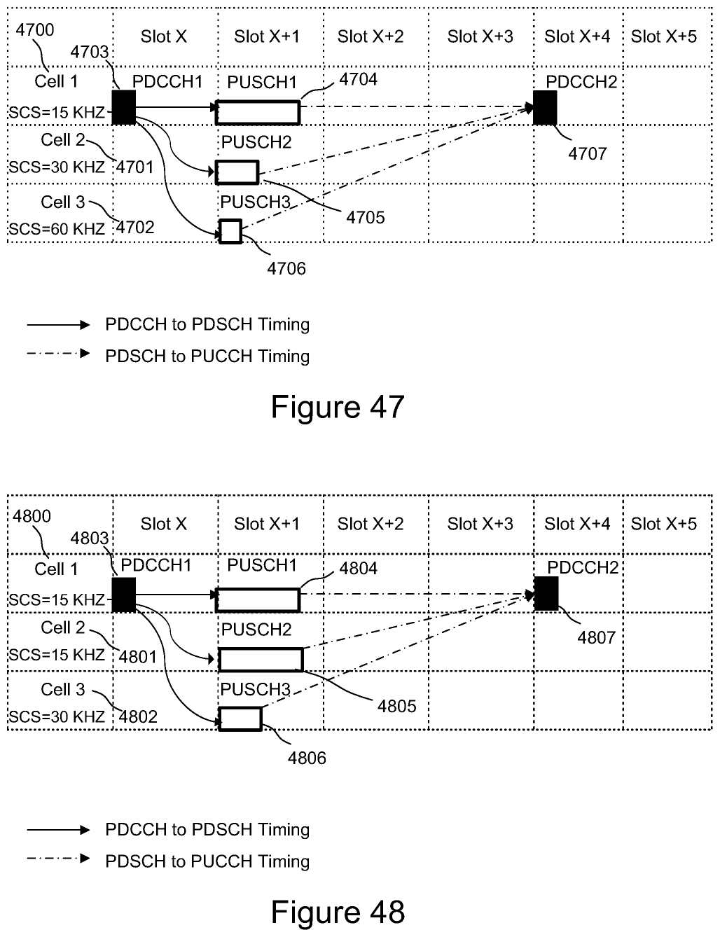

In another embodiment as presented in FIG. 47, a BS (for example, a BS as shown in conjunction with FIG. 5) may transmit and a UE (for example, a UE as shown in conjunction with FIG. 4) may receive a PDCCH1 (4703) containing DCI1 self-scheduling PUSCH1 (4704) on Cell 1 (4700) and cross-carrier scheduling PUSCH2 (4705), and PUSCH3 (4706) on Cell 2 (4701) and Cell 3 (4702) respectively. The Sub-carrier spacings (SCSs) of Cell 1 (4700), Cell 2 (4701) and Cell 3 (4702) are respectively configured as 15 KHZ, 30 KHZ and 60 KHZ. PDCCH1 (4703) is received by a UE in Slot X and PDCCH to PUSCH transmission timing from the reception timing of PDCCH1 (4703) may be configured as one slot (this is an exemplary value other values may also be used) and the scheduled PUSCH1 (4704), PUSCH2 (4705), and PUSCH3 (4706) are transmitted in Slot X+1 on Cell 1 (4700), Cell 2 (4701), and Cell 3 (4702) respectively. The timing for receiving the HARQ feedback on PDCCH2 (4707) for the transmitted PUSCH1 (4704), PUSCH2 (4705), and PUSCH3 (4706) is determined based on the SCS of a reference cell configured by the UE for the timing purpose, the UE may select a cell with the smallest SCS as the reference cell. For example, as shown in FIG. 47, Cell 1 (4700) has the smallest SCS (i.e. 15 KHZ) and used as the reference cell for determining the timing for receiving the HARQ feedback of the transmitted PUSCHs on PDCCH2 (4707). The timing may include the offset in the number of slots and/or symbols from the transmitted PUSCH timing on the reference cell (i.e. Cell 1 (4700) in case of FIG. 47). Further, the UE may determine the reference cell implicitly based on the configured SCSs of the cells. The format of DCI 1 received on PDCCH1 (4703) may refer to any one of the DCI formats disclosed in the description in conjunction with FIG. 12-19 or 22-26.

In an alternative embodiment for determining the reference cell to the one presented in FIG. 47, the UE may select a reference cell as the cell configured with the smallest time duration of an OFDM symbol (i.e. largest subcarrier spacing). The selected reference cell may be used for determining the timing for receiving the HARQ feedback for the transmitted PUSCH1 (4704), PUSCH2 (4705), and PUSCH3 (4706). For example, as shown in FIG. 47, Cell 3 (4702) has the smallest time duration of an OFDM symbol and may be used as the reference cell for determining the timing for receiving the HARQ feedback of the transmitted PUSCHs. The timing may include the offset in the number of slots and/or symbols from the transmitted PUSCH timing on the reference cell (i.e. Cell 3 (4702) in case of FIG. 47). Further, the UE may determine the reference cell for determining the timing for receiving the HARQ feedback implicitly based on the configured SCSs of the cells.

In another embodiment as presented in FIG. 48, a BS (for example, a BS as shown in conjunction with FIG. 5) may transmit and a UE (for example, a UE as shown in conjunction with FIG. 4) may receive a PDCCH1 (4803) containing DCI1 self-scheduling PUSCH1 (4804) on Cell1 (4800) and cross-carrier scheduling PUSCH2 (4805), and PUSCH3 (4806) on Cell2 (4801) and Cell3 (4802) respectively. The Sub-carrier spacings (SCSs) of Cell 1 (4800), Cell 2 (4801) and Cell 3 (4802) are respectively configured as 15 KHZ, 15 KHZ and 30 KHZ. PDCCH1 (4803) is received by a UE in Slot X and PDCCH to PUSCH transmission timing from the reception timing of PDCCH1 (4803) may be configured as one slot (this is an exemplary value other values may also be used) and the scheduled PUSCH1 (4804), PUSCH2 (4805), and PUSCH3 (4806) are transmitted in Slot X+1 on Cell1 (4800), Cell2 (4801), and Cell3 (4802) respectively. The timing for receiving the HARQ feedback for the transmitted PUSCH1 (4804), PUSCH2 (4805), and PUSCH3 (4806) is determined based on the SCS of a reference cell configured by the UE, the UE may select a cell with the smallest SCS as the reference cell. However, if there are a plurality of Cells with the same smallest subcarrier spacing, the reference cell with the smallest cell index is selected by the UE. For example, as shown in FIG. 48, Cell 1 (4800) and Cell 2 (4801) have the smallest SCS (i.e. 15 KHZ) but Cell index of Cell 1 (4800) is smaller than the Cell 2 (4801), hence Cell 1 (4800) is used as the reference cell for determining the timing for receiving the HARQ feedback of the transmitted PUSCHs. The timing may include the offset in the number of slots and/or symbols from the transmitted PUSCH timing on the reference cell (i.e. Cell 1 (4800) in case of FIG. 48). Further, the UE may determine the reference cell implicitly based on the configured Cell indices and SCSs of the cells. The format of DCI 1 received on PDCCH1 (4803) may refer to any one of the DCI formats disclosed in the description in conjunction with FIG. 12-19 or 22-26.

In an alternative embodiment for determining the reference cell to the one presented in FIG. 48, the UE may select a reference cell as the cell configured with the smallest time duration of an OFDM symbol (i.e. largest subcarrier spacing). The selected reference cell may be used for determining the timing for receiving the HARQ feedback for the transmitted PUSCH1 (4804), PUSCH2 (4805), and PUSCH3 (4806). However, if there are a plurality of Cells with the same smallest time duration of the OFDM symbol, the cell with the smallest cell index is selected by the UE as the reference cell. The timing may include the offset in the number of slots and/or symbols from the transmitted PUSCH timing on the reference cell (i.e. Cell 3 (4802) in case of FIG. 48).

### CRC Field

In another embodiment, a BS may transmit, and a UE may receive a PDCCH containing a one of a DCI format as disclosed in the description in conjunction with FIG. 12-19 or 22-26 for PUSCH/PDSCH scheduling on a plurality of cells includes a CRC field. For example, a 24-bit CRC field may be used which may be scrambled by one of C-RNTI, CS-RNTI, MCS-C-RNTI, TC-RNTI, SP-CSI-RNTI, P-RNTI, SI-RNTI, RA-RNTI, or MsgB-RNTI. CRC is configured as a common field for all the cells.

In another embodiment, a BS may transmit, and a UE may receive a PDCCH containing a one of a DCI format as disclosed in the description in conjunction with FIG. 12-19 or 22-26 for PUSCH/PDSCH scheduling on a plurality of cells includes a CRC field. Using a common RNTI in the PDCCH means same interpretation for the DCI fields for each of the scheduled PDSCH/PUSCH. For example, interpretation for “Modulation and coding scheme” field depends on whether the CRC of PDCCH is scrambled by MCS-RNTI or C-RNTI. The flexibility of the scheduled multiple PUSCH/PDSCH would be restricted by using a common RNTI. Therefore, to enhance flexibility of the scheduled multiple PUSCH/PDSCH a CRC field of the PDCCH may a scrambled by an X-RNTI which is jointly coded for the co-scheduled cells. For example, PDCCH scheduling PDSCHs on Cell1, Cell2 and Cell3 may be scrambled by X-RNTI, where X-RNTI may indicate C-RNTI specific DCI fields for Cell1 and Cell2 while CS-RNTI specific DCI fields for Cell3. Below provided exemplary table 11 may be preconfigured in a UE for identifying RNTIs used for CRC scrambling.

TABLE 11

| RNTI for CRC | | | |
|---|---|---|---|
| Scrambling | Cell1 | Cell2 | Cell3 |
| X-RNTI1 | C-RNTI | C-RNTI | C-RNTI |
| X-RNTI2 | C-RNTI | C-RNTI | CS-RNTI |
| X-RNTI3 | C-RNTI | CS-RNTI | C-RNTI |
| X-RNTI4 | C-RNTI | CS-RNTI | CS-RNTI |
| X-RNTI5 | CS-RNTI | C-RNTI | C-RNTI |
| X-RNTI6 | CS-RNTI | C-RNTI | CS-RNTI |
| X-RNTI7 | CS-RNTI | CS-RNTI | C-RNTI |
| X-RNTI8 | CS-RNTI | CS-RNTI | CS-RNTI |

Above X-RNTI table may be configured by a BS to a UE via RRC signaling. Once X-RNTI table is configured, a UE may use the RNTI specific fields in the DCI for the corresponding cells.

A person skilled in the art would appreciate that other combinations of RNTIs including C-RNTI, CS-RNTI, MCS-C-RNTI, TC-RNTI, SP-CSI-RNTI, P-RNTI, SI-RNTI, RA-RNTI, or MsgB-RNTI may be used for joint coding. Also, the number of cells for configuring corresponding RNTIs may be more than or less than 3 as provided in the above table.
Related art (available at https://www.3gpp.org/ftp/TSG_RAN/WG1 RL1/TSGR1 109-e/Docs):
R1-2203135: Discussion on multi-cell PUSCH/PDSCH scheduling with a single scheduling DCI, Huawei, HiSilicon
R1-2203207: Discussion on Multi-cell PUSCH/PDSCH scheduling with a single DCI, ZTE
R1-2203346: Discussion on multi-cell PUSCH/PDSCH scheduling with a single DCI, Spreadtrum Communications
R1-2203448: Discussion on multi-cell PUSCH/PDSCH scheduling with a single DCI, CATT
R1-2203583: Discussion on multi-cell scheduling, vivo
R1-2203664: Discussion on multi-cell scheduling with a single DCI, China Telecom
R1-2203688: Discussion on Multi-cell PXSCH scheduling with a single DCI, NEC
R1-2203706: Discussion on multi-cell scheduling via a single DCI, Lenovo
R1-2203800: Discussion on the design of multi-cell scheduling with a single DCI, xiaomi
R1-2203842: Discussions on multi-cell PUSCH/PDSCH scheduling with a single DCI, Langbo
R1-2203925: Multi-cell PUSCH/PDSCH scheduling with a single DCI, Samsung
R1-2204026: Discussion on multi-cell PUSCH/PDSCH scheduling with a single DCI, OPPO
R1-2204087: Multi-cell scheduling with a single DCI, InterDigital, Inc.
R1-2204186: Discussion on multi-cell PUSCH/PDSCH scheduling with a single DCI, CAICT
R1-2204262: On multi-cell PUSCH/PDSCH scheduling with a single DCI, Apple
R1-2204324: Discussion on multi-cell PUSCH/PDSCH scheduling with a single DCI, CMCC
R1-2204398: Discussion on multi-cell PUSCH/PDSCH scheduling with a single DCI, NTT DOCOMO, INC.
R1-2204631: Discussion on Multi-cell PUSCH/PDSCH scheduling with a single DCI, LG Electronics
R1-2204697: On multi-cell PUSCH/PDSCH scheduling with a single DCI, MediaTek Inc.
R1-2204816: Discussions on multi-cell scheduling with a single DCI, Intel Corporation
R1-2204865: Multi-cell PUSCH/PDSCH scheduling with a single DCI, Charter Communications
R1-2204888: Multi-cell PUSCH/PDSCH scheduling with a single DCI, Ericsson
R1-2205051: Multi-cell PUSCH and PDSCH scheduling with a single DCI, Qualcomm Incorporated
R1-2205073: Discussion on Multicarrier scheduling with a single DCI, FGI
R1-2205088: Consideration on multi-cell PUSCH/PDSCH scheduling with a single DCI, Fujitsu Limited
R1-2203276: On multi-cell PUSCH/PDSCH scheduling with a single DCI, Nokia, Nokia Shanghai Bell
R1-2205234; Feature lead summary #1 on multi-cell PUSCH/PDSCH scheduling with a single DCI, Moderator (Lenovo)
R1-2205235: Feature lead summary #2 on multi-cell PUSCH/PDSCH scheduling with a single DCI, Moderator (Lenovo)
R1-2205236: Feature lead summary #3 on multi-cell PUSCH/PDSCH scheduling with a single DCI, Moderator (Lenovo)
R1-2205486, Feature lead summary #4 on multi-cell PUSCH/PDSCH scheduling with a single DCI, Moderator (Lenovo)
R1-2205487: Feature lead summary #5 on multi-cell PUSCH/PDSCH scheduling with a single DCI, Moderator (Lenovo)

1.-35. (canceled)

36. A method performed by a user equipment (UE), the method comprising:
receiving radio resource control (RRC) signalling configuring a first downlink control information (DCI) scheduling respective physical uplink shared channels (PUSCHs) on a first plurality of cells and configuring a second DCI scheduling respective physical downlink shared channels (PDSCHs) on a second plurality of cells;
receiving the first DCI scheduling the respective PUSCHs on the first plurality of cells;
receiving the second DCI scheduling the respective PDSCHs on the second plurality of cells;
transmitting the respective PUSCHs on the first plurality of cells based on the received first DCI; and
receiving the respective PDSCHs on the second plurality of cells based on the received second DCI.

37. The method of claim 36, wherein the first plurality of cells are associated with a first physical uplink control channel (PUCCH) group, and the second plurality of cells are associated with a second PUCCH group.

38. The method of claim 37, wherein the RRC signalling further includes information of a cell group ID of the first plurality of cells, a PUCCH group ID of the first PUCCH group, a cell group ID of the second plurality of cells, or a PUCCH group ID of the second PUCCH group.

39. The method of claim 37, wherein the first PUCCH group and the second PUCCH group have at least one cell that is not common.

40. The method of claim 36, wherein the RRC signalling further includes information indicating one or more combinations of the first plurality of cells, wherein the RRC signalling further includes information indicating one or more combinations of the second plurality of cells, wherein the first DCI includes first co-scheduled cells indicator (CSCI) information indicating a first combination of the one or more combinations of the first plurality of cells for scheduling the respective PUSCHs on the first plurality of cells, and wherein the second DCI includes second CSCI information indicating a second combination of the one or more combinations of the second plurality of cells for scheduling the respective PDSCHs on the second plurality of cells.

41. The method of claim 36, wherein the RRC signalling further includes information of a reference cell within the first plurality of cells for determining a transmission timing of the respective PUSCHs on the first plurality of cells or for determining timing of receiving feedback of the transmitted respective PUSCHs on at least one cell of the first plurality of cells, and wherein the RRC signalling further includes information of a reference cell within the second plurality of cells for determining a reception timing of the respective PDSCHs on the second plurality of cells or for determining timing of transmitting feedback of the received respective PDSCHs on the second plurality of cells.

42. The method of claim 36, wherein the RRC signalling further includes information of a first DCI field in the first DCI that indicates separate information for a set of scheduled cells, wherein the set of scheduled cells corresponds to the first plurality of cells or a subset of cells of the first plurality of cells, wherein the information of the first DCI field includes two or more of: a first DCI field name or a first DCI field identifier, a number of bits comprising the first DCI field, or joint indication bits and corresponding values for each scheduled cell of the set of scheduled cells, wherein the joint indication bits are included in the first DCI when the first DCI field is used for scheduling respective PUSCHs for the first plurality of cells, and wherein the first DCI field in the first DCI is a time domain resource assignment (TDRA) field or an SRS request field.

43. The method of claim 36, wherein the RRC signalling further includes information of a first DCI field in the second DCI that indicates separate information for a set of scheduled cells, wherein the set of scheduled cells corresponds to the second plurality of cells or a subset of cells from the second plurality of cells, wherein the information of the first DCI field in the second DCI includes two or more of: a first DCI field name or a first DCI field identifier, a number of bits to be used for the DCI field, or joint indication bits and corresponding values for each scheduled cell of the set of scheduled cells wherein the joint indication bits are included in the second DCI when the first DCI field is used for scheduling respective PDSCHs for the second plurality of cells, and wherein the first DCI field in the second DCI is a time domain resource assignment (TDRA) field or an SRS request field.

44. The method of claim 36, wherein the RRC signalling further includes information of a second DCI field in the first DCI which is dynamically configured based on a network configuration as a common field for indicating common information for a set of scheduled cells or as separate fields for indicating separate information for each scheduled cell of a set of scheduled cells, wherein the set of scheduled cells corresponds to the first plurality of cells or a subset of cells from the first plurality of cells, wherein the information of the second DCI field in the first DCI includes a second DCI field name or a second DCI field identifier, and an indicator of configuration as the common field for indicating common information for the set of scheduled cells or an indicator of configuration as separate fields for indicating separate information for each scheduled cell of the set of scheduled cells, and wherein the second DCI field in the first DCI is an Antenna port(s) field, an SRS resource indicator field, or a precoding information and number of layers field.

45. The method of claim 36, wherein the RRC signalling further includes information of a second DCI field in the second DCI which is dynamically configured based on a network configuration as a common field for indicating common information for a set of scheduled cells or as separate fields for indicating separate information for each scheduled cell of a set of scheduled cells, wherein the set of scheduled cells corresponds to the second plurality of cells or a subset of cells from the second plurality of cells, wherein the information of the second DCI field in the second DCI includes a second DCI field name or a second DCI field identifier and an indicator of configuration as the common field for indicating common information for the set of scheduled cells or an indicator of configuration as separate fields for indicating separate information for each scheduled cell of the set of scheduled cells, and wherein the second DCI field in the second DCI is an Antenna port(s) field.

46. An apparatus comprising:
at least one processor;
a transceiver coupled to the at least one processor, the transceiver and the at least one processor configured to:
receive, from a base station, radio resource control (RRC) signalling configuring a first downlink control information (DCI) scheduling respective physical uplink shared channels (PUSCHs) on a first plurality of cells, and configuring a second DCI scheduling respective physical downlink shared channels (PDSCHs) on a second plurality of cells;
to receive, from the base station, the first DCI scheduling the respective PUSCHs on the first plurality of cells;
to receive, from the base station, the second DCI scheduling the respective PDSCHs on the second plurality of cells;
to transmit, to the base station, the respective PUSCHs on the first plurality of cells based on the received first DCI; and
to receive, from the base station, the respective PDSCHs on the second plurality of cells based on the received second DCI.

47. The apparatus of claim 46, wherein the first plurality of cells are associated with a first physical uplink control channel (PUCCH) group, and the second plurality of cells are associated with a second PUCCH group.

48. The apparatus of claim 47, wherein the RRC signalling further includes information of a cell group ID of the first plurality of cells, a PUCCH group ID of the first PUCCH group, a cell group ID of the second plurality of cells, or a PUCCH group ID of the second PUCCH group.

49. The apparatus of claim 47, wherein the first PUCCH group and the second PUCCH group have at least one cell that is not common.

50. The apparatus of claim 46, wherein the RRC signalling further includes information indicating one or more combinations of the first plurality of cells, wherein the RRC signalling further includes information indicating one or more combinations of the second plurality of cells, wherein the first DCI includes first co-scheduled cells indicator (CSCI) information indicating a first combination of the one or more combinations of the first plurality of cells for scheduling the respective PUSCHs on the first plurality of cells, and wherein the second DCI includes second CSCI information indicating a second combination of the one or more combinations of the second plurality of cells for scheduling the respective PDSCHs on the second plurality of cells.

51. The apparatus of claim 46, wherein the RRC signalling further includes information of a reference cell within the first plurality of cells for determining a transmission timing of the respective PUSCHs on the first plurality of cells or for determining timing of receiving feedback of the transmitted respective PUSCHs on at least one cell of the first plurality of cells, and wherein the RRC signalling further includes information of a reference cell within the second plurality of cells for determining a reception timing of the respective PDSCHs on the second plurality of cells or for determining timing of transmitting feedback of the received respective PDSCHs on the second plurality of cells.

52. The apparatus of claim 46, wherein the RRC signalling further includes information of a first DCI field in the first DCI that indicates separate information for a set of scheduled cells, wherein the set of scheduled cells corresponds to the first plurality of cells or a subset of cells of the first plurality of cells, wherein the information of the first DCI field includes two or more of: a first DCI field name or a first DCI field identifier, a number of bits comprising the first DCI field, or joint indication bits and corresponding values for each scheduled cell of the set of scheduled cells, wherein the joint indication bits are included in the first DCI when the first DCI field is used for scheduling respective PUSCHs for the first plurality of cells, and wherein the first DCI field in the first DCI is a time domain resource assignment (TDRA) field or an SRS request field.

53. The apparatus of claim 46, wherein the RRC signalling further includes information of a first DCI field in the second DCI that indicates separate information for a set of scheduled cells, wherein the set of scheduled cells corresponds to the second plurality of cells or a subset of cells from the second plurality of cells, wherein the information of the first DCI field in the second DCI includes two or more of: a first DCI field name or a first DCI field identifier, a number of bits to be used for the DCI field, or joint indication bits and corresponding values for each scheduled cell of the set of scheduled cells wherein the joint indication bits are included in the second DCI when the first DCI field is used for scheduling respective PDSCHs for the second plurality of cells, wherein the first DCI field in the second DCI is a time domain resource assignment (TDRA) field or an SRS request field.

54. The apparatus of claim 46, wherein the RRC signaling further includes information of a second DCI field in the first DCI which is dynamically configured based on a network configuration as a common field for indicating common information for a set of scheduled cells or as separate fields for indicating separate information for each scheduled cell of a set of scheduled cells, wherein the set of scheduled cells corresponds to the first plurality of cells or a subset of cells from the first plurality of cells, wherein the information of the second DCI field in the first DCI includes a second DCI field name or a second DCI field identifier, and an indicator of configuration as the common field for indicating common information for the set of scheduled cells or an indicator of configuration as separate fields for indicating separate information for each scheduled cell of the set of scheduled cells, and wherein the second DCI field in the first DCI is an Antenna port(s) field, an SRS resource indicator field, or a precoding information and number of layers field.

55. The apparatus of claim 46, wherein the RRC signalling further includes information of a second DCI field in the second DCI which is dynamically configured based on a network configuration as a common field for indicating common information for a set of scheduled cells or as separate fields for indicating separate information for each scheduled cell of a set of scheduled cells, wherein the set of scheduled cells corresponds to the second plurality of cells or a subset of cells from the second plurality of cells, wherein the information of the second DCI field in the second DCI includes a second DCI field name or a second DCI field identifier and an indicator of configuration as the common field for indicating common information for the set of scheduled cells or an indicator of configuration as separate fields for indicating separate information for each scheduled cell of the set of scheduled cells, and wherein the second DCI field in the second DCI is an Antenna port(s) field.
